(19) United States
(12) Patent Application Publication
(10) Pub. No.: US 2025/0280302 A1
(43) Pub. Date: Sep. 4, 2025

(54) SIGNAL TRANSMISSION METHOD AND RELATED APPARATUS

(71) Applicant: Huawei Technologies Co., Ltd., Shenzhen (CN)

(72) Inventors: Xiaolu Wang, Hangzhou (CN); Yunfei Qiao, Hangzhou (CN); Hejia Luo, Ottawa (CA); Chuili Kong, Hangzhou (CN); Tianhang Yu, Hangzhou (CN); Rong Li, Boulogne Billancourt (FR)

(21) Appl. No.: 19/209,205

(22) Filed: May 15, 2025

Related U.S. Application Data
(63) Continuation of application No. PCT/CN2023/104314, filed on Jun. 29, 2023.

(30) Foreign Application Priority Data
Nov. 16, 2022 (CN) 202211438704.8

(51) Int. Cl. H04W 16/28; H04B 7/185; H04W 72/0446; H04W 84/06

(52) U.S. Cl. CPC H04W 16/28; H04B 7/18513; H04W 72/0446; H04W 84/06

(57) ABSTRACT

Embodiments of this application disclose a signal transmission method and a related apparatus. The method includes: a first communication device obtains a first resource used for transmission of a noise signal, where the first resource includes one or more of the following: first time for transmission of the noise signal, a first coverage area of the noise signal, or a first frequency band of a beam that carries the noise signal. The first communication device determines, based on the first resource, a second resource used for transmission of a service signal, where the second resource includes one or more of the following: second time for transmission of the service signal, a second coverage area of the service signal, or a second frequency band of a beam that carries the service signal, and the first resource is different from the second resource.

### CROSS-REFERENCE TO RELATED APPLICATIONS

This application is a continuation of International Application No. PCT/CN 2023/104314, filed on Jun. 29, 2023, which claims priority to Chinese Patent Application No. 202211438704.8, filed on Nov. 16, 2022. The disclosures of the aforementioned applications are hereby incorporated by reference in their entireties.

### TECHNICAL FIELD

This application relates to the field of communication, and in particular, to a signal transmission method and a related apparatus.

### BACKGROUND

In a communication system, a signal transmitted by a signal transmitting end usually needs to pass through a high power amplifier (HPA), to increase transmit power of the signal. However, the HPA usually operates near a linear saturation region. When the signal transmitted by the transmitting end is a high peak-to-average power ratio (PAPR) signal, the signal is nonlinearly distorted after passing through the HPA, causing in-band distortion and out-of-band radiation of an output signal. In other words, decoding accuracy of a signal receiving end is affected, and interference is caused to a user on an adjacent channel.

A peak clipping and filtering (CAF) technology is used to effectively suppress a peak-to-average power ratio of the signal, to reduce distortion caused by nonlinearity of the HPA for the signal that passes through the HPA. However, the peak clipping and filtering technology may generate a large amount of peak clipping and filtering noise while suppressing the high peak-to-average power ratio. The peak clipping and filtering noise causes interference to an area covered by an adjacent signal transmitting end.

### SUMMARY

This application discloses a signal transmission method and a related apparatus, to implement spatial separation between a service signal in a beam and a noise signal that suppresses a high peak-to-average power ratio, to reduce interference of the noise signal that suppresses the high peak-to-average power ratio to the service signal.

According to a first aspect, this application provides a signal transmission method. The method includes:
a first communication device obtains a first resource used for transmission of a noise signal, where the first resource includes one or more of the following: first time for transmission of the noise signal, a first coverage area of the noise signal, or a first frequency band of a beam that carries the noise signal; the first communication device determines, based on the first resource, a second resource used for transmission of a service signal, where the second resource includes one or more of the following: second time for transmission of the service signal, a second coverage area of the service signal, or a second frequency band of a beam that carries the service signal, and the first resource is different from the second resource; and the first communication device sends a first service signal based on the second resource.

In this solution, after learning the first resource used for transmission of the noise signal, the first communication device determines the second resource that is different from the first resource and that is used for transmission of the service signal, so that interference of the noise signal transmitted based on the first resource to the service signal transmitted based on the second resource can be reduced.

In a possible implementation, the first resource includes the first coverage area of the noise signal. The second resource includes the second coverage area of the service signal. The first coverage area overlaps the second coverage area. That the first resource is different from the second resource includes: The first time is different from the second time, and/or the first frequency band is different from the second frequency band.

In this solution, when the coverage areas of the noise signal and the service signal overlap, the first time is different from the second time, and/or the first frequency band is different from the second frequency band, so that the interference of the noise signal to the service signal is reduced, and quality of the service signal is ensured.

In a possible implementation, that a first communication device obtains a first resource used for transmission of a noise signal includes:
the first communication device receives first information from a second communication device, where the first information is used to request to obtain a resource available for transmission of the noise signal; and the first communication device determines the first resource based on the first information.

In this solution, the first communication device receives, from the second communication device, the first information that requests to obtain the resource available for transmission of the noise signal, and determines the first resource based on the first information. In other words, the first communication device and the second communication device may determine, in a negotiation manner, a resource for transmission of the noise signal, to effectively reduce the interference of the noise signal to the service signal.

In a possible implementation, the first information includes one or more resources available for transmission of the noise signal, and the one or more resources available for transmission of the noise signal include the first resource.

In this solution, when the first information requests to obtain the resource available for transmission of the noise signal, the first information further carries the one or more resources available for transmission of the noise signal. Therefore, the first communication device can obtain a resource more suitable for transmission of the noise signal, to reduce interference of the noise signal transmitted by using the resource to the first service signal.

In a possible implementation, after the first communication device obtains the first resource used for transmission of the noise signal, the method further includes: The first communication device sends second information to the second communication device, where the second information indicates the first resource.

In this solution, the first communication device sends the generated first resource to the second communication device. The first communication device sends, to the second communication device, the first resource used for transmission of the noise signal, so that the second communication device can transmit the noise signal by using the first resource, or the second communication device forwards the first resource to another communication device for use.

In a possible implementation, the second resource includes the second time. That the first communication device sends a first service signal based on the second resource includes: The first communication device sends the first service signal at the second time.

In this solution, the first communication device sends the first service signal at the second time, to provide a service for a terminal device at the second time. In addition, because the second resource is different from the first resource, the service signal transmitted at the second time is less interfered by the noise signal.

In a possible implementation, the second resource includes the second frequency band, and a frequency band of a beam that carries the first service signal is the second frequency band.

In this solution, the first communication device may transmit the first service signal by using the beam on the second frequency band, to provide the service for the terminal device. In addition, because the second resource is different from the first resource, the service signal transmitted by using the second frequency band is less interfered by the noise signal.

In a possible implementation, the second resource includes the second coverage area, and a coverage area of the first service signal is the second coverage area.

In this solution, the coverage area of the first service signal is the second coverage area, so that the first service signal is sent to the second coverage area. In addition, because the second resource is different from the first resource, the service signal sent to the second coverage area is less interfered by the noise signal.

In a possible implementation, before the first communication device obtains the first resource used for transmission of the noise signal, the method further includes: The first communication device receives a beam hopping pattern from one or more communication devices.

That the first communication device obtains a first resource used for transmission of a noise signal includes: The first communication device determines the first resource based on the beam hopping pattern.

In this solution, the first communication device obtains the first resource by receiving the beam hopping pattern from the one or more communication devices. Therefore, the interference of the noise signal transmitted based on the first resource to the service signal can be reduced as much as possible.

In a possible implementation, that the first communication device determines the first resource based on the beam hopping pattern includes:
the first communication device determines, based on the beam hopping pattern, a plurality of resources used for transmission of the noise signal, where the plurality of resources used for transmission of the noise signal include the first resource.

That the first communication device determines, based on the first resource, a second resource used for transmission of a service signal includes:
the first communication device adjusts, based on the plurality of resources used for transmission of the noise signal, a beam hopping pattern corresponding to the first communication device, where an adjusted beam hopping pattern includes the second resource.

In this solution, the plurality of resources used for transmission of the noise signal may be determined based on the foregoing beam hopping pattern, so that signaling exchange between different communication devices can be reduced. In addition, the beam hopping pattern can provide more abundant information, so that the resource determined based on the beam hopping pattern to transmit the noise signal can reduce the interference of the noise signal transmitted based on the resource to the service signal as much as possible. The beam hopping pattern corresponding to the first communication device is adjusted based on the plurality of resources used for transmission of the noise signal, so that the interference of the noise signal transmitted based on the resources to the service signal of the first communication device can be reduced.

According to a second aspect, this application provides a signal transmission method. The method includes:
a second communication device obtains a first resource used for transmission of a noise signal, where the first resource includes one or more of the following: first time for transmission of the noise signal, a first coverage area of the noise signal, or a first frequency band of a beam that carries the noise signal; and the second communication device sends a first noise signal based on the first resource.

In this solution, the second communication device may obtain the first resource used for transmission of the noise signal, so that the noise signal can be sent based on the designated first resource, reducing interference to a service signal caused by uncontrollability of a transmission resource for the noise signal.

In a possible implementation, the first noise signal is carried in a first beam. The first beam further carries a first service signal. The first service signal is transmitted based on a second resource. A second coverage area indicated by the second resource does not overlap the first coverage area.

In this solution, one beam carries a noise signal and a service signal, and coverage areas of the noise signal and the service signal do not overlap, so that interference of the noise signal in the beam to the service signal in the beam can be reduced.

In a possible implementation, before the second communication device obtains the first resource used for transmission of the noise signal, the method further includes:
the second communication device sends first information, where the first information is used to request to obtain a resource available for transmission of the noise signal.

In this solution, the second communication device may send, to another communication device (for example, the foregoing first communication device), the first information for requesting to obtain the resource available for transmission of the noise signal. In other words, the first communication device and the another communication device may determine, in a negotiation manner, a resource for transmission of the noise signal, to effectively reduce the interference of the noise signal to the service signal.

In a possible implementation, the first information includes one or more resources available for transmission of the noise signal, and the one or more resources available for transmission of the noise signal include the first resource.

In this solution, when sending the first information to the another communication device, the second communication device may carry one or more candidate resources available for transmission of the noise signal in the first information, where the candidate resource is a resource available for or expected to be used by the first communication device to transmit the noise signal. Therefore, it is convenient for the another communication device to select a resource (for example, the first resource) more suitable for transmission of the noise signal, to reduce the interference of the noise signal transmitted based on the resource to the service signal as much as possible.

In a possible implementation, before the second communication device sends the first noise signal based on the first resource, the method further includes: The second communication device sends second information, where the second information indicates that the first resource is used for transmission of the noise signal.

In this solution, before sending the first noise signal, the second communication device sends a resource used for transmission of the first noise signal, and indicates that the resource is to be used for transmission of the noise signal. Therefore, the another communication device can avoid a service signal transmitted by using the first resource, to avoid interference of the first noise signal.

In a possible implementation, the first resource includes the first time. That the second communication device sends a first noise signal based on the first resource includes: The second communication device sends the first noise signal at the first time.

In this solution, the second communication device sends the first noise signal at the first time, so that the noise signal is sent at the first time. In addition, because the first resource is a resource designated for transmission of the noise signal, transmitting the noise signal at the first time can reduce the interference to the service signal.

In a possible implementation, the first resource includes the first frequency band, and a frequency band of a beam that carries the first noise signal is the first frequency band.

In this solution, the second communication device may transmit the first noise signal by using the beam on the first frequency band. In addition, because the first resource is a resource designated for transmission of the noise signal, transmitting the noise signal by using the first frequency band can reduce the interference to the service signal.

In a possible implementation, the first resource includes the first coverage area. Before the second communication device sends the first noise signal based on the first resource, the method further includes:
the second communication device obtains a first signal;
the second communication device performs peak clipping and filtering on the first signal to obtain a second signal;
the second communication device obtains a peak clipping and filtering noise signal based on the first signal and the second signal; and
the second communication device performs, based on the first coverage area, beamforming on the peak clipping and filtering noise signal to obtain the first noise signal.

In this solution, peak clipping and filtering noise of the first signal is obtained, and beamforming is performed on the peak clipping and filtering noise based on the first coverage area, so that the noise signal can be sent to the first coverage area, to implement spatial separation between the noise signal and the service signal in the beam, to reduce the interference of the noise signal to the service signal.

According to a third aspect, this application provides a signal transmission method. The method includes:
a third communication device receives first information from a first communication device, where the first information is used to request to obtain a resource available for transmission of a noise signal;
the third communication device determines a first target resource from a candidate resource based on the first information, where the first target resource includes one or more resources available for transmission of the noise signal, and the candidate resource is a plurality of resources that are from one or more communication devices and that are available for transmission of the noise signal; and
the third communication device sends the first target resource to the first communication device.

In this solution, the third communication device obtains the resources of the one or more communication devices available for transmission of the noise signal. The first communication device requests the resource available for transmission of the noise signal, and the third communication device selects a resource available for transmission of the noise signal from the resources of the one or more communication devices available for transmission of the noise signal, and sends the resource to the first communication device. On the one hand, this can reduce signaling exchange between the first communication device and a surrounding communication device. On the other hand, the third communication device obtains resources of a plurality of communication devices available for transmission of the noise signal, and may select a resource more suitable for the first communication device to transmit the noise signal. In other words, in this solution, the third communication device, as a coordination center, may obtain and integrate the resources of the plurality of communication devices available for transmission of the noise signal. Therefore, a proper resource can be provided for a communication device that applies for a noise signal transmission resource, to reduce impact of the noise signal on a service signal.

In a possible implementation, the first information includes one or more resources expected by the first communication device to be used for transmission of the noise signal.

In this solution, the first information includes the one or more resources that are expected by the first communication device to be used and that are available for transmission of the noise signal. On the one hand, the third communication device can have more reference bases during resource selection and select a more suitable resource. On the other hand, the first communication device can obtain the resource more suitable for transmission of the noise signal, to reduce interference of the noise signal transmitted by using the resource to the service signal.

In a possible implementation, the method further includes: The third communication device sends a second target resource to a second communication device, where the second target resource includes one or more resources that are determined from the candidate resource and that are available for transmission of the noise signal.

In this solution, the third communication device actively sends, to the second communication device, the resource available for transmission of the noise signal, so that interference of a noise signal generated by the second communication device to a service beam is reduced, and signaling exchange between the second communication device and the third communication device can also be reduced, saving communication resources.

In a possible implementation, the method further includes: The third communication device sends second information, where the second information indicates that the first target resource is used for transmission of a noise signal.

In this solution, the third communication device sends the second information to another communication device, to indicate that the first target resource is used for transmission of a noise signal. Therefore, the another communication device can avoid a service signal transmitted by using the first target resource, to avoid interference of the noise signal.

According to a fourth aspect, this application provides a communication device. The apparatus includes a unit for implementing the method according to any one of the first aspect and the possible implementations of the first aspect.

According to a fifth aspect, this application provides a communication device. The apparatus includes a unit for implementing the method in any one of the second aspect and the possible implementations of the second aspect.

According to a sixth aspect, this application provides a communication device. The apparatus includes a unit for implementing the method in any one of the third aspect and the possible implementations of the third aspect.

According to a seventh aspect, this application discloses a communication device. The communication device may include a processor, a memory, and a transceiver. The transceiver is configured to: receive information from another communication device other than the communication device, and output information to the another communication device other than the communication device. When the processor executes a computer program stored in the memory, the communication device is enabled to perform the method according to any one of the first aspect and the implementations of the first aspect.

According to an eighth aspect, this application discloses a communication device. The communication device may include a processor, a memory, and a transceiver. The transceiver is configured to: receive information from another communication device other than the communication device, and output information to the another communication device other than the communication device. When the processor executes a computer program stored in the memory, the communication device is enabled to perform the method according to any one of the second aspect and the implementations of the second aspect.

According to a ninth aspect, this application discloses a communication device. The communication device may include a processor, a memory, and a transceiver. The transceiver is configured to: receive information from another communication device other than the communication device, and output information to the another communication device other than the communication device. When the processor executes a computer program stored in the memory, the communication device is enabled to perform the method according to any one of the third aspect and the implementations of the third aspect.

According to a tenth aspect, this application provides a computer-readable storage medium. The computer-readable storage medium stores a computer program. The computer program is executed by a processor to implement the method according to any one of the first aspect or the possible implementations of the first aspect.

According to an eleventh aspect, this application provides a computer-readable storage medium. The computer-readable storage medium stores a computer program. The computer program is executed by a processor to implement the method according to any one of the second aspect or the possible implementations of the second aspect.

According to a twelfth aspect, this application provides a computer-readable storage medium. The computer-readable storage medium stores a computer program. The computer program is executed by a processor to implement the method according to any one of the third aspect or the possible implementations of the third aspect.

According to a thirteenth aspect, this application provides a computer program product. When the computer program product is executed by a processor, the method according to any one of the first aspect or the possible implementations of the first aspect is performed.

According to a fourteenth aspect, this application provides a computer program product. When the computer program product is executed by a processor, the method according to any one of the second aspect or the possible implementations of the second aspect is performed.

According to a fifteenth aspect, this application provides a computer program product. When the computer program product is executed by a processor, the method according to any one of the third aspect or the possible implementations of the third aspect is performed.

The solutions provided in the fourth aspect to the fifteenth aspect are used to implement or cooperate to implement the method correspondingly provided in the first aspect, the second aspect, or the third aspect, and therefore, can achieve beneficial effects the same as or corresponding to those of the corresponding method in the first aspect, the second aspect, or the third aspect. Details are not described herein again.

### BRIEF DESCRIPTION OF THE DRAWINGS

To describe the technical solutions in embodiments of this application or in the background more clearly, the following briefly describes the accompanying drawings for describing embodiments of this application or the background.

FIG. 1A is a diagram of a multiple-input multiple-output system;

FIG. 1B is a diagram of beamforming;

FIG. 1C is a diagram of beam sweeping;

FIG. 2A is a diagram of a model curve of a high power amplifier;

FIG. 2B is a diagram of a framework of an OFDM signal transmitting end;

FIG. 2C is a diagram of a peak-to-average power ratio of an OFDM signal;

FIG. 2D is a diagram of spatial energy distribution of an OFDM signal;

FIG. 2E is a diagram of a beam signal direction;

FIG. 2F is a diagram of energy distribution of a noise signal;

FIG. 3A, FIG. 3B, FIG. 3C, and FIG. 3D are diagrams of a communication scenario;

FIG. 4 is a schematic flowchart of a CS and CBF method;

FIG. 5 is a flowchart of a signal transmission method;

FIG. 6A, FIG. 6B, FIG. 7A, and FIG. 7B are diagrams of signal transmission resources;

FIG. 8 and FIG. 9 are diagrams of a framework of a transmitting end that suppresses a PAPR of a multi-beam signal through peak clipping and filtering;

FIG. 10A and FIG. 10B are diagrams of a coverage area of a noise signal;

FIG. 10C is a diagram of interference to an adjacent communication device;

FIG. 11A is a diagram of a communication scenario;

FIG. 11B is a flowchart of a signal transmission method;

FIG. 12A, FIG. 12B, FIG. 13A to FIG. 13D, and FIG. 14A to FIG. 14E are diagrams of signal transmission resources;

FIG. 15 is a diagram of a communication scenario;

FIG. 16 is a flowchart of a signal transmission method;

FIG. 17A is a diagram of a communication scenario;

FIG. 17B is a flowchart of a signal transmission method;

FIG. 18A is a diagram of a communication scenario;

FIG. 18B is a flowchart of a signal transmission method;

FIG. 19A is a diagram of a communication scenario;

FIG. 19B is a flowchart of a signal transmission method;

FIG. 20 and FIG. 21A to FIG. 21C are diagrams of signal transmission resources;

FIG. 22A is a diagram of a communication scenario;

FIG. 22B is a flowchart of a signal transmission method;

FIG. 23A to FIG. 23C are diagrams of signal transmission resources;

FIG. 24A is a diagram of a communication scenario;

FIG. 24B and FIG. 25 are flowcharts of a signal transmission method;

FIG. 26 is a diagram of signal transmission resources;

FIG. 27A is a diagram of PAPR simulation;

FIG. 27B is a diagram of PAPR noise suppression effects; and

FIG. 28 to FIG. 31 are diagrams of a structure of a communication device.

### DETAILED DESCRIPTION OF ILLUSTRATIVE EMBODIMENTS

The following describes embodiments of this application with reference to the accompanying drawings in embodiments of this application.

Before the technical solutions provided in this application are described, a beamforming technology and a peak clipping and filtering technology in this application are first described.

Beamforming is also referred to as beam forming, space domain filtering, spatial filtering, or spatial separation processing. The beam is a set of a plurality of electromagnetic waves sent by a signal transmitting end. The signal transmitting end may be a device that sends an electromagnetic wave signal, such as a ground signal base station, an air signal base station, a network device (such as a router, a switch, or a wireless access point), or a satellite.

The beamforming technology is a beam management technology generated in the development of multiple-input multiple-output (MIMO).

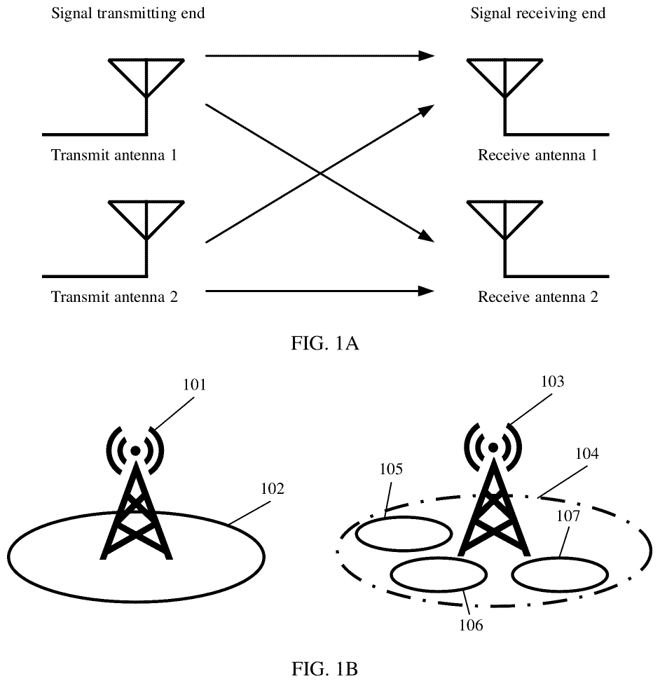

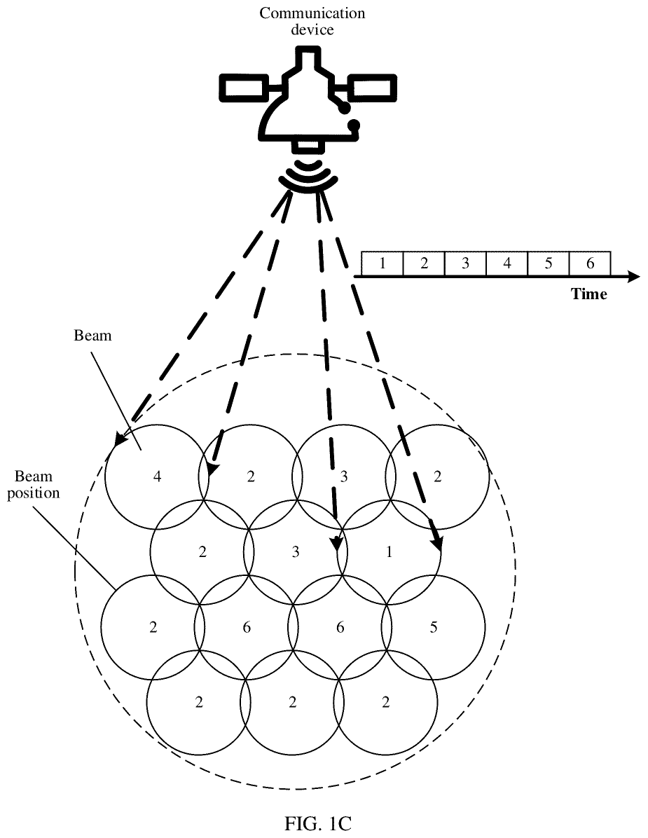

For MIMO, refer to FIG. 1A as an example. In a possible implementation, in FIG. 1A, two inputs and two outputs are used as an example. To be specific, a signal transmitting end has two antennas: a transmit antenna 1 and a transmit antenna 2, and a signal receiving end also has two antennas: a receive antenna 1 and a receive antenna 2. Both the signal transmitting end and the signal receiving end have two antennas, and therefore, two channels of data can be received and sent at the same time. It may be understood that in another possible implementation, in MIMO, a signal transmitting end and a signal receiving end are not limited to two antennas, and may have at least two antennas at any quantity. In addition, for example, a quantity of transmit antennas may be unequal to a quantity of receive antennas. A channel capacity of MIMO may increase linearly with an increase of a quantity of antennas, and MIMO-based spectrum utilization may be multiplied without increasing a bandwidth and transmit power of the antenna.

The beamforming technology can obtain a high-gain directional beam on the basis of high spectrum utilization of MIMO. The directional beam is a beam sent to a specified area, and is an external embodiment of the beamforming technology. In the beamforming technology, a plurality of antenna units are adjusted, so that energy of a plurality of radio signals transmitted by the plurality of antenna units forms signal energy superposition at a location of the signal receiving end, improving strength of a received signal. In addition, signal energy is weakened in a non-target area, reducing interference of the signal to the non-target area.

For ease of understanding the beamforming technology, for a possible implementation, refer to FIG. 1B as an example. In FIG. 1B, the beamforming technology is not used for a signal transmitted by a signal base station 101, and a coverage area 102 of the signal is a fixed area. The beamforming technology is used for a signal transmitted by a signal base station 103, and a coverage area 104 of the signal is a non-fixed area larger than the coverage area 102. The coverage area 104 includes a plurality of small coverage areas such as a coverage area 105, a coverage area 106, and a coverage area 107, and these small coverage areas are usually referred to as beam positions. The beam position may be understood as that a coverage area of a signal transmitting end (for example, a satellite), a part of an area on the earth, or a ground area on the entire earth is divided by using a coverage area of a single beam as a unit, and a coverage area of each beam is referred to as a beam position. Generally, the signal base station 103 cannot simultaneously transmit a plurality of beams to provide services for all beam positions in the coverage area 104, and generally provides services for the plurality of beam positions by using a time division method.

It may be understood that a non-terrestrial network (NTN) is used as an example. Compared with a conventional mobile communication system, satellite communication in the NTN has advantages such as a wider coverage area, independence of a transmission link and communication costs and a transmission distance, and a capability of overcoming natural geographical obstacles such as oceans, deserts, and mountains. To overcome disadvantages of a conventional communication network, satellite communication may serve as an effective supplement to the conventional network. However, compared with terrestrial communication, a satellite in a satellite communication network has limited power and a great propagation loss. To improve a link budget and a signal-to-noise ratio of a terminal device, the satellite uses a large-scale antenna array to form a formed beam with a larger gain, to overcome the great propagation loss. However, transmission of such narrow beams by the satellite increases a quantity of beam positions in the coverage area of the satellite. As shown in FIG. 1C, black circles represent beam positions in the figure, and all beam positions form a coverage area of a communication device (for example, the satellite). For example, the satellite is used as an example. A satellite orbit height is 1150 km, a coverage diameter of a single beam is about 26 km, and a coverage area of one satellite may be divided into about 700 beam positions to complete full coverage.

The satellite is still used as an example. A hardware resource on the satellite is limited, and a quantity of beams that can be simultaneously transmitted is limited. For example, one satellite may simultaneously transmit eight beams, that is, simultaneously transmit signals covering eight beam positions. In this case, a quantity of beams simultaneously transmitted by the satellite is far less than a quantity of beam positions in a coverage area of the satellite, and the coverage area of the satellite cannot be simultaneously covered at a same moment. A beam time division multiplexing manner needs to be used to provide services for terminal devices in different beams of the satellite. This manner is also referred to as beam hopping. As shown in FIG. 1C, a beam transmitted by the satellite irradiates different beam positions in different time periods, that is, provides services for different beam positions in a time division multiplexing manner, which may also be described as that the beam sequentially scans the beam positions. For example, numbers 1, 2, 3, 4, 5, 6, and 7 in FIG. 1C represent an order in which the communication device sends beam signals to the beam positions. For example, the communication device in FIG. 1C sequentially provides beam signals for the beam positions whose numbers are 1, 2, 3, 4, 5, and 6. The communication device may provide beam signals for one or more beam positions each time.

In addition, it may be understood that if the quantity of beams that can be simultaneously transmitted by the satellite is less than a quantity of coverage areas of beams for which services need to be improved in the coverage area of the satellite, the satellite cannot simultaneously provide services for the coverage areas of all the beams, and provides, in a time division manner, services for the coverage areas of the beams for which services need to be provided. An information set including information such as time or a frequency band for service provision for one or more beam positions (beams) by the satellite is referred to as a beam hopping pattern.

It may be understood that the foregoing related concepts are mainly described by using the satellite as an example, and in specific implementation, may be applicable to another signal transmitting end, for example, applicable to a signal base station on the ground or an air signal base station. This is not limited in embodiments of this application.

In a possible implementation, the beam position is not a fixed coverage area, and the coverage area may change with movement of the terminal device, so that a transmitted signal has a maximum gain. This manner in which a coverage area of a beam can be adjusted in real time based on a situation is also referred to as adaptive beamforming. On the contrary, a manner in which a beam has a fixed coverage area is referred to as fixed beamforming.

In specific implementation, after beamforming is performed on a service beam that carries a service signal, the service beam may be transmitted to a specified beam position. The specified beam position is a coverage area of the service beam.

It may be understood that the coverage area represented by any one of the foregoing beam positions may be ground, space, or underwater. This is not limited in embodiments of this application. For example, the beam position may be represented by using longitude and latitude. For example, the beam position may be represented by a coverage area from longitude 73°33′ east to longitude 73°58′ east and from latitude 3°43′ north to latitude 4°21′ north. Alternatively, a named area may be used for representation. For example, an area in which a city is located is a beam position, or an area in which a village or town is located is a beam position. It may be understood that a size and a shape of a coverage area of a beam position may be adjusted based on a requirement. This is not limited in embodiments of this application.

A resource used for transmission of the service beam further includes time for transmission of the service beam, a frequency band of the service beam, and the like. The coverage area of the service beam is usually a coverage area of the service signal. For example, a terminal device in the coverage area may receive a stable service signal. A terminal device outside the coverage area may also receive the service signal, but signal quality of the service signal is poor, and the signal is unstable.

The time may be absolute time, for example, coordinated time or Greenwich mean time. The time may alternatively be relative time, for example, a frame number, a subframe number, a slot number, or a symbol sequence number. For example, the time may be (+0800) the 5th millisecond of 00:01 on Jan. 1, 2001 to (+0800) the 15th millisecond of 00:01 on Jan. 1, 2001.

A unit of the frequency band may be hertz (Hz) or kilohertz (kHz), or may be a frequency domain unit such as a resource block (RB), a resource element (RE), a resource block group (RBG), a resource element group (REG), or a channel control element (CCE).

Generally, a signal in the foregoing service beam needs to pass through an HPA, to increase transmit power of the signal. However, when the HPA operates near a linear saturation region, a high peak-to-average power ratio signal transmitted by a transmitting end may be nonlinearly distorted, causing in-band distortion and out-of-band radiation of an output signal. In other words, decoding accuracy of a signal receiving end is affected, and interference is caused to a user on an adjacent channel. For example, the high peak-to-average power ratio signal may be, for example, an orthogonal frequency division multiplexing (OFDM) signal, a discrete Fourier transform-spread-orthogonal frequency division multiplexing (DFT-S-OFDM) signal, a MIMO-OFDM signal, a time division-synchronous code division multiple access (TD-SCDMA) signal, or a quadrature amplitude modulation (QAM) signal. A waveform of the signal is not limited in this application, and a method in this application may be used for a waveform that has a peak-to-average power ratio suppression requirement.

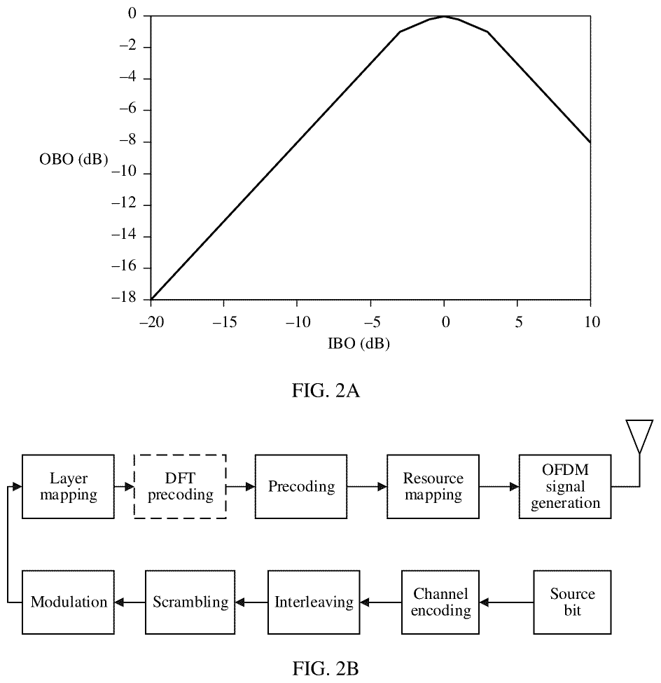

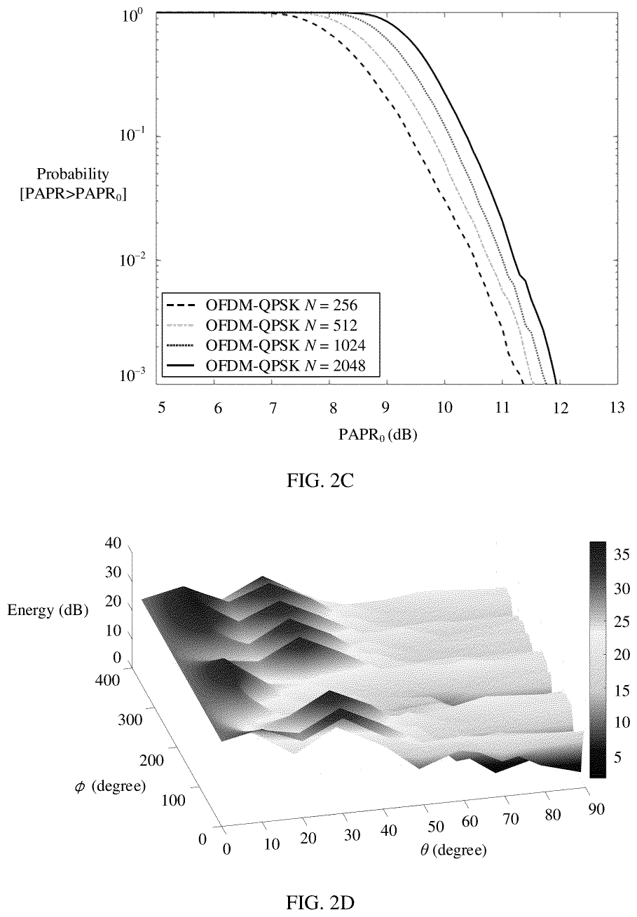

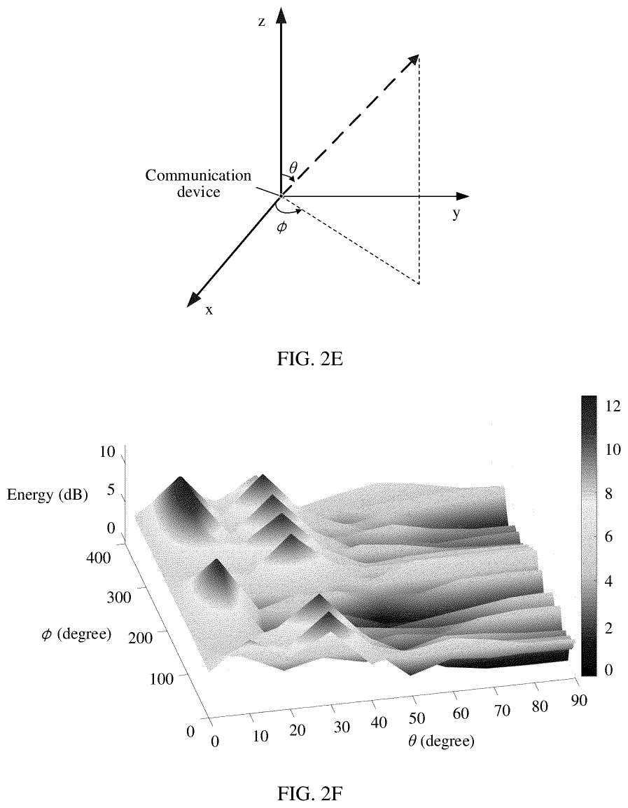

For a possible implementation, refer to FIG. 2A as an example. This figure is a curve diagram that simulates a change of an input back-off (IBO) value and an output back-off (OBO) value of the high peak-to-average power ratio signal that passes through the HPA. The foregoing IBO represents a ratio of an average amplitude of an input signal to an amplitude value at a saturation point (a maximum input amplitude value allowed in a linear region). The foregoing OBO represents a ratio of an average amplitude of the output signal of the power amplifier to the amplitude value at the saturation point (the maximum output amplitude value allowed in the linear region). It can be learned from FIG. 2A that average power/amplitude of the signal input to the power amplifier is close to the saturation point (at the saturation point, IBO=o dB or OBO=o dB), an instantaneous signal amplitude exceeds the saturation point in the linear region, the input signal may enter a nonlinear region, and an output of the power amplifier may be severely nonlinearly distorted.

To suppress a high peak-to-average power ratio of the signal, a peak clipping and filtering technology is usually used. The peak clipping and filtering technology is divided into a peak clipping part and a filtering part, where the peak clipping part may be represented by the following formula:

$$y [ n ] = \{ \begin{matrix}x [ n ] , \vert x [ n ] \vert \leq A \\ {Ae}^{j∠x [ n ]} , \vert x [ n ] \vert > A\end{matrix}$$

A is a peak clipping threshold. When an amplitude of an input signal x[n] is greater than A, the amplitude of the input signal x[n] is reduced to A, and a phase remains unchanged. When the amplitude of the input signal x[n] is not greater than A, the input signal is not processed.

The filtering part filters out out-of-band noise of a peak-clipped signal y[n], to avoid interference to the user on an adjacent frequency band. However, filtering cannot filter out in-band noise (peak clipping and filtering noise for short), and a coverage area of the peak clipping and filtering noise is greater than the coverage area of the service signal in the service beam, and even affects a signal transmitted by a surrounding signal transmitting end.

To more clearly show that a coverage area of a peak clipping and filtering noise signal is larger than an aggregate coverage area of the service signal in the service beam, an OFDM signal is used as an example to simulate spatial energy distribution of a plurality of beam signals transmitted by a communication device. The plurality of beam signals are transmitted at same time. FIG. 2B is a block diagram of a transmitting end of the OFDM signal. PAPR performance of the OFDM signal is shown in FIG. 2C. For example, spatial energy distribution of an OFDM signal on which peak clipping and filtering processing is not performed is shown in FIG. 2D. This figure is a diagram of the spatial energy distribution of the OFDM signal on which peak clipping and filtering processing is not performed. It can be learned that signal energy in the figure is concentrated in a plurality of directions, for example, a beam direction in which θ=30 degrees and ϕ=10 degrees. For a beam direction of an antenna array indicated by θ and ϕ, refer to a diagram of a beam signal direction shown in FIG. 2E. It may be understood that a beam direction determines a coverage area of a beam. In FIG. 2E, an origin of an x-axis, a y-axis, and a z-axis may be understood as a location of the communication device. The beam signal direction may be controlled by controlling an angle ϕ of an x-y plane and an angle θ of an x-z plane. Therefore, θ and ϕ may be used to represent the beam direction.

Peak clipping and filtering is performed on the plurality of beam signals transmitted by the communication device, and spatial energy distribution of a peak clipping and filtering noise signal generated through peak clipping and filtering is simulated, for example, as shown in FIG. 2F. Compared with FIG. 2D, it can be learned from FIG. 2F that in addition to having an energy in the foregoing beam signal direction, the peak clipping and filtering noise signal also has energy in another coverage area, causing interference to a beam signal in the another coverage area.

FIG. 2D, FIG. 2E, and FIG. 2F are merely examples for describing a coverage area of a peak clipping and filtering noise signal being larger than a coverage area of a beam signal on which peak clipping and filtering is not performed, and do not constitute a limitation on this application.

In specific implementation, the peak clipping and filtering noise is noise generated to suppress a PAPR of the signal, so that the peak clipping and filtering noise may also be referred to as PAPR suppression noise.

It may be understood that a coverage area of a service beam is usually a coverage area of a service signal in the service beam. For example, sending a service beam to a beam position means sending a service signal in the service beam to the beam position. For example, that a diameter of the service beam is 100 km means that a diameter of the service signal in the service beam is 100 km. For example, signal quality of the service beam may be understood as signal quality of the service signal in the service beam.

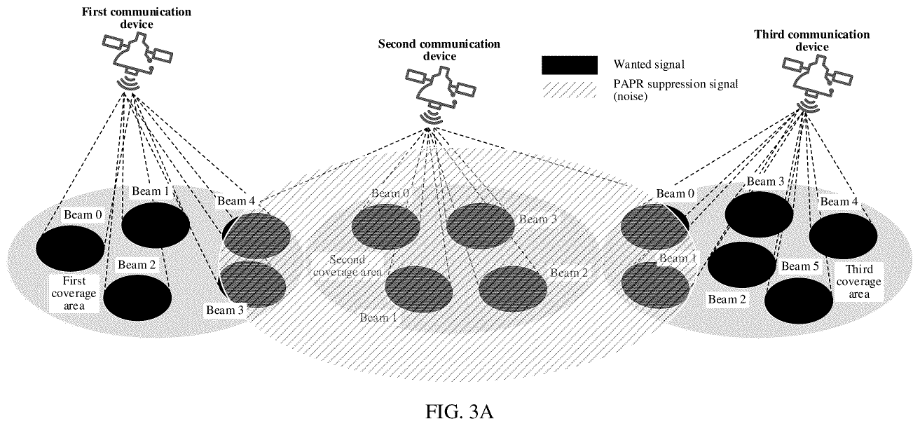

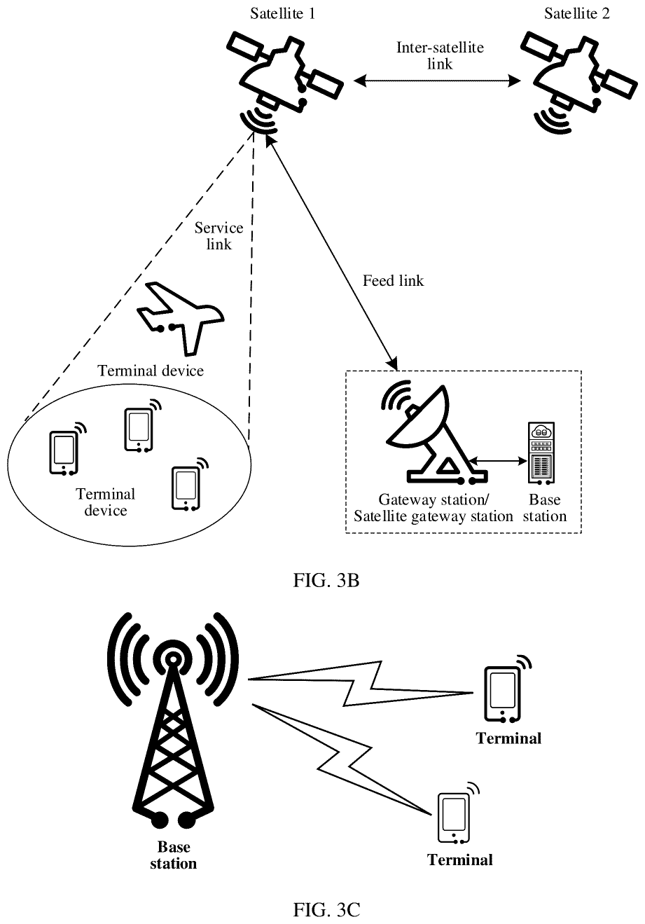

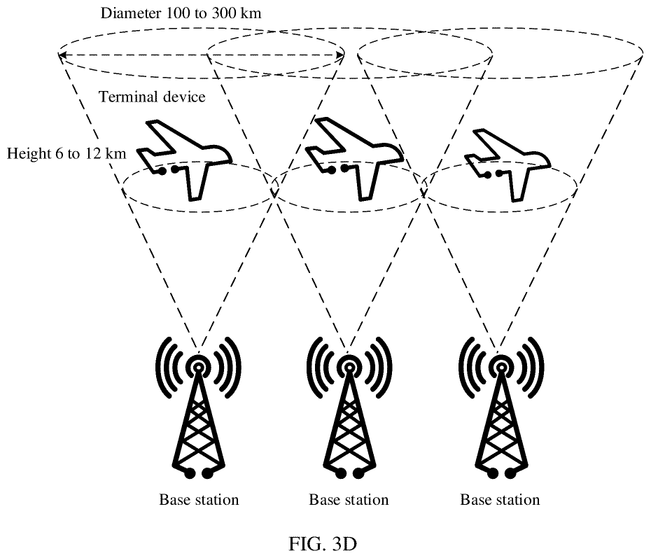

For a possible implementation, refer to FIG. 3A as an example. A first coverage area of a service signal transmitted by a first communication device is adjacent to a second coverage area of a signal transmitted by a second communication device, and the second coverage area of a service signal transmitted by the second communication device is adjacent to a third coverage area of a signal transmitted by a third communication device. A beam transmitted by the second communication device is a beam 0, a beam 1, a beam 2, and a beam 3 in the second coverage area. A coverage area of a noise signal accompanying the beam is larger than a signal coverage area of the second communication device. This not only affects the beam in the second coverage area, but also affects some beams in the first coverage area and the third coverage area. Therefore, to reduce interference of peak clipping and filtering noise to the service signal in a noise coverage area and improve signal quality of the service signal, this application provides a signal transmission method.

For a communication scenario in which the second communication device sends the service signal to the second coverage area, refer to FIG. 3B as an example. The scenario includes satellites, terminal devices, a gateway station/satellite gateway station, and a base station. A communication link between the satellite and the terminal device is referred to as a service link. A communication link between the satellite and the gateway station is referred to as a feed link. A communication link between the satellites is referred to as an inter-satellite link. The satellite in FIG. 3B may be classified into a transparent mode and a regenerative mode based on an operation mode. In the transparent mode, the satellite has a signal relaying and forwarding function. In addition, the gateway station/satellite gateway station has a function of the base station or some functions of the base station. Therefore, the gateway station/satellite gateway station may be considered as a base station. Alternatively, the base station may be deployed separately from the gateway station/satellite gateway station. In this case, a delay of the feed link includes a delay from the satellite to the gateway station/satellite gateway station and a delay from the gateway station/satellite gateway station to the base station. In the regenerative mode, the satellite has a data processing capability, the function of the base station, or some functions of the base station. Therefore, the satellite in the regenerative mode may be considered as a base station. The base station or the device used as a base station is connected to a core network.

For example, the terminal device may be, for example, any possible terminal device, a network device, a base station, a subscriber station, a mobile station, a transport device, or a smart home device.

For example, the terminal device may include but is not limited to any electronic product based on an intelligent operating system capable of performing man-machine interaction with a user via an input device such as a keyboard, a virtual keyboard, a touchpad, a touchscreen, or a voice control device, for example, a smartphone, a tablet computer (tablet personal computer (Tablet PC)), a handheld computer, a wearable electronic device, a personal computer (PC), and a desktop computer. The intelligent operating system includes but is not limited to any operating system that enriches functions of a device by providing various applications for the device, for example, an operating system like Android, IOS, Windows, MAC, or HarmonyOS.

For example, the network device may include but is not limited to a switch, a router, a bridge, a hub, a gateway, a server, a network interface card, a wireless access point, a modem, an optical transceiver, an optical fiber transceiver, or the like.

For example, the transport device may include but is not limited to a vehicle, a ship, or an aircraft (for example, an airplane, an uncrewed aerial vehicle, or a hot air balloon).

For example, the smart home device may include but is not limited to a smart sound box, an air conditioner, a washing machine, or a television.

It may be understood that the foregoing description of the terminal device is merely an example, and does not constitute any limitation on embodiments of this application.

In another possible implementation, in the communication scenario shown in FIG. 3B, the satellite may alternatively be another communication service device. The another communication service device may have a communication service function the same as or similar to that of the satellite. For example, the another communication service device may be, for example, an aerial aircraft such as an uncrewed aerial vehicle, an airplane, or a hot air balloon. The description herein is merely an example, and does not constitute any limitation on embodiments of this application.

In a possible implementation, embodiments of this application may also be applied to a terrestrial communication scenario shown in FIG. 3C. The scenario includes a base station (or a network device) and terminal devices. The base station (or the network device) may provide a service for the terminal device. For a specific example of the terminal device, refer to the foregoing descriptions. Details are not described herein again.

In a possible implementation, embodiments of this application may also be applied to an air-to-ground (ATG) communication scenario shown in FIG. 3D. The scenario includes ground base stations and terminal devices. The terminal device includes a high-altitude aircraft, a handheld terminal on an aircraft, or the like. The high-altitude aircraft may be an airplane, an uncrewed aerial vehicle, a hot air balloon, or the like. For example, in the air-to-ground communication scenario, a flight height of the terminal device is generally 6 to 12 km, and a diameter of a service signal is approximately 100 to 300 km. The description herein is merely an example, and does not constitute any limitation on embodiments of this application. It can be further learned from FIG. 3D that coverage areas of service signals transmitted by two adjacent base stations overlap, prone causing interference between signals.

It may be understood that the foregoing described application scenarios are merely examples, and do not constitute limitations on embodiments of this application.

To reduce interference of a noise signal that suppresses a high peak-to-average power ratio to a surrounding service beam, a possible implementation is a coordinated scheduling (CS) and coordinated beamforming (CBF) solution.

CS is a time domain and frequency domain interference coordination technology. It coordinates time domain and frequency domain resources of interfering users between communication devices and does not schedule other users on interfering RBs. This improves performance of interfered users, thereby improving performance of edge users.

CBF adjusts transmit weights of interfering users to change transmit directions of beams. When performance losses of the interfering users are small, this significantly improves performance of interfered users, thereby improving performance of edge users.

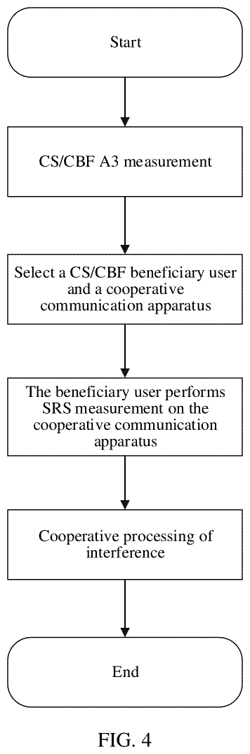

For example, a possible implementation process of CS and CBF is shown in FIG. 4.

### 1. CBF/CS Measurement (SSB)

After a service is set up, a terminal device (user equipment (UE)) starts SSB RSRP measurement, and when an A3 event is satisfied, report an A3 measurement report. The A3 event is that signal quality of an adjacent communication device is better than that of the communication device by a specific difference.

### 2. Determine a CBF/CS Cooperative Communication Device and UE

A base station selects, from the received A3 event measurement report, a communication device that satisfies the condition. A maximum of three communication devices with best signal quality are selected as CBF/CS cooperative communication devices. The UE that reports the A3 event measurement report is selected as the CBF/CS UE. When no communication device satisfies the condition, the procedure ends.

### 3. CBF/CS Measurement

Channel sounding reference signal (SRS) measurement: After recognizing the CBF/CS UE, the base station separately performs SRS measurement on the communication device and the cooperative communication device.

### 4. Interference Coordination Processing

It is determined, based on SRS measurement results reported by the communication device and the cooperative communication device, whether CS or CBF can be performed. If CS is performed, frequency division multiplexing is performed for interference coordination. If CBF is performed, beam adjustment is performed for interference avoidance.

PAPR suppression noise in the foregoing CS and CBF method procedure cannot implement interference avoidance through CS and CBF, because the PAPR suppression noise is a random signal and cannot implement measurement feedback like a known SSB signal. Therefore, a problem of interference of PARP suppression noise of an adjacent communication device to the adjacent communication device cannot be resolved. In addition, a measurement feedback mechanism further has problems of a long round-trip delay, a large quantity of occupied time-frequency resources, and high complexity.

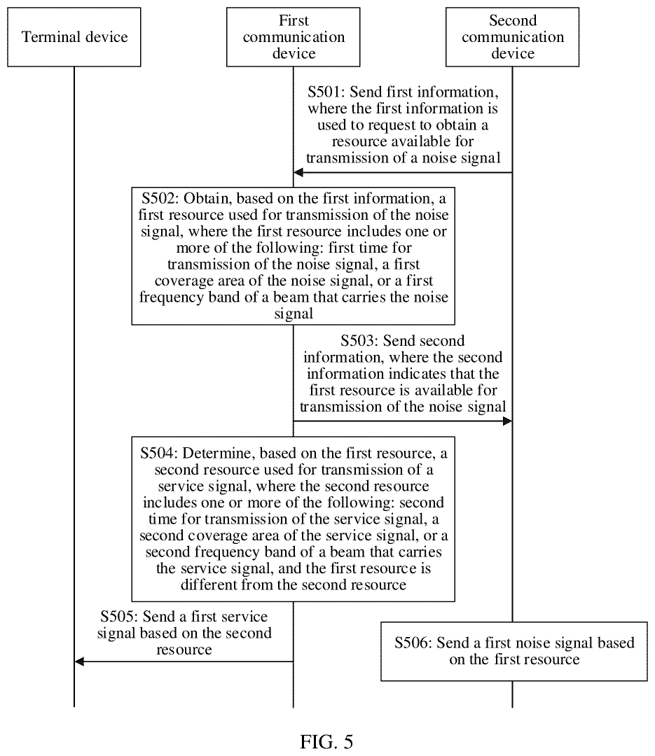

Because the foregoing implementation solutions have the foregoing defects, an implementation of this application provides a signal transmission method, to better reduce interference of a noise signal to a service signal. For example, FIG. 5 shows a signal transmission method provided in an embodiment of this application, including, but not limited to, the following steps.

S501: A second communication device sends first information to a first communication device, where the first information is used to request to obtain a resource available for transmission of a noise signal.

The second communication device and the first communication device may be two adjacent signal transmitting ends. Coverage areas of signals transmitted by the two signal transmitting ends are adjacent or overlap. For example, refer to FIG. 3A. For example, the second communication device may be, for example, the second communication device in FIG. 3A, and the first communication device may be the first communication device in FIG. 3A. In another possible implementation, the second communication device may be, for example, the satellite 2 in FIG. 3B, and the first communication device may be the satellite 1 in FIG. 3B. In another possible implementation, in the scenario shown in FIG. 3C or FIG. 3D, the second communication device and the first communication device may be two adjacent base stations or network devices. It may be understood that this is merely an example, and does not constitute any limitation on this embodiment of this application.

The resource available for transmission of the noise signal may include one or more of the following: a time resource for sending the noise signal, a frequency band resource of a beam that carries the noise signal, or a coverage area of the noise signal. The noise signal may be, for example, a noise signal transmitted by the second communication device. The noise signal may be, for example, a peak clipping and filtering noise signal.

In specific implementation, the second communication device has a requirement for suppressing a PAPR of a signal, that is, needs to suppress a peak-to-average power ratio of a sent service signal, for example, suppress the peak-to-average power ratio of the sent signal by using a peak clipping and filtering technology. To avoid interference of a generated peak-to-average power ratio suppression noise (for example, peak clipping and filtering noise) signal to a signal sent by an adjacent signal transmitting end (for example, the foregoing first communication device) (that is, interference to receiving, by a terminal device, a signal from the first communication device), the second communication device sends, to the first communication device, information (that is, the foregoing first information) used to request to obtain the resource available for transmission of the noise signal.

In a possible implementation, the first information is request information for obtaining the resource available for transmission of the noise signal, and the request information does not include a candidate resource for transmission of the noise signal.

In another possible implementation, the first information includes one or more resources available for transmission of the noise signal. The one or more resources available for transmission of the noise signal are candidate resources selected by the second communication device for transmission of the noise signal.

S502: The first communication device determines, based on the first information, a first resource used for transmission of the noise signal, where the first resource includes one or more of the following: first time for transmission of the noise signal, a first coverage area of the noise signal, or a first frequency band of a beam that carries the noise signal.

S503: The first communication device sends second information to the second communication device, where the second information indicates that the first resource is available for transmission of the noise signal.

For example, after receiving the first information from the second communication device, the first communication device may obtain or determine, based on the first information, the first resource used by the second communication device to transmit the noise signal.

The following first describes, by using an example in different cases when the first information is the request information for obtaining the resource available for transmission of the noise signal and the request information does not include the candidate resource for transmission of the noise signal, a specific implementation in which the first communication device obtains the first resource based on the first information.

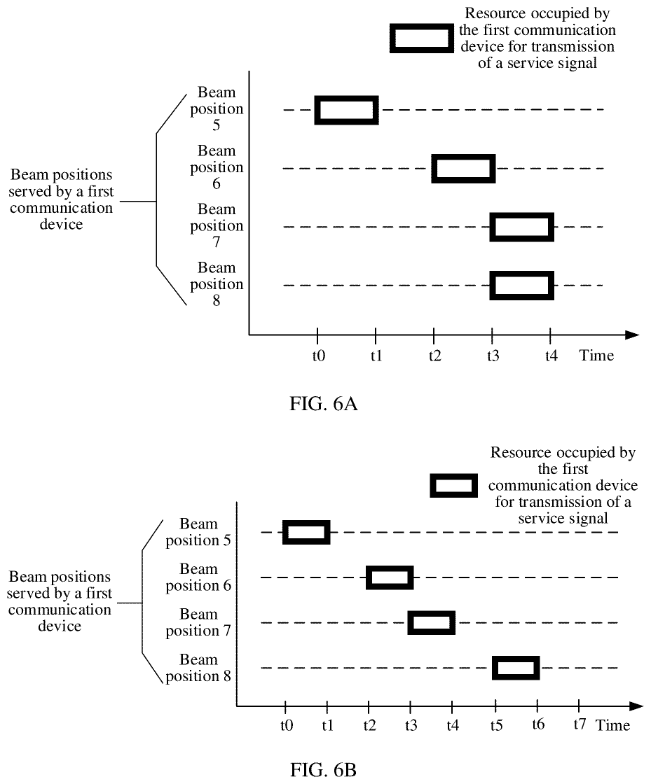

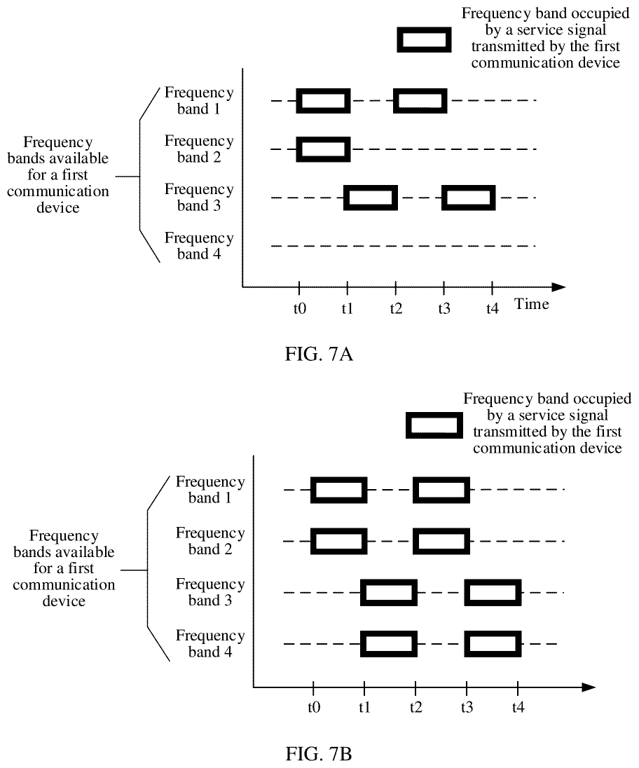

In a first case, in a possible implementation, the first resource includes the first time. The following describes, with reference to FIG. 6A and FIG. 6B, a specific implementation in which the first communication device obtains the first time.

In FIG. 6A, for example, the first communication device serves four beam positions in total, including a beam position 5, a beam position 6, a beam position 7, and a beam position 8. In the figure, a rectangle with a black border represents a resource occupied by the first communication device for transmission of a service signal, and the resource includes time for transmission of the service signal and a beam position served by the service signal. It can be learned from the figure that in a time period t0 to t1, a service signal transmitted by the first communication device serves the beam position 5. In a time period t1 to t2, the first communication device transmits no service signal. In a time period t2 to t3, a service signal transmitted by the first communication device serves the beam position 6. In a time period t3 to t4, a service signal transmitted by the first communication device serves the beam position 7 and the beam position 8. It may be learned that in the time period t1 to t2, the first communication device transmits no service signal. In this case, the first communication device may determine the time period t1 to t2 as time (that is, the first time) for transmission of the noise signal, and send the time period t1 to t2 to the second communication device. Information that the first communication device serves different beam positions in time t0 to t4 is stored in the first communication device. Because the first communication device transmits no service signal in the time period t1 to t2, interference of a noise signal transmitted by the second communication device in the time period t1 to t2 to the service signal of the first communication device may be reduced, that is, interference of the second communication device to receiving a signal of the first communication device by a terminal device is reduced.

It may be understood that if the resource sent by the first communication device to the second communication device includes only the time, for another resource that is not described, for example, a frequency band and a coverage area, the second communication device may select, based on existing data and/or a program of the second communication device, the frequency band used for transmission of the noise signal, and the coverage area.

In the foregoing implementation, the first communication device uses an idle time resource as the time resource used by the second communication device to transmit the noise signal. Therefore, interference of the noise signal sent by the second communication device based on the time resource to the service signal sent by the first communication device is reduced.

In another possible implementation, the first time may include a plurality of time periods available for transmission of the noise signal. For example, in FIG. 6B, the first communication device serves four beam positions in total, including a beam position 5, a beam position 6, a beam position 7, and a beam position 8. In the figure, a rectangle with a black border represents a resource occupied by the first communication device for transmission of a service signal, and the resource includes time for transmission of the service signal and a beam position served by the service signal. It can be learned from the figure that the first communication device transmits no service signal in three time periods t1 to t2, t4 to t5, and t6 to t7. Therefore, the resource that is sent by the first communication device to the second communication device and that is used for transmission of the noise signal includes the three time periods t1 to t2, t4 to t5, and t6 to t7 (that is, the first time), and interference of a noise signal sent by the second communication device in the time t1 to t2, t4 to t5, and t6 to ty to the service signal sent by the first communication device may be reduced. Information that the first communication device serves different beam positions in the time t0 to t4 is stored in the first communication device. It may be understood that the resource sent by the first communication device to the second communication device includes only the time, and for another resource that is not described, for example, a frequency band and a coverage area, the second communication device may select, based on existing data and/or a program of the second communication device, the resource used for transmission of the noise signal.

In a second case, in a possible implementation, the first resource includes the first frequency band. The first communication device may obtain, based on a frequency band of the service signal, a frequency band used by the second communication device to transmit the noise signal. The following provides an example for description with reference to FIG. 7A.

For example, a frequency band available for the first communication device in FIG. 7A includes a frequency band 1, a frequency band 2, a frequency band 3, and a frequency band 4. Similarly, the second communication device may also use the frequency band 1, the frequency band 2, the frequency band 3, and the frequency band 4 when transmitting a service signal. For example, the frequency band 1 is 29.6 GHz to 29.7 GHZ, the frequency band 2 is 29.7 GHz to 29.8 GHz, the frequency band 3 is 29.9 GHz to 30.0 GHZ, and the frequency band 4 is 30.1 GHZ to 30.2 GHz. It may be understood that this is merely an example, and does not constitutes a limitation on this embodiment of this application. In the figure, a rectangle with a black border represents a resource occupied by the first communication device for transmission of a service signal, and the resource includes time for transmission of the service signal and a frequency band of a beam that carries the service signal. A time period t0 to t1 is used as an example. In the time period t0 to t1, the frequency band 1 and the frequency band 2 are used for a service signal transmitted by the first communication device. For another time period, refer to the descriptions of the time period t0 to t1. Details are not described herein again. It can be learned from FIG. 7A that the first communication device does not use the frequency band 4 in the time period t0 to t4. In this case, the resource that is sent by the first communication device to the second communication device and that is used by the second communication device to transmit the noise signal may include the frequency band 4 (that is, the first frequency band). When the second communication device receives a frequency band resource, it indicates that the second communication device may transmit the noise signal by using the frequency band. The frequency bands occupied by the service signal transmitted by the first communication device shown in FIG. 7A is stored in the first communication device. It may be understood that if the resource sent by the first communication device to the second communication device includes only the frequency band, for another resource that is not described, for example, time and a coverage area, the second communication device may select, based on existing data and/or a program of the second communication device, the resource used for transmission of the noise signal.

The second communication device receives a frequency band used for transmission of the noise signal, but does not limit time for transmission of the noise signal by using the frequency band. In a possible implementation, this indicates that transmission of the noise signal on this frequency band is not limited by time. Alternatively, in another possible implementation, the second communication device may transmit, by default, the noise signal by using the frequency band within preset duration after receiving the frequency band. The preset duration may be, for example, one minute, one hour, or one day. Specific duration is not limited in this application.

In a third case, in a possible implementation, the first resource includes the first coverage area. The first communication device obtains, through calculation with reference to a resource (for example, a beam hopping pattern) used by the first communication device to transmit a service signal, one or more groups of resources available for the second communication device to transmit the noise signal, where each group of resources includes a coverage area of the noise signal. For example, a coverage area of the service signal in the first communication device includes a beam position 1, a beam position 2, a beam position 3, and a beam position 4. In this case, the first communication device may select one or more beam positions from the plurality of beam positions as the first coverage area, and send the first coverage area to the second communication device. Optionally, after the first communication device selects the one or more beam positions as the first coverage area, the first communication device may no longer send a service signal to the one or more beam positions, to reduce interference of the noise signal to the service signal. It may be understood that this is merely an example, and does not constitute any limitation on this embodiment of this application.

In a fourth case, in a possible implementation, the first resource includes the first time and the first frequency band. The following provides an example for description with reference to FIG. 7A. For example, refer to FIG. 7B. A frequency band available for the first communication device in FIG. 7B includes a frequency band 1, a frequency band 2, a frequency band 3, and a frequency band 4. For example, in a time period t0 to t1, the first communication device transmits a service signal by using the frequency band 1 and the frequency band 2. In the time period t0 to t1, the first communication device does not transmit the service signal by using the frequency band 3 and the frequency band 4. In this case, the time period t0 to t1 may be used as the first time, and the frequency band 3 and the frequency band 4 may be sent to the second communication device as the first frequency band. The second communication device transmits the noise signal by using one or more of the frequency band 3 or the frequency band 4 in the time period t0 to t1 based on the foregoing resource. Therefore, interference of noise generated by the second communication device to the service signal transmitted by the first communication device is reduced. The frequency bands occupied by the service signal transmitted by the first communication device shown in FIG. 7B is stored in the first communication device. It may be understood that the resource sent by the first communication device to the second communication device includes the frequency band and time, and for another resource that is not described, for example, a coverage area, the second communication device may select, based on existing data and/or a program of the second communication device, the resource used for transmission of the noise signal.

In a fifth case, in a possible implementation, the first resource includes the first time and the first coverage area. The following provides an example for description with reference to FIG. 6A.

For example, FIG. 6A shows resources occupied by the first communication device for transmission of a service signal. In this case, the first communication device may select the first time and the first coverage area based on the resource. For example, the first communication device may select some or all of idle time resources in the resource as the first time; and the first communication device may select some or all of idle beam position resources in the resource as the first coverage area. For example, in FIG. 6A, the first communication device may select, as the first time, one or more of four time periods: a time period t0 to t1, a time period t1 to t2, a time period t2 to t3, and a time period t3 to t4. In other words, the first time includes the one or more time periods. Similarly, the first communication device may select, as the first coverage area, one or more of four beam positions: a beam position 5, a beam position 6, a beam position 7, and a beam position 8. In other words, the first coverage area includes the one or more beam positions. After determining the first time and the first coverage area, the first communication device may send the first time and the first coverage area to the second communication device.

In a sixth case, in a possible implementation, the first resource includes the first frequency band and the first coverage area. In this case, the first communication device obtains the first frequency band and the first coverage area with reference to a resource (for example, a beam hopping pattern) used by the first communication device to transmit a service signal. For example, for the resource used by the first communication device to transmit the service signal, refer to Table 1 for an example. In this case, the first communication device may select a frequency band 1 as the first frequency band, and select a beam position 2 as the first coverage area. Alternatively, the first communication device may select a frequency band 2 as the first frequency band, and select a beam position 1 as the first coverage area. After determining the first time and the first coverage area, the first communication device may send the first time and the first coverage area to the second communication device.

TABLE 1

| Frequency band for transmission | Coverage area of |
|---|---|
| of a service signal | the service signal |
| Frequency band 1 | Beam position 1 |
| Frequency band 2 | Beam position 2 |

It may be understood that the resource sent by the first communication device to the second communication device includes only the frequency band and the coverage area, and for another resource that is not described, the second communication device may select, based on existing data and/or a program of the second communication device, the resource used for transmission of the service signal.

In a seventh case, in a possible implementation, the first resource includes the first time, the first frequency band, and the first coverage area. In this case, the first communication device obtains the first time, the first frequency band, and the first coverage area with reference to a resource (for example, a beam hopping pattern) used by the first communication device to transmit a service signal. For example, the first communication device may select some or all of idle time resources in the resource as the first time; the first communication device may select some or all of idle frequency ban resources in the resource as the first frequency band; and the first communication device may select some or all of idle beam position resources in the resource as the first coverage area. For example, FIG. 6A and FIG. 7B show resources occupied by the first communication device for transmission of a service signal. The first communication device may select, as the first time, one or more of four time periods: a time period t0 to t1, a time period t1 to t2, a time period t2 to t3, and a time period t3 to t4. In other words, the first time includes the one or more time periods. Similarly, the first communication device may select, as the first frequency band, one or more of four frequency bands: a frequency band 1, a frequency band 2, a frequency band 3, and a frequency band 4. In other words, the first frequency band includes the one or more frequency bands. Similarly, the first communication device may select, as the first coverage area, one or more of four beam positions: a beam position 5, a beam position 6, a beam position 7, and a beam position 8. In other words, the first coverage area includes the one or more beam positions. After determining the first time, the first frequency band, and the first coverage area, the first communication device may send the first time, the first frequency band, and the first coverage area to the second communication device.

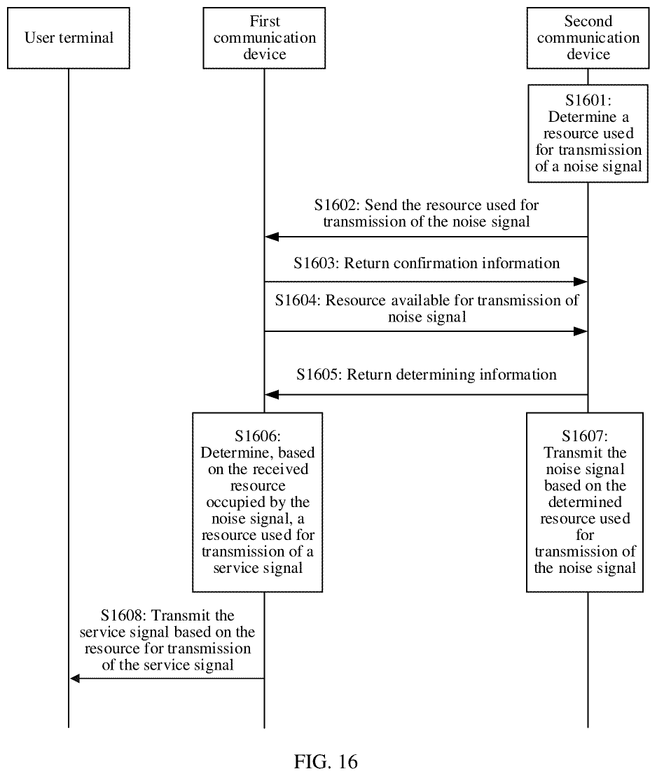

For a specific implementation in which the first communication device obtains the first resource based on the first information when the first information includes one or more resources available for transmission of the noise signal, refer to corresponding descriptions in S1602 and S1603 in FIG. 16 as an example. Details are not described herein again.

S504: The first communication device determines, based on the first resource, a second resource used for transmission of the service signal, where the second resource includes one or more of the following: second time for transmission of the service signal, a second coverage area of the service signal, or a second frequency band of a beam that carries the service signal, and the first resource is different from the second resource.

It may be understood that the first communication device may first perform S503, and then perform S504. Alternatively, the first communication device may first perform S504, and then perform S503. A sequence of performing S503 and S504 is not limited in this embodiment of this application.

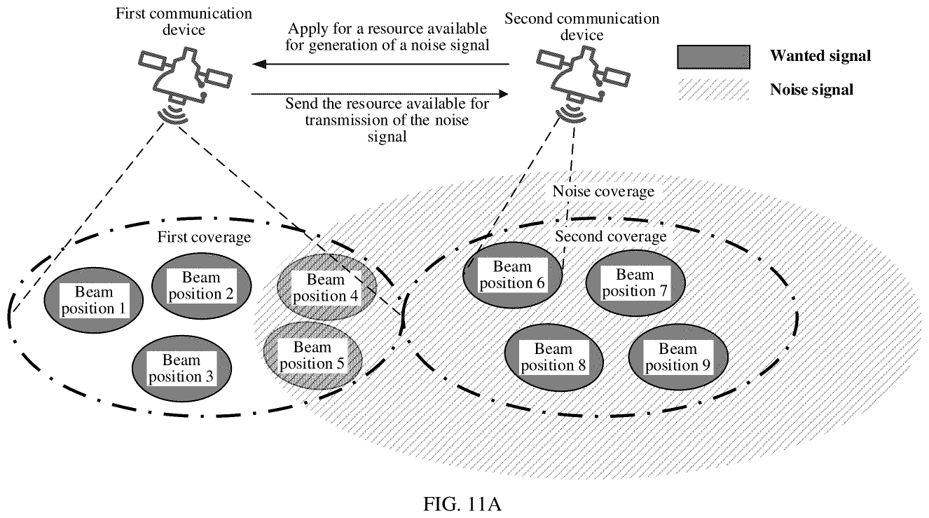

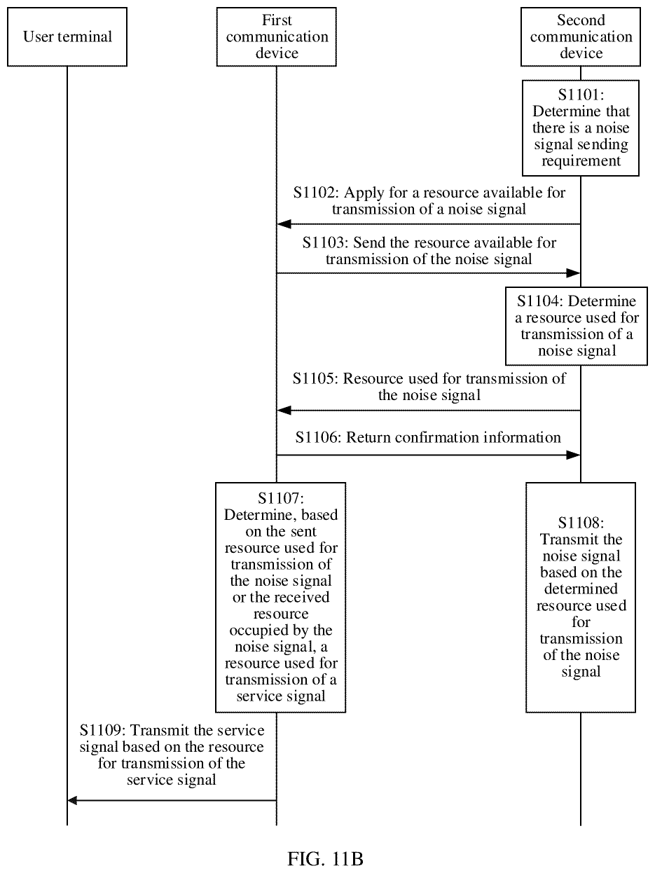

For the first communication device determining, based on the first resource, the second resource used for transmission of the service signal, refer to corresponding descriptions in S1107 in FIG. 11B. Details are not described herein again.

For example, that the first resource is different from the second resource includes one or more of the following: The first time is different from the second time, the first coverage area does not overlap the second coverage area, or the first frequency band is different from the second frequency band.

Ensuring that the first resource is different from the second resource can reduce interference of the noise signal sent by the second communication device to the service signal sent by the first communication device.

S505: The first communication device sends a first service signal based on the second resource.

In a possible implementation, the second resource includes the second time. In this case, the first communication device may send the first service signal based on the second time. For example, the first communication device may carry the first service signal in a service beam, and send the service beam at the second time.

In a possible implementation, the second resource includes the second frequency band. In this case, the first communication device may send the first service signal based on the second frequency band. For example, the first communication device may modulate the first service signal to a service beam whose frequency band is the second frequency band, and then send the service beam.

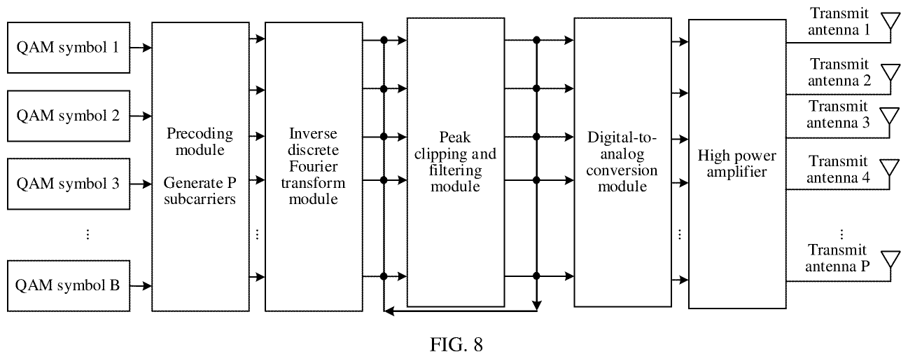

In a possible implementation, the second resource includes the second coverage area. In this case, the first communication device may send the first service signal to the second coverage area. For example, the service signal may be sent to a specified coverage area by using a beamforming technology. Based on the foregoing descriptions, the service signal may be, for example, an OFDM signal, a MIMO-OFDM signal, a DFT-S-OFDM signal, a TD-SCDMA signal, or a QAM signal. A waveform of the signal is not limited in this application, and the method in this application may be applied to a waveform with a peak-to-average power ratio suppression requirement. The DFT-S-OFDM signal means that DFT precoding may be first performed on data, and then the data is mapped to a frequency domain data subcarrier. The following describes, with reference to FIG. 8 by using a QAM signal as an example, a specific implementation of sending the first service signal to the specified second coverage area based on the beamforming technology.

As shown in FIG. 8, B QAM symbols are first obtained, where B may be an integer greater than 1. The B QAM symbols are a QAM symbol 1, a QAM symbol 2, a QAM symbol 3, . . . , and a QAM symbol B. The QAM symbol is a symbol obtained by performing a series of processing such as encoding and modulation on to-be-sent data. Each QAM symbol corresponds to a service signal. A precoding module separately sends, to an inverse discrete Fourier transform (IDFT) module, P (P is an integer greater than 1 and less than or equal to B) subcarriers obtained by precoding the B QAM symbols based on B beam directions. P groups of precoded signals respectively correspond to P transmit antennas. In other words, the P groups of signals are respectively sent by the P transmit antennas after being processed.

For example, it is assumed that Sₖ is a frequency domain constellation mapping signal vector (B×1 vector) of B beams on a k^{th} subcarrier. A value of k is an integer from 1 to P. A precoding matrix Wₖ of data on the k^{th} subcarrier is a P×B matrix, where P represents a quantity of transmit antennas, and B represents a quantity of beams. A signal obtained by precoding the original constellation mapping signal vector Sₖ is shown in the following formula:

S̅ₖ=WₖSₖ

S̅ₖ (a P×1 vector) is the signal obtained through precoding. Wₖ is determined by a coverage area of a service signal corresponding to the k^{th} subcarrier.

That each service signal is sent to a specified coverage area means that signal quality of the service signal received in the specified coverage area is greater than a specific standard, which may be that signal sensitivity is greater than a specific threshold, for example, the signal sensitivity is greater than −10 dB; or may be that the signal is a continuous, stable, and continuous service signal.

For example, frequency domain data S̅ on one of the antennas is used as an example to describe an implementation process of the beamforming technology.

First, inverse discrete Fourier transform is performed on precoded data, which may be shown in the following formula: x=IDFT(S̅).

Then, x is sent to a peak clipping and filtering module. For an implementation process of peak clipping and filtering, refer to the foregoing related content. Details are not described herein again. Peak clipping and filtering is performed on x, which may be represented as x_{CAF}=CAF(x).

In a possible implementation, in an actual implementation process of peak clipping and filtering, peak clipping and filtering needs to be performed for a plurality of times, to achieve better filtering effects.

When a quantity of times of peak clipping and filtering reaches a threshold, peak clipping and filtering on x is completed, and a subsequent step is performed. For example, it is assumed that five times of peak clipping and filtering is a maximum quantity of times of peak clipping and filtering. Peak clipping and filtering is performed on x for the first time, which may be represented as x_{CAF1}=CAF(x), where x_{CAF1} indicates that peak clipping and filtering is performed on x for the first time. Then, peak clipping and filtering is performed on x_{CAF1}, which may be represented as x_{CAF2}=CAF(x_{CAF1}). Then, peak clipping and filtering is performed on x_{CAF2} to obtain x_{CAF3}. By analogy, when x_{CAF5} is obtained, it indicates that the quantity of times of peak clipping and filtering has reached the threshold, and the foregoing cycle may be terminated, it is set that x_{CAF5}=x_{CAF}, and the subsequent step is performed.

Alternatively, when peak clipping and filtering effects reach a specific standard, peak clipping and filtering on x is completed, and a subsequent step is performed. For example, it is assumed that a PAPR of a signal obtained through peak clipping and filtering needs to be less than a specific threshold. For example, the PAPR needs to be less than 3 dB. Peak clipping and filtering is performed on x, which may be represented as x_{CAF}=CAF(x). Then, it is determined whether a PAPR of x_{CAF} is less than 3 dB. If the PAPR of x_{CAF} is greater than 3 dB, it is set that x_{CAF}=x, and the foregoing steps continue to be performed; or if the PAPR of x_{CAF} is less than 3 dB, the foregoing cycle is stopped, and the subsequent step is performed.

The signal x_{CAF} obtained through peak clipping and filtering needs to pass through a digital-to-analog conversion module, so that x_{CAF} is converted from a digital signal to an analog signal x_{CAF_M}. Further, transmit power of x_{CAF_M} is increased by using a high power amplifier, and x_{CAF_M} with higher transmit power is sent through the antenna.

In a possible implementation, the second resource includes two or three of the second time, the second frequency band, and the second coverage area. In this case, the first communication device may send the first service signal based on the two or three resources. For a specific implementation, refer to the foregoing descriptions. Details are not described herein.

S506: The second communication device sends a first noise signal based on the first resource.

In specific implementation, after the first communication device sends, to the second communication device in S503, the second information indicating the first resource, the second communication device receives the second information, and sends the first noise signal based on the first resource indicated by the second information. The first resource includes one or more of the first time, the first frequency band, and the first coverage area. The following provides descriptions in different cases.

In a possible implementation, the first resource includes the first time. In this case, the second communication device may send the first noise signal based on the first time. For example, based on the foregoing descriptions, the first noise signal may be a peak clipping and filtering noise signal. In this case, the first noise signal may be carried in the service beam together with the service signal. Then, the second communication device sends the service beam at the first time.

In a possible implementation, if the first time includes a plurality of time periods available for transmission of the first noise signal, the second communication device may select a time period from the plurality of time periods to send the first noise signal. Optionally, the second communication device may further send a message to the first communication device, to indicate the time period that is confirmed to be used for transmission of the first noise signal. Therefore, the first communication device learns transmission time of the first noise signal, and can avoid sending the service signal at the time, reducing interference of the noise signal to the service signal.

In a possible implementation, the first resource includes the first frequency band. In this case, the second communication device may send the first noise signal based on the first frequency band. For example, based on the foregoing descriptions, the first noise signal may be a peak clipping and filtering noise signal. The first communication device may modulate the first noise signal and the service signal together into a service beam whose frequency band is the first frequency band, and then send the service beam.

In a possible implementation, if the first frequency band includes a plurality of frequency bands available for transmission of the first noise signal, the second communication device may select a frequency band from the plurality of frequency bands to send the first noise signal. Optionally, the second communication device may further send a message to the first communication device, to indicate the frequency band that is confirmed to be used for transmission of the first noise signal. Therefore, the first communication device can avoid sending the service signal in the frequency band, reducing interference of the noise signal to the service signal.

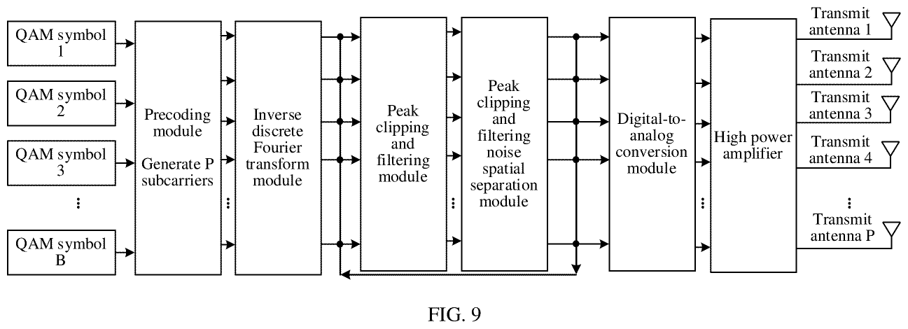

In a possible implementation, the first resource includes the first coverage area. In this case, the second communication device may send the first noise signal to the first coverage area. The beamforming technology is described in step S505, and the service signal may be sent to the specified coverage area. In an implementation, the noise signal accompanying the service signal may be further sent to a specified coverage area. For example, refer to FIG. 9. Compared with FIG. 8, FIG. 9 includes an additional peak clipping and filtering noise spatial separation module. In an implementation, the specific implementation may include but is not limited to the following steps.

Step one: Similar to the method shown in FIG. 8, a QAM signal is used as an example to describe how to send the noise signal accompanying the service signal to the specified coverage area in this application.

Step two: It may be understood that this embodiment is also based on a MIMO antenna. If one MIMO antenna includes P transmit antennas, P subcarriers may be transmitted at the same time. In addition, it is assumed that the P subcarriers may form B service beams to serve B different areas. As shown in FIG. 9, B QAM symbols are first obtained: a QAM symbol 1, a QAM symbol 2, a QAM symbol 3, . . . , and a QAM symbol B. The QAM symbol is a symbol obtained by performing a series of processing such as encoding and modulation on to-be-sent data. Each QAM symbol corresponds to a beam. The precoding module separately sends, to the inverse discrete Fourier transform (IDFT) module, P subcarriers obtained by precoding the B QAM symbols based on B beam directions. P groups of precoded signals respectively correspond to P transmit antennas. In other words, the P groups of signals are respectively sent by the P transmit antennas after being processed.

Step three: Obtain frequency domain data S̅ on a carrier. For a process of obtaining S̅, refer to the corresponding content of the method shown in FIG. 8. Details are not described herein again.

Step four: Perform IDFT on the S̅ to obtain a signal x after IDFT. For a process of performing IDFT on the signal S̅, refer to the corresponding content of the method in FIG. 8. Details are not described herein again.

Step five: Send the signal x to the peak clipping and filtering module, to obtain a peak-clipped and filtered signal x_{CAF}. For a process of performing peak clipping and filtering on the signal x, refer to the corresponding content of the method in FIG. 8. Details are not described herein again.

Step six: Send the signal x_{CAF} to the peak clipping and filtering noise spatial separation (clipping noise spatial separation) module. This module has a function of processing the signal x_{CAF}, so that after a processed signal x_{CAF} is sent through the antenna, a service signal represented by the signal x_{CAF} and a noise signal accompanying the service signal can be respectively sent to specified coverage areas. Therefore, the peak clipping and filtering noise spatial separation module may also be referred to as a beamforming module, a spatial filtering module, or the like. A specific implementation process of the peak clipping and filtering noise spatial separation module includes but is not limited to the following steps.

Step 1: Obtain a CAF noise signal, where the signal x_{CAF} with a suppressed PAPR is subtracted from the signal x with an unsuppressed PAPR, to obtain the CAF noise signal Nx_{CAF}. The obtaining a CAF noise signal may be represented as Nx_{CAF_TD}=x_{CAF}−x.

Step 2: Obtain a CAF noise signal in a frequency domain form, where a CAF noise signal in a time domain form is converted into the CAF noise signal in the frequency domain form through discrete Fourier transform. The obtaining a CAF noise signal in a frequency domain form may be represented as Nx_{CAF_FD=DFT}(Nx_{CAF_TD}).

Step 3: Perform spatial separation processing on the CAF noise signal in the frequency domain form. The spatial separation processing may also be referred to as spatial filtering, beamforming, or the like. A possible implementation may be represented as N_{D_}x_{CAF_FD}=(I−W_{S}W_{S}^{P}) Nx_{CAF_FD}.

I represents a P×P unit matrix. W_{S} (a P×B matrix) may represent a precoding matrix of a service signal on a carrier, where the carrier and the carrier in which the frequency domain data S̅ is located in step three are a same carrier, and the precoding matrix of the service signal is determined by a coverage area of the service signal. W_{S}^{P} (a B×P matrix) is a pseudo-inverse matrix of W_{S}. N_{D_}x_{CAF_FD} is a P×1 vector.

In the method, a coverage area of noise accompanying the service signal does not overlap the coverage area of the service signal, so that interference of the noise to the service beam can be reduced. This is equivalent to reducing interference of the peak clipping and filtering noise accompanying the service beam to the service beam.

Another possible implementation may be represented as N_{D_}x_{CAF_FD}=W_{NS} W_{NS}^{P}Nx_{CAF_FD}.

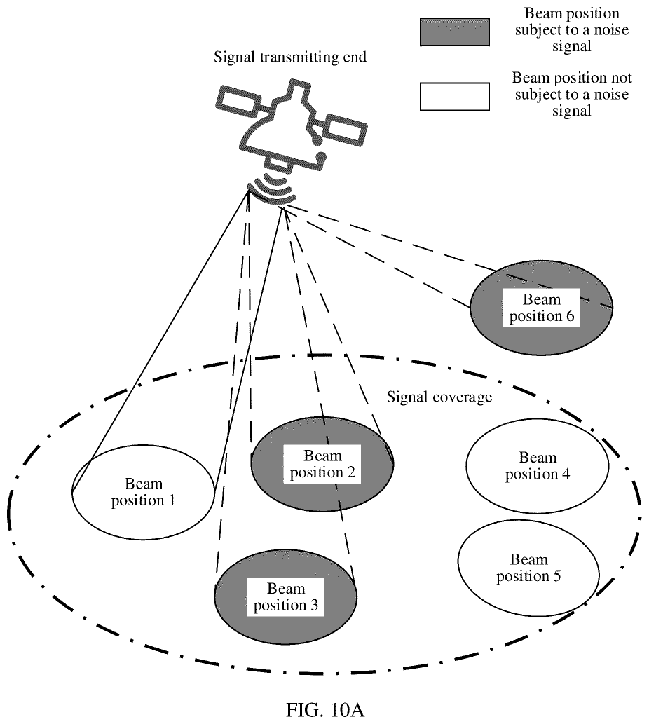

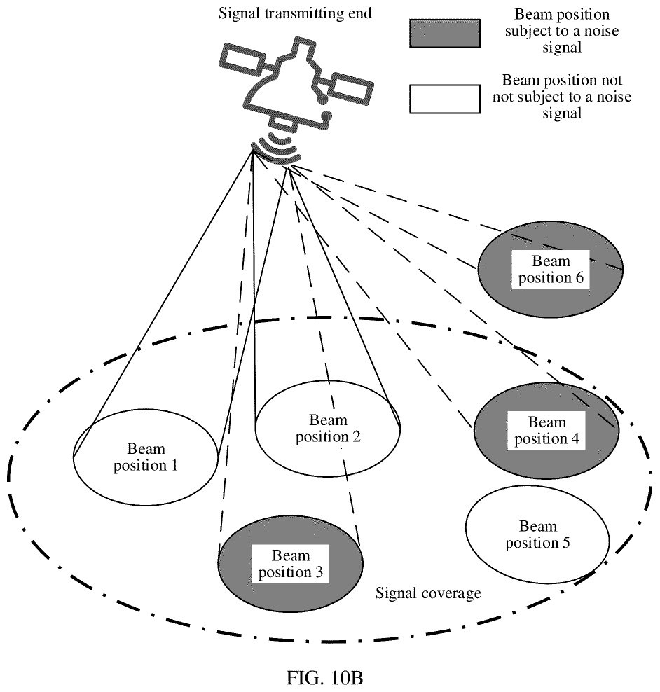

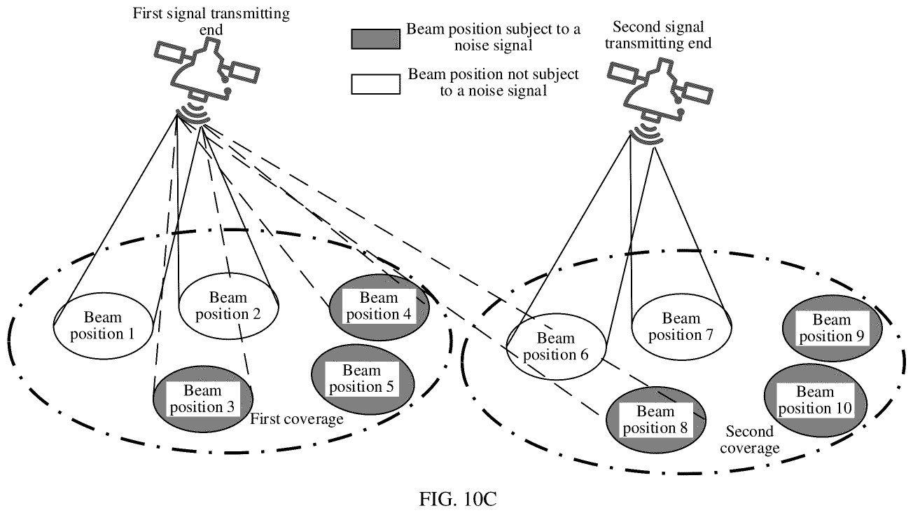

W_{NS} (a P×B matrix) may represent a precoding matrix of a non-service signal, and is determined by a coverage area of a noise signal. W_{NS}^{P} (a B×P matrix) is a pseudo-inverse matrix of W_{NS}. The coverage area of the noise signal may be an area that does not overlap a coverage area of a service signal on a same carrier. For example, the second communication device may be, for example, a signal transmitting end in FIG. 10A. A signal coverage area of the signal transmitting end is shown by a dashed line range in the figure. The signal coverage area includes five beam positions: a beam position 1, a beam position 2, a beam position 3, a beam position 4, and a beam position 5. For example, when the signal transmitting end sends a service signal serving the beam position 1, a precoding matrix of the service beam may be determined based on an area in which the beam position 1 is located. According to the foregoing method, noise accompanying the service signal may be sent to another beam position, for example, the beam position 2 or the beam position 3, by avoiding the beam position 1 in which the service signal is located.

In a possible implementation, the noise signal may alternatively be sent to an area outside the signal coverage area, for example, a beam position 6.

Alternatively, the coverage area of the noise signal may be an area that does not overlap a coverage area of a service signal sent by one or more communication devices (when the service signal and the noise signal are on a same frequency band). The communication device may be a communication device that sends the noise signal, or may be another communication device.

For example, the second communication device may be, for example, a signal transmitting end in FIG. 10B. A signal coverage area of the signal transmitting end is shown by a dashed line range in the figure. The signal coverage area includes five beam positions: a beam position 1, a beam position 2, a beam position 3, a beam position 4, and a beam position 5. For example, when the signal transmitting end sends a service signal serving the beam position 1 and a service signal serving the beam position 2, a beam carrying the beam position 1 and a beam carrying the beam position 2 are on a same frequency band. The service signal serving the beam position 1 is referred to as a first service signal, and the service signal serving the beam position 2 is referred to as a second service signal. A coverage area of noise accompanying the first service signal should not overlap the beam position 1 and the beam position 2. For example, a coverage area of a noise signal may be one or more of the beam position 3, the beam position 4, or a beam position 6. In a same manner, a coverage area of a noise signal accompanying the second service signal should not overlap the beam position 1 and the beam position 2. For example, the coverage area of the noise signal may be one or more of the beam position 3, the beam position 4, or the beam position 6.

For example, the first communication device may be, for example, a second signal transmitting end in FIG. 10C, and the second communication device may be, for example, a first signal transmitting end in FIG. 10C. The figure includes the first signal transmitting end, a first coverage area of the first signal transmitting end, the second signal transmitting end, and a second coverage area of the second signal transmitting end. The first coverage area includes five beam positions: a beam position 1, a beam position 2, a beam position 3, a beam position 4, and a beam position 5. The second coverage area includes five beam positions: a beam position 6, a beam position 7, a beam position 8, a beam position 9, and a beam position 10. A noise signal generated by the first signal transmitting end may affect the second coverage area. According to the foregoing method, the noise signal generated by the first signal transmitting end may avoid a beam position that is in the second coverage area and that is covered by a service signal. For example, when the first signal transmitting end transmits a service beam serving the beam position 1 and a service beam serving the beam position 2, and the second signal transmitting end transmits a service beam serving the beam position 6 and a service beam serving the beam position 7, a coverage area of a noise signal carried by a service beam serving any one of the foregoing beam positions may be any one or more of the following: the beam position 3, the beam position 4, the beam position 5, the beam position 8, the beam position 9, or the beam position 10.

According to the foregoing method, interference of a noise signal generated by a signal transmitting end to a service signal that is at a same time and on a same frequency band can be reduced. The service signal may be any one or more service signals.

Step seven: Perform IDFT processing on the spatially separated signal N_{D_}x_{CAF_FD} to obtain a time domain form of the signal N_{D_}x_{CAF_FD}. The obtaining a time domain form of the signal N_{D_}x_{CAF_FD} may be expressed as: N_{D_}x_{CAF_ID}=IDFT(N_{D_}x_{CAF_FD}).

Step eight: Obtain an updated peak-clipping and filtering signal Nx_{CAF}. The obtaining an updated peak-clipping and filtering signal Nx_{CAF} may be represented as Nx_{CAF}=X+N_{D_}x_{CAF_TD}, where x is the signal x in step four.

Step nine: Determine whether Nx_{CAF} meets a standard, for example, determine whether a peak-to-average power ratio of the obtained signal Nx_{CAF} is less than a preset threshold, where the threshold may be 3 dB, 1 dB, or the like. This is not limited in this application. If a determining result is that Nx_{CAF} does not meet the standard, step ten is performed; or if a determining result is that Nx_{CAF} meets the standard, step eleven is performed.

Step ten: Obtain a quantity of times of execution of the peak clipping and filtering module and/or the peak clipping and filtering noise spatial separation module. If the quantity of times of execution of the peak clipping and filtering module and/or the peak clipping and filtering noise spatial separation module is greater than or equal to a preset threshold, step eleven is performed; or if the quantity of times of execution of the peak clipping and filtering module and/or the peak clipping and filtering noise spatial separation module is not greater than or equal to a preset threshold, the signal x in step five is replaced with Nx_{CAF}, and step five is performed.

Step eleven: Perform operations such as digital-to-analog conversion and power amplification on the obtained Nx_{CAF}, and finally transmit Nx_{CAF} via a transmit antenna.

In an implementation, in the foregoing method, step nine is not performed, and step ten is directly performed after the signal Nx_{CAF} is obtained.

Based on the foregoing descriptions, the second communication device may send the first noise signal to the first coverage area. In addition, in this implementation, peak clipping and filtering noise may be sent to a specified coverage area on the premise that peak clipping and filtering effects are not affected. A feasible method is provided for reducing the interference of the noise signal to the service signal.

In a possible implementation, if the first coverage area includes a plurality of coverage areas available for transmission of the first noise signal, the second communication device may select a coverage area from the plurality of coverage areas, and send the first noise signal to the selected coverage area. Optionally, the second communication device may further send a message to the first communication device, to indicate to confirm the selected coverage area. Therefore, the first communication device can avoid sending the service signal in the coverage area, reducing interference of the noise signal to the service signal.

In a possible implementation, the first resource includes two or three of the first time, the first frequency band, and the first coverage area. In this case, the second communication device may send the first noise signal based on the two or three resources. For a specific implementation, refer to the foregoing descriptions. Details are not described herein. Similarly, optionally, the second communication device may further send a message to the first communication device, to indicate the resource (including two or more of a time resource, a frequency band resource, and a coverage area) that is confirmed to be used for transmission of the first noise signal. Therefore, the first communication device can avoid sending the service signal by using the resource, reducing interference of the noise signal to the service signal.

For better understanding the solution of this application, the following describes several possible implementations of the signal transmission method provided in this embodiment of this application by using examples.

In a possible implementation, for example, FIG. 11A is a diagram of an inter-communication device application-negotiation solution provided. In FIG. 11A, a first coverage area of a service signal transmitted by the first communication device is adjacent to a second coverage area of a signal transmitted by the second communication device. A beam position served by the second communication device is a beam position 6, a beam position 7, a beam position 8, and a beam position 9 in the second coverage area. A coverage area of a noise signal of the second communication device is larger than a coverage area of the service signal of the second communication device, and interference is caused to a beam position in the first coverage area. The second communication device applies to the first communication device for a resource available for transmission of the noise signal. The first communication device may indicate, to the second communication device, the resource available for transmission of the noise signal, and transmit the service signal by avoiding the resource for transmission of the noise signal, to reduce interference of the noise signal to the service signal. In addition, in this embodiment of this application, after spatial separation is performed on the service signal and the noise signal in a service beam, the noise signal causes small or even no interference to the beam position in the second coverage area. The following describes a specific implementation by using an example with reference to FIG. 11B.

FIG. 11B provides a signal transmission method. In the method, content shown in FIG. 11A can be presented more clearly. A first communication device in FIG. 11B may be, for example, the satellite 1 in FIG. 11A, and a second communication device in FIG. 11B may be, for example, the satellite 2 in FIG. 11A. According to the method provided in FIG. 11B, the first communication device and the second communication device may negotiate, to reduce interference of a noise signal generated by the second communication device to a service signal sent by the first communication device. For example, the following describes an example in which a beam position served by the second communication device includes a beam position 1, a beam position 2, a beam position 3, and a beam position 4, and a beam position served by the first communication device includes a beam position 5, a beam position 6, a beam position 7, and a beam position 8. The method shown in FIG. 11B includes but is not limited to the following steps.

S1101: The second communication device determines that there is a noise signal sending requirement.

In a possible implementation, the second communication device needs to send a service signal, and needs to perform peak-to-average power ratio suppression on the sent service signal, which indicates that the second communication device has the noise signal sending requirement.

It should be noted that step S1101 is an optional step.

S1102: The second communication device applies to the first communication device for a resource available for transmission of a noise signal.

In a possible implementation, it can be learned from the foregoing corresponding content that a coverage area of a noise signal accompanying a service signal is usually larger than a coverage area of the service signal. To reduce interference of the noise signal to the service signal as much as possible, a communication device that may be subject to the noise signal needs to be queried for a resource available for the noise signal, where the resource includes one or more of the following: for example, time, a coverage area, or a frequency band.

In a possible implementation, that the second communication device applies to the first communication device for the resource available for transmission of the noise signal may be sending request information to the first communication device. The request information may include a resource expected to be used for transmission of the noise signal, to request the first communication device to determine, based on the expected resource, the resource available for transmission of the noise signal. The expected resource may include, for example, one or more of the following: time for transmission of the noise signal, a frequency band of a beam that carries the noise signal, or a coverage area of the noise signal.

In a possible implementation, the satellite 1 may send application information to a satellite 2 via an Xn interface, and the Xn interface may be used for subsequent inter-satellite information transmission.

S1103: The first communication device sends, to the second communication device, the resource available for transmission of the noise signal.

In a possible implementation, after receiving the request information sent by the second communication device, the first communication device calculates, based on a resource occupied by the first communication device for sending a service signal, the resource available for the second communication device to transmit the noise signal, and sends the resource to the second communication device.

For example, the first communication device selects, based on the request information, a resource that is not used for the service signal sent by the first communication device in a period of time, including one or more of the following: time, a coverage area, or a frequency band. The period of time may be 10 ms, 1 second, or 1 minute after the satellite 2 receives the request information. Specific duration is not limited in this application.

For example, the first communication device selects, based on the request information, a resource that is not used by the first communication device to transmit the service signal in one or more frequency bands, including one or more of the following: time, a coverage area, or a frequency band. The one or more frequency bands are one or more frequency bands available for both the first communication device and the second communication device.

For example, the first communication device selects, based on the request information, a resource that is not used by the first communication device to transmit the service signal in one or more beam positions, including one or more of the following: time, a coverage area, or a frequency band. The one or more beam positions are one or more beam positions within a service range of the first communication device.

In a possible implementation, if the information sent by the first communication device to the second communication device indicates that the first communication device does not agree to provide the resource available for transmission of the noise signal, or that there is no resource available for transmission of the noise signal, subsequent steps may be omitted.

In a possible implementation, information sent by the first communication device to the second communication device indicates the resource available for the noise signal generated by the second communication device, and the resource includes one or more of the following: time for transmission of the noise signal, a frequency band of a beam that carries the noise signal, or a coverage area of the noise signal.

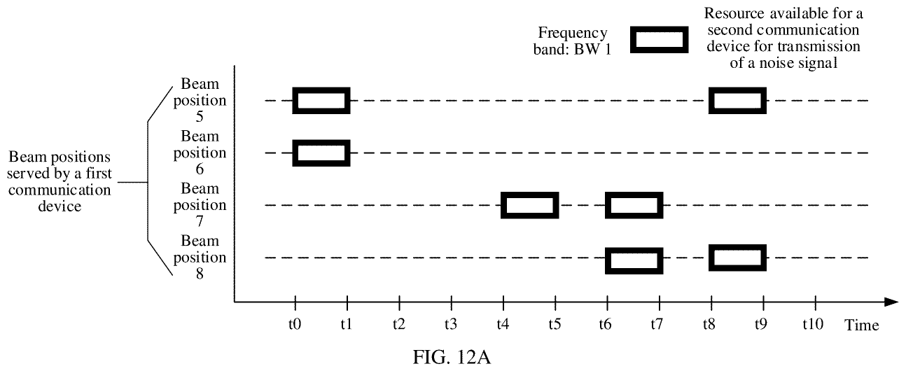

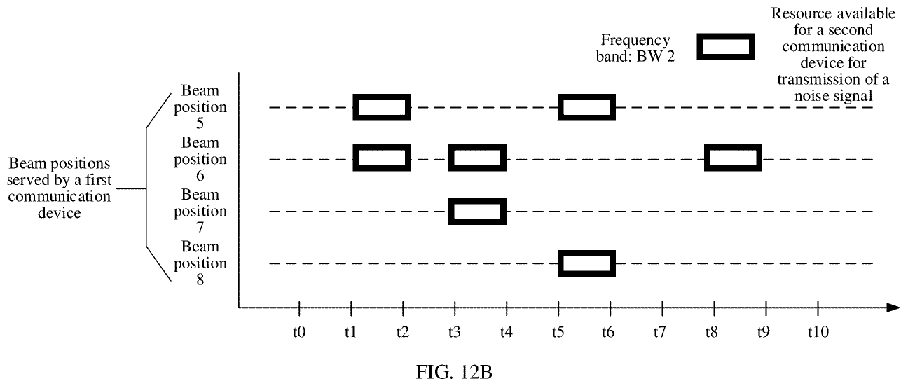

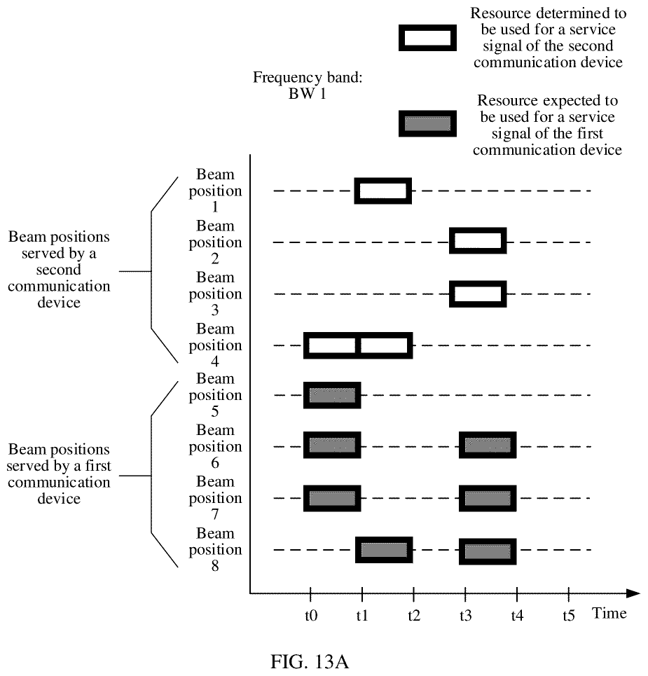

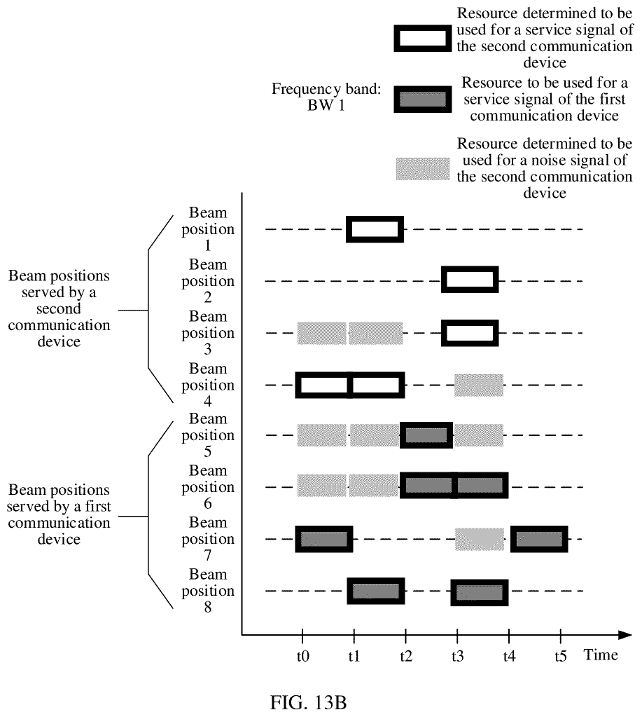

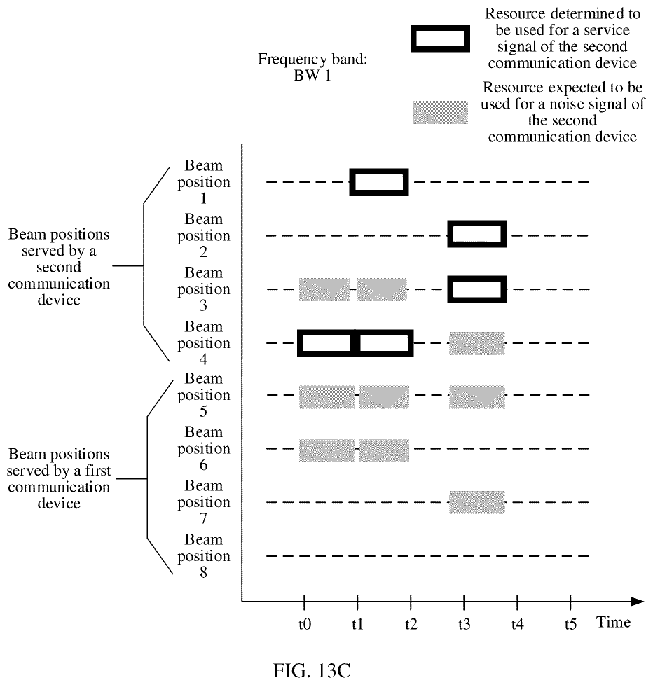

For example, refer to FIG. 12A and FIG. 12B. In FIG. 12A, a resource represented by a black border is a resource available for the second communication device to transmit the noise signal within the service range of the first communication device. A horizontal axis represents time, a vertical axis represents a beam position, and a frequency band is a BW 1. It can be learned that when the time is from t0 to t1, the second communication device may use the beam position 5 and the beam position 6 to transmit the noise signal; when the time is from t4 to t5, the second communication device may use the beam position 7 to transmit the noise signal; when the time is from t6 to t7, the second communication device may use the beam position 7 and the beam position 8 to transmit the noise signal; or when the time is from t8 to t9, the second communication device may use the beam position 5 and the beam position 8 to transmit the noise signal, and all remaining beam positions in the frequency band BW 1 are beam positions unavailable for the second communication device to transmit the noise signal. For example, the BW 1 may be 29.6 GHz to 29.7 GHZ.

In FIG. 12B, a resource represented by a black border is a resource available for the second communication device to transmit the noise signal within the service range of the first communication device. A horizontal axis represents time, a vertical axis represents a beam position, and a frequency band is a frequency band BW 2. It can be learned that when the time is from t1 to t2, the second communication device may use the beam position 5 and the beam position 6 to transmit the noise signal; when the time is from t3 to t4, the second communication device may use the beam position 6 and the beam position 7 to transmit the noise signal; when the time is from t5 to t6, the second communication device may use the beam position 5 and the beam position 8 to transmit the noise signal; or when the time is from t8 to t9, the second communication device may use the beam position 6 to transmit the noise signal, and all remaining beam positions in the frequency band BW 2 are beam positions unavailable for the second communication device to transmit the noise signal. For example, the BW 2 may be 29.7 GHz to 29.8 GHz.

For example, the resource that is available for transmission of the noise signal and that is sent by the first communication device to the second communication device may be shown in Table 2A, Table 2B, and Table 2C. It can be learned from Table 2A that a frequency band resource available for transmission of the noise signal is the frequency band BW 1. In time t0 to t1, the noise signal of the second communication device may be sent to the beam position 5 and the beam position 6. In time t4 to t5, the noise signal of the second communication device may be sent to the beam position 7. In time t6 to t7, the noise signal of the second communication device may be sent to the beam position 7 and the beam position 8. In time t8 to t9, the noise signal of the second communication device may be sent to the beam position 5 and the beam position 8, and all the remaining beam positions are beam positions unavailable for the noise signal of the second communication device. For example, the BW 1 may be 29.6 GHz to 29.7 GHZ.

TABLE 2A

| Time | Frequency band | Beam position |
|---|---|---|
| t0 to t1 | BW 1 | Beam position 5 and beam position 6 |
| t4 to t5 | BW 1 | Beam position 7 |
| t6 to t7 | BW 1 | Beam position 7 and beam position 8 |
| t8 to t9 | BW 1 | Beam position 5 and beam position 8 |

It can be learned from Table 2B that a frequency band resource available for transmission of the noise signal is the frequency band BW 2. In time t1 to t2, the noise signal of the second communication device may be sent to the beam position 5 and the beam position 6. In time t3 to t4, the noise signal of the second communication device may be sent to the beam position 6 and the beam position 7. In time t5 to t6, the noise signal of the second communication device may be sent to the beam position 5 and the beam position 8. In time t8 to t9, the noise signal of the second communication device may be sent to the beam position 6, and all the remaining beam positions in the frequency band BW 2 are beam positions unavailable for the noise signal of the second communication device. For example, the BW 2 may be 29.7 GHZ to 29.8 GHz.

TABLE 2B

| Time | Frequency band | Beam position |
|---|---|---|
| t1 to t2 | BW 2 | Beam position 5 and beam position 6 |
| t3 to t4 | BW 2 | Beam position 6 and beam position 7 |
| t5 to t6 | BW 2 | Beam position 5 and beam position 8 |
| t8 to t9 | BW 2 | Beam position 6 |

In Table 2C, “\” indicates that there is no such information. For example, if the frequency band is the BW 2 and the beam position is the beam position 5 and the beam position 6, no time information is provided. It indicates that when the frequency band is the BW 2 and the beam position is the beam position 5 and the beam position 6, the second communication device may select, within specific time based on a requirement of the second communication device, time for sending the noise signal. For example, within 10 minutes after receiving information shown in Table 2C, the second communication device may select any time to transmit the noise signal by using the frequency band BW 2, as well as the beam position 5 and/or the beam position 6. Similarly, in time t3 to t4, no frequency band is provided in Table 2C. It indicates that in a case of the time t3 to t4, as well as the beam position 6 and/or beam position 7, any available frequency band may be selected to transmit the noise signal. When the time is t8 to t9, no frequency band and time are provided in Table 2C. It indicates that in the time t8 to t9, the second communication device may select any available frequency band to send the noise signal to an area that can be covered by the service beam of the first communication device.

TABLE 2C

| Time | Frequency band | Beam position |
|---|---|---|
| \ | BW 2 | Beam position 5 and beam position 6 |
| t3 to t4 | \ | Beam position 6 and beam position 7 |
| t5 to t6 | BW 2 | \ |
| t8 to t9 | \ | \ |

In a possible implementation, the available resource may be indicated in a periodic, aperiodic, or semi-static manner. For example, when the resource is periodic, the resource may be used, at an interval of fixed time, by the second communication device as a resource for transmission of a noise signal. For example, when the resource is aperiodic, the resource may be used, at an interval of unfixed time, by the second communication device as a resource for transmission of a noise signal. For example, when the resource is semi-static, the resource may be used, at an interval of fixed time, by the second communication device as a resource for transmission of a noise signal, and the resource is also updated with subsequent information.

S1104: The second communication device determines a resource used for transmission of the noise signal.

The second communication device determines, based on information sent by the first communication device, the resource used for transmission of the noise signal, where the resource includes one or more of the following: the time for transmission of the noise signal, the frequency band in which the beam carrying the noise signal is located, or the coverage area of the noise signal.

In a possible implementation, the determined resource occupied for transmission of the noise signal is some or all of the resource available for transmission of the noise signal. For example, the resource that is available for transmission of the noise signal and that is sent by the first communication device to the second communication device may be shown in Table 2A. The resource determined by the second communication device to transmit the noise signal is shown in Table 3. The resource determined by the second communication device to transmit the noise signal is some of the resource that is sent by the first communication device to the second communication device and that is available for transmission of the noise signal. Specifically, in the time t0 to t1, the resource used by the second communication device to transmit the noise signal is the frequency band BW 1, the beam position 5, and the beam position 6. In the time t6 to t7, the resource used by the second communication device to transmit the noise signal is the frequency band BW 1, the beam position 7, and the beam position 8.

TABLE 3

| Time | Frequency band | Beam position |
|---|---|---|
| t0 to t1 | BW 1 | Beam position 5 and beam position 6 |
| t6 to t7 | BW 1 | Beam position 7 and beam position 8 |

In a possible implementation, the resource determined to be used for transmission of the noise signal is some of the resource that is sent by the first communication device to the second communication device and that is used for transmission of the noise signal, and another resource. The another resource is a resource that is not included in the foregoing resource used for transmission of the noise signal. In addition, the another resource is a resource available for the second communication device to transmit the noise signal. For example, the resource that is sent by the first communication device to the second communication device and that is used for transmission of the noise signal is shown in Table 2A and Table 2B, the resource available for the second communication device to transmit the noise signal is shown in Table 4, and the resource determined by the second communication device to transmit the noise signal is shown in Table 5. Resources shown in Table 5 include some resources in Table 2A and some resources in Table 4.

TABLE 4

| Time | Frequency band | Beam position |
|---|---|---|
| t0 to t1 | BW 1 | Beam position 1 and beam position 3 |
| t3 to t4 | BW 1 | Beam position 2 and beam position 4 |
| t5 to t6 | BW 1 | Beam position 1 and beam position 4 |
| t8 to t9 | BW 1 | Beam position 2 |

The resources shown in Table 5 include some resources in Table 2A and some resources in Table 4. Specifically, in the time t0 to t1, the resource used by the second communication device to transmit the noise signal is the frequency band BW 1, the beam position 1, and the beam position 5, where the beam position 1 is a coverage area of a service beam of the second communication device, and the beam position 5 is a coverage area of the service beam of the first communication device. In the time t5 to t6, the resource used by the second communication device to transmit the noise signal is the frequency band BW 2, the beam position 5, and the beam position 8.

TABLE 5

| Time | Frequency band | Beam position |
|---|---|---|
| t0 to t1 | BW 1 | Beam position 1 and beam position 5 |
| t5 to t6 | BW 2 | Beam position 5 and beam position 8 |

In a possible implementation, the second communication device receives a resource that is sent by the first communication device and that is available for transmission of the noise signal and a resource that is sent by a third communication device and that is available for transmission of the noise signal. For example, the third communication device may be, for example, a signal transmitting end adjacent to the second communication device. The resource received by the second communication device from the first communication device is shown in Table 2A, and the resource received by the second communication device from the third communication device is shown in Table 6. In other words, Table 6 shows an example of the resource that is sent by the third communication device to the second communication device and that is available for transmission of the noise signal. The resource determined by the second communication device to transmit the noise signal is shown in Table 7A.

TABLE 6

| Time | Frequency band | Beam position |
|---|---|---|
| t0 to t1 | BW 1 | Beam position 9 and beam position 11 |
| t3 to t4 | BW 1 | Beam position 10 and beam position 12 |
| t5 to t6 | BW 1 | Beam position 9 and beam position 12 |
| t8 to t9 | BW 1 | Beam position 11 |

Resources shown in Table 7A include some resources in Table 2A and some resources in Table 6. Specifically, in the time t0 to t1, the resource used by the second communication device to transmit the noise signal is the frequency band BW 1, the beam position 5, and the beam position 9, where the beam position 5 is a coverage area of the service beam of the first communication device, and the beam position 9 is a coverage area of a service beam of the third communication device. In the time t8 to t9, the resource used by the second communication device to transmit the noise signal is the frequency band BW 1, the beam position 5, and a beam position 11, where the beam position 5 is the coverage area of the service beam of the first communication device, and the beam position 11 is a coverage area of a service beam of the third communication device.

TABLE 7A

| Time | Frequency band | Beam position |
|---|---|---|
| t0 to t1 | BW 1 | Beam position 5 and beam position 9 |
| t8 to t9 | BW 1 | Beam position 5 and beam position 11 |

S1105: The second communication device sends, to the first communication device, the resource determined to be used for transmission of the noise signal.

In a possible implementation, the second communication device sends, to the first communication device, the resource used for transmission of the noise signal, as shown in Table 3.

In a possible implementation, information sent by the second communication device to the first communication device includes a manner in which the first communication device uses the resource shown in Table 3, including, but not limited to, periodic, aperiodic, or semi-static.

In still another possible implementation, in addition to sending, to the first communication device, the resource used for transmission of the noise signal, the second communication device further sends, to the third communication device, the resource used for transmission of the noise signal, as shown in Table 7A.

In this step, the first communication device and/or the third communication device can clearly know which resources used for transmission of the noise signal are used by the second communication device. Therefore, the first communication device and/or the third communication device adjust/adjusts resources used for transmission of service signals, minimizing interference of the noise signal to the service signal.

It should be noted that step S1105 is an optional step.

S1106: The first communication device returns confirmation information to the second communication device.

For example, the second communication device may be, for example, a second communication device, and the first communication device may be, for example, a first communication device. After receiving the resource that is sent by the second communication device and that is used for transmission of the noise signal, the first communication device returns information for confirming reception.

It should be noted that step S1106 is an optional step.

S1107: The first communication device determines, based on the sent resource used for transmission of the noise signal or the received resource occupied by the noise signal, a resource used for transmission of the service signal.

In a possible implementation, after the first communication device receives the resource used by the second communication device to transmit the noise signal, the first communication device adjusts, based on the resource, a resource of a coverage area occupied by the first communication device for transmission of the service signal. For example, a resource expected to be used for the service signal of the first communication device is shown in FIG. 13A. In FIG. 13A, a white block with a black border represents a resource that the second communication device determines to use, and a gray block with a black border represents a resource expected by the first communication device to be used. It can be learned from the information in FIG. 13A that a resource to be used for the service signal of the first communication device is: the time: t0 to t1, the frequency band: the BW 1, and the beam position: the beam position 5, the beam position 6, and the beam position 7; the time: t1 to t2, the frequency band: the BW 1, the beam position: the beam position 8; and the time: t3 to t4, the frequency band: the BW 1, and the beam position: the beam position 6, the beam position 7, and the beam position 8. The resource determined by the second communication device to transmit the noise signal is shown in Table 7B.

TABLE 7B

| Time | Frequency band | Beam position |
|---|---|---|
| t0 to t1 | BW 1 | Beam position 3, beam position 5, |
| | | and beam position 6 |
| t1 to t2 | BW 1 | Beam position 3, beam position 5, |
| | | and beam position 6 |
| t3 to t4 | BW 1 | Beam position 4, beam position 5, |
| | | and beam position 7 |

To avoid the interference of the noise signal generated by the second communication device to the service signal of the first communication device as much as possible, the resource occupied by the service signal of the first communication device needs to be adjusted. An adjusted resource occupied by the service signal of the first communication device is shown in FIG. 13B. In FIG. 13B, a white block with a black border represents a resource determined to be used for the service signal of the second communication device, a gray block with a black border represents a resource to be used for the service signal of the first communication device, and a borderless gray block represents a resource determined to be used for the noise signal of the second communication device. The resource determined to be used for the noise signal in FIG. 13B is consistent with a resource expected to be used for the noise signal in FIG. 13C, and details are not described herein again. The resource determined to be used for the service signal of the second communication device in FIG. 13B is consistent with the resource determined to be used for the service signal in FIG. 13A, and details are not described herein again. Compared with the resource determined to be used for the service signal of the first communication device in FIG. 13A, the resource to be used for the service signal of the first communication device in FIG. 13B differs in that: A service signal serving the beam position 5 and the beam position 6 in the time t0 to t1 in the frequency band BW 1 is adjusted to serve the beam position 5 and the beam position 6 in the time t2 to t3 in the frequency band BW 1. A service signal serving the beam position 7 in the time t3 to t4 in the frequency band BW 1 is adjusted to serve the beam position 7 in the time t4 to t5 in the frequency band BW 1.

The first communication device transmits the service signal by using the resource shown in FIG. 13B, so that the interference from the noise signal of the second communication device can be effectively avoided.

In a possible implementation, the first communication device may adjust only the frequency band of the service signal, to avoid the interference of the noise signal of the second communication device and further provide a service for the coverage area of the noise signal.

For example, the first communication device adjusts the resource used for transmission of the service signal from: the frequency band: the BW 1, the time: t0 to t1, and the beam position: the beam position 5 and the beam position 6, to the frequency band: BW 2, the time: t0 to t1, and the beam position: the beam position 5 and the beam position 6. It can be learned that on the frequency band BW 1, the time t0 to t1, the beam position 5, and the beam position 6, there is the noise signal of the second communication device and the service signal of the first communication device, and an interference signal from the noise signal of the second communication device for the service beam of the first communication device is quite small.

In a possible implementation, the first communication device may adjust the frequency band and the time that are used for transmission of the service signal, to avoid the noise signal of the second communication device as much as possible, and reduce the interference of the noise signal to the service signal of the first communication device. A specific implementation process is similar to the foregoing corresponding content, and details are not described herein again.

S1108: The second communication device transmits the noise signal based on the determined resource used for transmission of the noise signal.

In a possible implementation, for a method for transmission of the noise signal by the second communication device based on the determined resource used for transmission of the noise signal, refer to the foregoing corresponding content. Details are not described herein again.

S1109: The first communication device transmits the service signal to a terminal device based on the resource for transmission of the service signal.

For example, the first communication device sends the service signal to the terminal device based on the resource for transmission of the service signal and with reference to the procedure shown in FIG. 9. The service signal is less interfered by the noise signal of the second communication device.

It should be noted that the signal transmission method shown in FIG. 11B is not limited to the foregoing steps, and may be a combination of the foregoing steps in a specific implementation process.

In another possible implementation, the following may describe, by using examples with reference to FIG. 14A, FIG. 14B, FIG. 14C, FIG. 14D, and FIG. 14E, how to adjust the resource occupied by the service signal of the second communication device, to reduce the interference of the resource for the noise signal generated by the second communication device to the service signal of the first communication device. FIG. 14A and FIG. 14D show examples of information about beam positions occupied by the service signals of the second communication device and the first communication device in a case in which the time is t0 to t10 and the frequency band is the BW 1. As shown in FIG. 14A, FIG. 14B, FIG. 14C, and FIG. 14E, a white block with a black border represents a service signal of the second communication device, a gray block with a black border represents a service signal of the first communication device, and a borderless ray block represents a noise signal of the second communication device. FIG. 14D indicates that a resource on which neither the second communication device nor the first communication device sends a service signal is the frequency band BW 2 and the time t0 to t1.

For example, FIG. 14A shows a resource expected to be used by the second communication device to transmit a service signal and a resource expected to be used by the first communication device to transmit a service signal. As shown in the figure, when the time is t0 to t1, the second communication device prepares to send a service signal to the beam position 4, and the first communication device prepares to send a service signal to the beam position 5, the beam position 6, the beam position 7, and the beam position 8. Apparently, in the time t0 to t1, within the service range of the first communication device, there is no resource available for the noise signal generated by the second communication device. However, in the time t1 to t2, within the service range of the first communication device, the beam position 5, the beam position 6, and the beam position 7 are available for the second communication device to transmit the noise signal. Similarly, in the time t5 to t6, the second communication device prepares to send a service signal to the beam position 1, the beam position 2, the beam position 3, and the beam position 4. However, in the time t5 to t6, the first communication device has only the beam position 6 and the beam position 7 available for the second communication device to transmit the noise signal. However, in the time t6 to t7, within the service range of the first communication device, the beam position 5, the beam position 6, the beam position 7, and the beam position 8 are available for the second communication device to transmit the noise signal.

For example, FIG. 14B and FIG. 14C indicate resources occupied by the service signals of the second communication device and the first communication device and the noise signal generated by the second communication device after the second communication device and the first communication device use the method shown in FIG. 11B. A possible implementation is shown in FIG. 14B. In FIG. 14A, a resource used for a service signal 1 is adjusted from the frequency band BW 1, the time t0 to t1, and the beam position 4 to the frequency band BW 1, the time t1 to t2, and the beam position 4. A resource occupied by a noise signal accompanying the service signal 1 is the time t1 to t2, the frequency band BW 1, the beam position 3, and the beam position 5. Before the adjustment, the first communication device cannot provide an available resource for the noise signal for the service signal 1, and the noise signal for the service signal 1 may cause interference to the service signal of the first communication device. Another possible implementation is shown in FIG. 14C. A resource occupied by a service signal 1 in FIG. 14A is not adjusted. A coverage area of a noise signal generated from the service signal 1 is adjusted, so that a resource occupied by the noise signal is the time t0 to t1, the frequency band BW 1, the beam position 2, and the beam position 3. In still another possible implementation, as shown in FIG. 14D, when the frequency band is the BW 2, and the time is t0 to t1, neither the second communication device nor the first communication device sends a service signal. To reduce the interference of the noise signal generated by the second communication device to the service signal of the first communication device as much as possible, as shown in FIG. 14E, FIG. 14E shows a resource occupied by the service signal 1 in FIG. 14A after adjustment. In FIG. 14E, a white block with a black border represents the service signal of the second communication device, and a gray block in FIG. 14E represents the noise signal generated by the second communication device. The resource occupied by the service signal 1 after adjustment is the frequency band BW 2, the time t0 to t1, the beam position 4. A resource occupied by a noise signal accompanying the service signal 1 is the frequency band BW 2, the time t0 to t1, the beam position 5, and the beam position 6. A possible implementation is shown in FIG. 14B. A service signal 2, a service signal 3, a service signal 4, and a service signal 5 in FIG. 14A that respectively serve the beam position 1, the beam position 2, the beam position 3, and the beam position 4 in the frequency band BW 1 at time t5 to time t6 are adjusted to respectively serve the beam position 1, the beam position 2, the beam position 3, and the beam position 4 in the frequency band BW 1 at time t6 to t7. Resources occupied by noise signals for the service signal 2, the service signal 3, the service signal 4, and the service signal 5 are the time t6 to t7, the frequency band BW 1, the beam position 5, the beam position 6, the beam position 7, and the beam position 8. Another possible implementation is shown in FIG. 14C. A resource occupied by a service signal 5 in FIG. 14A is not adjusted, and resources occupied by a service signal 2, a service signal 3, and a service signal 4 are adjusted. Resources occupied by generated noise signals are the time t5 to t6, the frequency band BW 1, the beam position 6, and the beam position 7; and the time t6 to t7, the frequency band BW1, the beam position 4, the beam position 5, the beam position 6, the beam position 7, and the beam position 8.

The resource occupied by the service signal is adjusted based on the resource available for the noise signal. Adjusting the resource occupied by the service signal is to facilitate use of a given resource for the noise signal. Interference of a noise signal generated from the adjusted service signal to the service signal generated by the first communication device can be reduced.

The second communication device is used as an example. In the foregoing method, in an application manner is used, so that a surrounding satellite provides a resource available for the noise signal generated by the second communication device. The second communication device adjusts, based on the resource provided by the surrounding satellite, a resource occupied by a service beam of the second communication device.

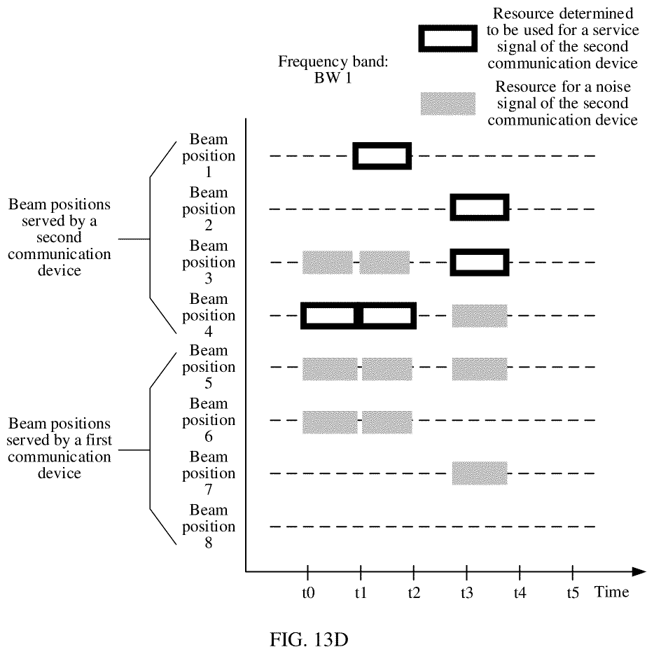

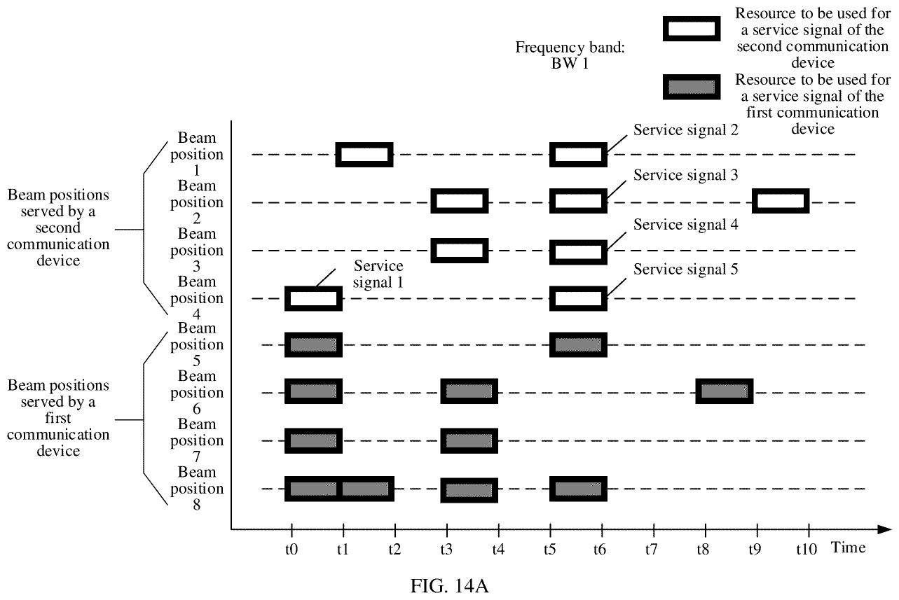

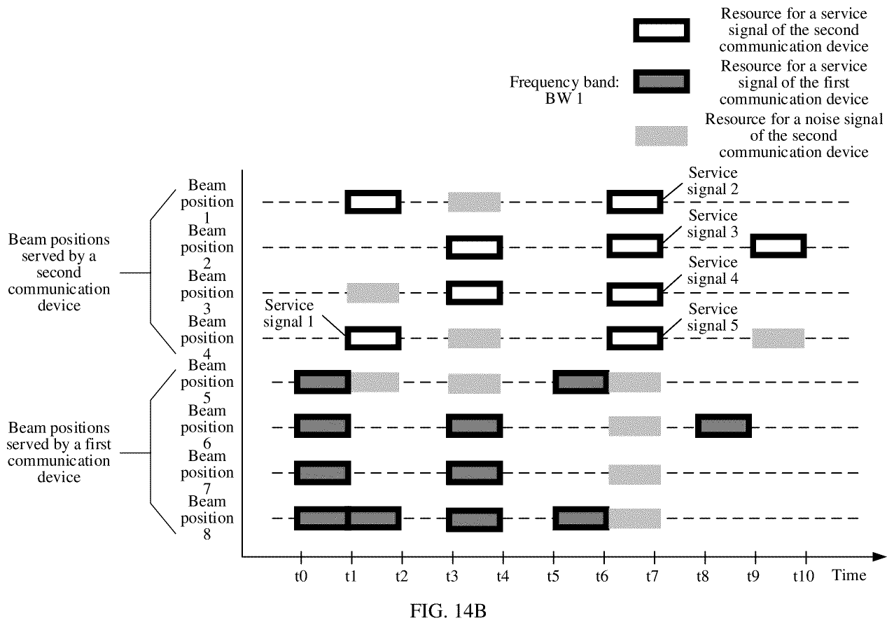

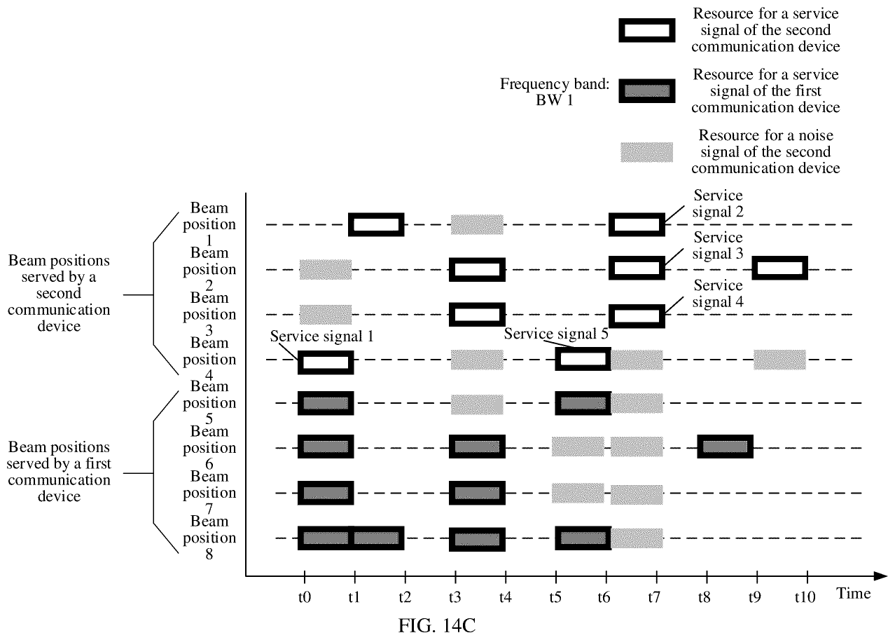

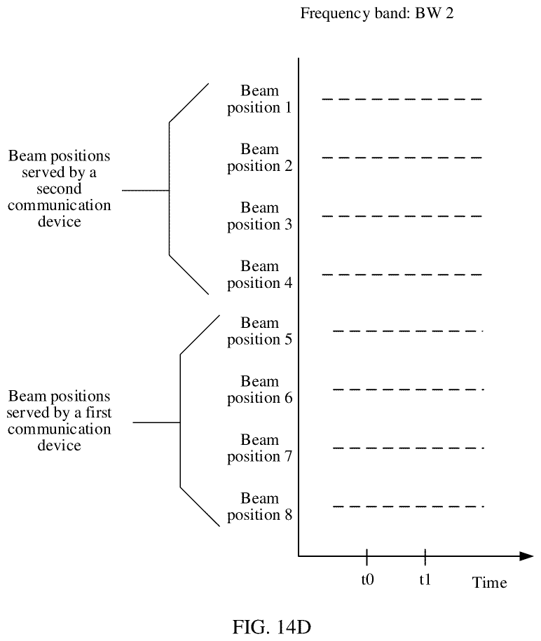

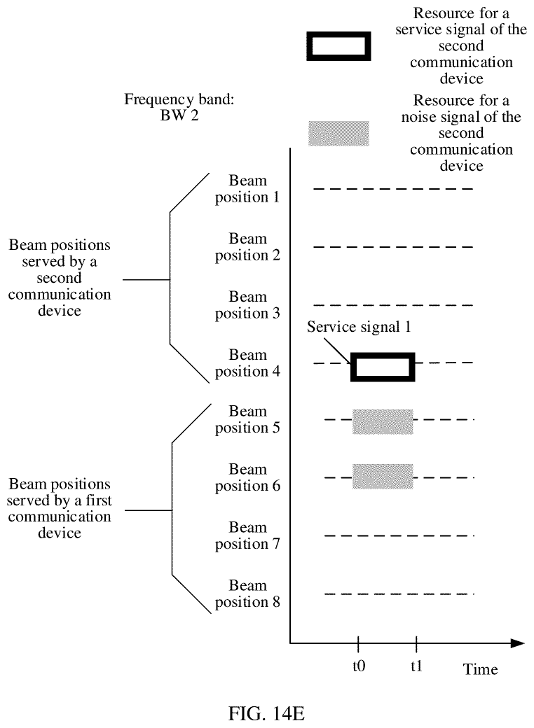

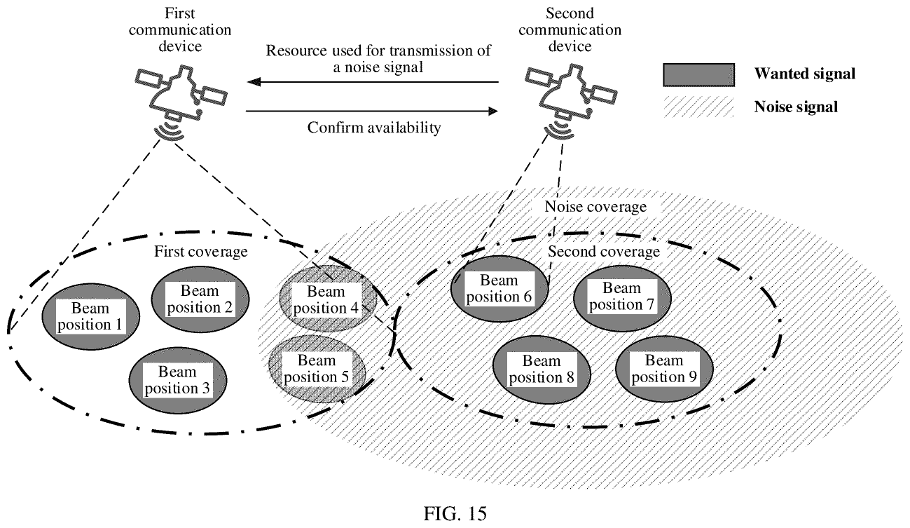

In still another possible implementation, for example, FIG. 15 is a diagram of an inter-communication device application-negotiation solution provided. A difference between FIG. 15 and FIG. 11A lies in content of interaction between a first communication apparatus and a second communication apparatus in the figure. The content of interaction includes: The second communication apparatus sends, to the first communication apparatus, a resource used for transmission of a noise signal. The first communication apparatus sends, to the second communication apparatus, information confirming availability. For other descriptions in FIG. 15, refer to the foregoing content in FIG. 11A. Details are not described herein again.

FIG. 16 provides a signal transmission method. In the method, content shown in FIG. 15 can be presented more clearly. A first communication device in FIG. 16 may be, for example, the second communication device in FIG. 15, and a second communication device in FIG. 16 may be, for example, the first communication device in FIG. 15. According to the method, the first communication device and the second communication device may negotiate, to avoid a service signal generated by the first communication device from interference of a noise signal generated by the second communication device. Both the first communication device and the second communication device may generate a service signal used to serve a terminal, and the service signal generated by the first communication device is interfered by the noise signal generated by the second communication device. For example, the following describes an example in which a service range of the second communication device includes a beam position 1, a beam position 2, a beam position 3, and a beam position 4, and a service range of the first communication device includes a beam position 5, a beam position 6, a beam position 7, and a beam position 8. The method shown in FIG. 16 includes but is not limited to the following steps.

S1601: The second communication device determines a resource occupied by the noise signal.

In an implementation, the second communication device obtains, based on a determined resource occupied by a service signal, including one or more of the following: time, a coverage area, or a frequency band, a resource that may be occupied by a noise signal accompanying the service signal, including one or more of the following: time, a coverage area, or a frequency band.

For example, as shown in FIG. 13A, a white block with a black border in FIG. 13A represents a resource determined by the second communication device to transmit a service signal, and a gray block with a black border represents a resource to be used by the first communication device to transmit a service signal. The second communication device obtains, based on the service signal determined to be used in FIG. 13A, a resource that may be used for a noise signal accompanying the service signal, as shown in FIG. 13C. It can be learned from the information in FIG. 13C that in time t0 to t1, the resource that may be used for transmission of the noise signal is the time t0 to t1, a frequency band BW 1, and any two of the beam position 3, the beam position 5, or the beam position 6. In time t1 to t2, the resource that may be occupied by the noise signal is the time t1 to t2, the frequency band BW 1, and any two of the beam position 3, the beam position 5, or the beam position 6. In time t3 to t4, the resource that may be occupied by the noise signal is the time t3 to t4, the frequency band BW 1, and any two of the beam position 4, the beam position 5, or the beam position 7. For example, the BW 1 may be 29.6 GHz to 29.7 GHZ.

In an implementation, the second communication device obtains, based on a determined resource used for transmission of a service signal, a resource occupied by a noise signal accompanying the service signal.

For example, the second communication device obtains, based on the service signal determined to be used in FIG. 13A, a resource for the noise signal accompanying the service signal, as shown in FIG. 13D. A difference between FIG. 13C and FIG. 13D lies in that FIG. 13C indicates the resource that may be used for transmission of the noise signal, and some resources may be selected from the resource as the resource for the noise signal. However, FIG. 13D indicates the resource used for transmission of the noise signal, and the resource is all used for transmission of the noise signal. It can be learned from the information in FIG. 13D that in time t0 to t1, the resource used for transmission of the noise signal is the time t0 to t1, a frequency band BW 1, and the beam position 3, the beam position 5, or the beam position 6. In time t1 to t2, the resource used for transmission of the noise signal is the time t1 to t2, the frequency band BW 1, and the beam position 3, the beam position 5, or the beam position 6. In time t3 to t4, the resource used for transmission of the noise signal is the time t3 to t4, the frequency band BW 1, and the beam position 4, the beam position 5, or the beam position 7.

S1602: The second communication device sends, to the first communication device, the resource used for transmission of the noise signal.

In a possible implementation, the resource that is received by the first communication device and that is occupied by the noise signal is selectable. For example, the resource that is received by the first communication device and that is available for transmission of the noise signal is shown in Table 8.

TABLE 8

| Time | Frequency band | Beam position |
|---|---|---|
| t0 to t1 | BW 1 | Any two or more of the |
| | | beam position 3, the beam |
| | | position 5, and the beam position 6 |
| t1 to t2 | BW 1 | Any two or more of the |
| | | beam position 3, the beam |
| | | position 5, and the beam position 6 |
| t3 to t4 | BW 1 | Any two or more of the |
| | | beam position 4, the beam |
| | | position 5, and the beam position 7 |

The first communication device determines, based on Table 8 and with reference to information about sending of a service beam by the first communication device, the resource occupied by the second communication device for transmission of the noise signal, as shown in Table 9.

TABLE 9

| Time | Frequency band | Beam position |
|---|---|---|
| t0 to t1 | BW 1 | Beam position 3 and beam position 5 |
| t1 to t2 | BW 1 | Beam position 3 and beam position 6 |
| t3 to t4 | BW 1 | Beam position 5 and beam position 7 |

The resource used by the first communication device to transmit the service beam is shown in FIG. 13A. The resource includes: the frequency band BW 1, the time t0 to t1, the beam position 5, the beam position 6, and the beam position 7; the frequency band BW 1, time t1 to t2, and the beam position 8; and the frequency band BW 1, time t3 to t4, the beam position 6, the beam position 7, and the beam position 8.

In a possible implementation, the resource that is received by the first communication device and that is occupied for transmission of the noise signal is non-selectable. The first communication device may adjust, based on the received resource occupied by the noise signal, the resource occupied by the service signal of the first communication device, to avoid interference of the noise signal to the service signal of the first communication device. For example, the first communication device may be, for example, a first communication device, and the resource that is received by the first communication device and that is occupied by the noise signal is shown in Table 10.

TABLE 10

| Time | Frequency band | Beam position |
|---|---|---|
| t0 to t1 | BW 1 | Beam position 3, beam position 5, |
| | | and beam position 6 |
| t1 to t2 | BW 1 | Beam position 3, beam position 5, |
| | | and beam position 6 |
| t3 to t4 | BW 1 | Beam position 4, beam position 5, |
| | | and beam position 7 |

In a possible implementation, the second communication device may send, to the first communication device via an Xn interface, the resource used for transmission of the noise signal, and the Xn interface may be used for subsequent inter-satellite information transmission.

In a possible implementation, the resource may be indicated in a periodic, aperiodic, or semi-static manner. In a possible implementation, the available resource may be indicated in the periodic, aperiodic, or semi-static manner. For example, when the resource is periodic, the resource may be used, at an interval of fixed time, by the second communication device as a resource for transmission of a noise signal. For example, when the resource is aperiodic, the resource may be used, at an interval of unfixed time, by the second communication device as a resource for transmission of a noise signal. For example, when the resource is semi-static, the resource may be used, at an interval of fixed time, by the second communication device as a resource for transmission of a noise signal, and the resource is also updated with subsequent information.

In a possible implementation, the foregoing resource may be sent in a form of a table. For example, resource information may be indicated by using an index in the table.

It should be noted that step S1602 is an optional step.

S1603: The first communication device returns confirmation information to the second communication device.

In a possible implementation, after receiving the resource that is sent by the second communication device and that is used for transmission of the noise signal, the first communication device needs to return the confirmation information, to confirm that the first communication device has received related information. For example, the resource occupied by the noise signal is shown in Table 10.

It should be noted that step S1603 is an optional step.

S1604: The first communication device sends, to the second communication device, a resource available for transmission of the noise signal.

In a possible implementation, after the first communication device receives the resource that is sent by the second communication device and that may be occupied for transmission of the noise signal, the first communication device determines, with reference to the resource used by the first communication device to transmit the service signal, the resource occupied by the second communication device for transmission of the noise signal. For example, the second communication device may be, for example, a second communication device, and the first communication device may be, for example, a first communication device. The resource that is sent by the second communication device and that may be occupied for transmission of the noise signal may be shown in Table 8. The first communication device determines, based on Table 8 and with reference to the resource used by the first communication device to transmit the service signal, the resource occupied by the second communication device for transmission of the noise signal, as shown in Table 9. The first communication device sends the resource shown in Table 9 to the second communication device.

It should be noted that step S1604 is an optional step.

S1605: The second communication device returns, to the first communication device, the resource determined to be used for transmission of the noise signal.

In a possible implementation, after the second communication device receives the confirmation information returned by the first communication device (for example, step S1603), the second communication device returns, to the first communication device, the resource determined to be used for transmission of the noise signal. For example, the second communication device may be, for example, a second communication device, and the first communication device may be, for example, a first communication device. The second communication device returns, to the first communication device, the resource determined to be used for transmission of the noise signal, which may be, for example, Table 11.

TABLE 11

| | Frequency | |
|---|---|---|
| Time | band | Beam position |
| t0 to t1 | BW 1 | Beam position 3, beam position 5, |
| | | and beam position 6 |
| t1 to t2 | BW 1 | Beam position 3, beam position 5, |
| | | and beam position 6 |
| t3 to t4 | BW 1 | Beam position 4, beam position 5, |
| | | and beam position 7 |

In still another possible implementation, after the second communication device receives the resource that is sent by the first communication device and that is available for transmission of the noise signal (for example, step S1604), the second communication device returns, to the first communication device, the resource determined to be used for transmission of the noise signal. For example, the second communication device may be, for example, a second communication device, and the first communication device may be, for example, a first communication device. The second communication device returns, to the first communication device, the resource determined to be used for transmission of the noise signal, which may be, for example, Table 12.

TABLE 12

| | Frequency | |
|---|---|---|
| Time | band | Beam position |
| t0 to t1 | BW 1 | Beam position 3 and |
| | | beam position 5 |
| t1 to t2 | BW 1 | Beam position 3 and |
| | | beam position 6 |
| t3 to t4 | BW 1 | Beam position 5 and |
| | | beam position 7 |

It should be noted that step S1605 is an optional step.

S1606: The first communication device determines, based on the received resource occupied by the noise signal, the resource used for transmission of the service signal.

In a possible implementation, after the first communication device receives the resource used by the second communication device to transmit the noise signal, the first communication device adjusts, based on the resource, a time resource occupied by the first communication device for transmission of the service signal. For a specific implementation process, refer to step S1107. Details are not described herein again.

In a possible implementation, the first communication device may adjust only a frequency band of the service signal, to avoid interference of the noise signal of the second communication device and further provide a service for a coverage area of the noise signal. For a specific implementation process, refer to step S1107. Details are not described herein again.

In a possible implementation, the first communication device may adjust a frequency band and time that are used for transmission of the service signal, to avoid the noise signal of the second communication device as much as possible, and reduce interference of the noise signal to the service signal of the first communication device. For a specific implementation process, refer to step S1107. Details are not described herein again.

It should be noted that step S1606 is an optional step.

S1607: The second communication device transmits the noise signal based on the determined resource used for transmission of the noise signal.

In a possible implementation, for a method for transmission of the noise signal by the second communication device based on the determined resource used for transmission of the noise signal, refer to step S1108. Details are not described herein again.

S1608: The first communication device transmits the service signal to a terminal device based on the resource for transmission of the service signal.

For example, the first communication device sends the service signal to the terminal device based on the resource for transmission of the service signal and with reference to the method shown in FIG. 9. The service signal is less interfered by the noise signal of the second communication device.

It should be noted that the signal transmission method shown in FIG. 16 is not limited to the foregoing steps, and may be a combination of the foregoing steps in a specific implementation process.

An adjusted resource used by the first communication device to transmit the service signal can effectively avoid interference from the noise signal of the second communication device.

In the foregoing method, the first communication device directly negotiates with the second communication device, to determine the resource used for transmission of the noise signal or the resource used for transmission of the service signal. In still another possible implementation, a third communication device is disposed to integrate resources expected by a plurality of communication devices for transmission of noise signals and/or resources of a plurality of communication devices that can be used by another communication device to transmit a noise signal, and then the third communication device allocates, to the another communication device based on received information sent by the another communication device and the integrated resources, a resource used for transmission of the noise signal or a resource used for transmission of a service signal.

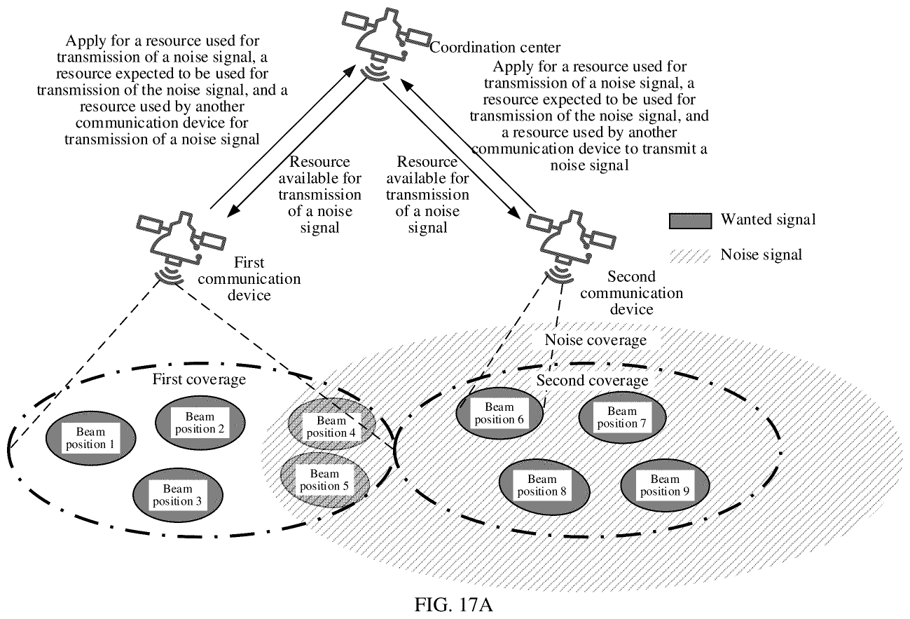

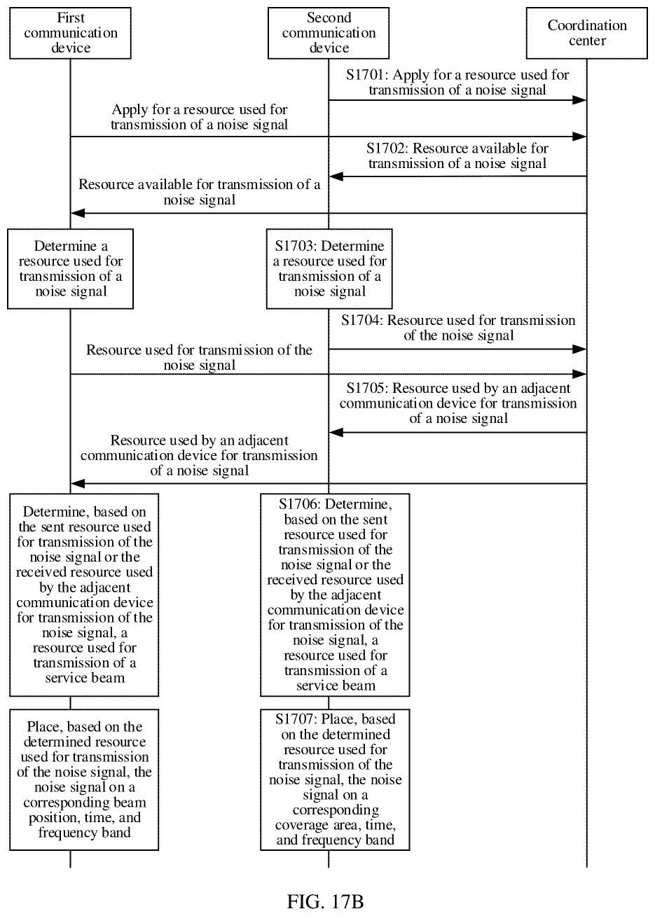

In still another possible implementation, for example, FIG. 17A is a diagram of an inter-communication device centralized application-negotiation solution provided. A difference between FIG. 17A and FIG. 15 lies in that FIG. 17A includes an additional coordination center. For example, the coordination center may be a base station, a network side processor, or a device that can be used for communication like the foregoing communication device. All communication devices in FIG. 17A perform application-negotiation via the coordination center. Content of application-negotiation between the communication device and the coordination center in FIG. 17A includes: A first communication device and a second communication device send application information to the coordination center, where the application information is used to apply for a resource for transmission of a noise signal, a resource expected to be used for transmission of the noise signal, and a resource used by another communication device to transmit a noise signal. The coordination center sends, to the first communication device and the second communication device, resources available for transmission of noise signals. For other descriptions in FIG. 17A, refer to the content in FIG. 3A. Details are not described herein again.

FIG. 17B provides a beam processing method. In the method, content shown in FIG. 17A can be presented more clearly, where a first communication device and a second communication device perform same steps. In this application, the second communication device in the figure is used as an example to describe a possible implementation of the method shown in FIG. 17B. FIG. 17B shows interaction between the first communication device and the second communication device and the coordination center, mainly to show that the coordination center may be configured to coordinate a plurality of communication devices to send service signals and/or noise signals. The method includes but is not limited to the following steps.

S1701: The second communication device applies to the coordination center for a resource used for transmission of a noise signal.

When the second communication device needs to suppress a high peak-to-average power ratio of a signal, the second communication device applies to the coordination center for the resource used for transmission of the noise signal, and the coordination center selects one or more resources from a candidate resource, and returns the one or more resources to the second communication device. The candidate resource is an idle resource (a resource that can be used by another communication device to transmit a noise signal) in a resource used by the another communication device to transmit a service signal. A manner in which the coordination center obtains the idle resource may be: Application information of a communication device for applying to the coordination center for a resource used for transmission of a noise signal carries an idle resource of the communication device, or the coordination center sends obtaining information to one or more communication devices, to obtain an idle resource in the communication device.

Application information sent by the second communication device to the coordination center may further include a resource expected by the second communication device to be used for transmission of the noise signal. The following describes content included in the application information in different cases.

In a first case, in a possible implementation, the application information sent by the second communication device to the coordination center includes only obtaining the resource used by the second communication device to transmit the noise signal. The resource includes one or more of the following: time for transmission of the noise signal, a frequency band of a beam that carries the noise signal, or a coverage area of the noise signal.

In a possible implementation, except a beam position for representing a coverage area of a service beam or noise, a longitude and a latitude, an administrative region, or the like may be used to represent the coverage area. For example, the coverage area is represented in a form of longitude and latitude, for example, from longitude 73°33′ east to longitude 73°58′ east, and from latitude 3°43′ north to latitude 4°21′ north. Alternatively, a named area may be used for representation. For example, an area in which a city is located is a beam position, or an area in which a village or town is located is a beam position. It may be understood that a size and a shape of a coverage area of a beam position may be adjusted based on a requirement. This is not limited in this embodiment of this application.

The time may be absolute time, for example, coordinated time or Greenwich mean time. The time may alternatively be relative time, for example, a frame number, a subframe number, a slot number, or a symbol sequence number. For example, the time may be (+0800) the 5^{th} millisecond of 00:01 on Jan. 1, 2001 to (+0800) the 15^{th} millisecond of 00:01 on Jan. 1, 2001.

A unit of the frequency band may be hertz (Hz) or kilohertz (kHz), or may be a frequency domain unit such as a resource block (RB), a resource element (RE), a resource block group (RBG), a resource element group (REG), or a channel control element (CCE).

The second communication device sends one piece of application information to the coordination center, to apply for one or more resources. In this application, a quantity of resources that can be applied for based on the one piece of application information is not limited.

In a second case, in a possible implementation, the application information further includes a resource expected by the second communication device to be used for transmission of the noise signal. For example, the resource expected by the second communication device to be used for transmission of the noise signal is shown in Table 13A.

TABLE 13A

| | Frequency | |
|---|---|---|
| Time | band | Beam position |
| t3 to t4 | BW 1 | Beam position 5 |
| t5 to t6 | BW 1 | Beam position 6 |
| t7 to t8 | BW 1 | Beam position 7 |
| t9 to t10 | BW 1 | Beam position 5 and |
| | | beam position 6 |

In a third case, in a possible implementation, the application information may include all or some information in Table 13A. The some information may be one or more of the following: time information, frequency band information, or beam position information. For example, the application information includes only the time information, as shown in Table 13B. For example, the application information includes only the time information and the frequency band information, as shown in Table 13C.

TABLE 13B
Time

t3 to t4
t5 to t6
t7 to t8
t9 to t10

TABLE 13C

| | Frequency |
|---|---|
| Time | band |
| t3 to t4 | BW 1 |
| t5 to t6 | BW 1 |
| t7 to t8 | BW 1 |
| t9 to t10 | BW 1 |

In a fourth case, in a possible implementation, the application information further includes a resource available for another communication device to transmit a noise signal. For example, a resource that can be provided by the second communication device for another satellite to transmit a noise signal is shown in Table 14.

TABLE 14

| | Frequency | |
|---|---|---|
| Time | band | Beam position |
| t1 to t2 | BW 1 | Beam position 1 |
| t3 to t4 | BW 1 | Beam position 2 |
| t5 to t6 | BW 1 | Beam position 3 |
| t7 to t8 | BW 1 | Beam position 1 and |
| | | beam position 2 |

In a possible implementation, the second communication device may send the application information to the coordination center via an Xn interface.

S1702: The coordination center transmits the resource available for the noise signal to the second communication device.

Before transmitting the resource available for the noise signal to the second communication device, the coordination center needs to obtain the idle resource of the another communication device. Descriptions are provided in different cases based on content of the idle resource.

In a first case, the idle resource includes one or more groups of resources available for transmission of the noise signal, and each group of idle resources includes time, a frequency band, and a beam position. For example, Table 15A shows the resource that the coordination center has obtained and that is available for the another communication device to transmit the noise signal.

TABLE 15A

| | Frequency | |
|---|---|---|
| Time | band | Beam position |
| t1 to t2 | BW 1 | Beam position 1 and |
| | | beam position 7 |
| t2 to t3 | BW 1 | Beam position 4 and |
| | | beam position 5 |
| t2 to t3 | BW 2 | Beam position 3 and |
| | | beam position 5 |
| t3 to t4 | BW 1 | Beam position 2 and |
| | | beam position 5 |
| t5 to t6 | BW 1 and BW 2 | Beam position 3 and |
| | | beam position 6 |
| t7 to t8, and | BW 1 | Beam position 1 and |
| t9 to t10 | | beam position 7 |

In a second case, the idle resource includes one or more groups of resources available for transmission of the noise signal, and each group of idle resources includes one or more of the following: time, a frequency band, and a beam position. For example, Table 15B shows the resource that the coordination center has obtained and that is available for the another communication device to transmit the noise signal.

TABLE 15B

| | Frequency | |
|---|---|---|
| Time | band | Beam position |
| t1 to t2 | BW 1 | \ |
| t2 to t3 | \ | Beam position 4 and |
| | | beam position 5 |
| \ | BW 2 | Beam position 3 and |
| | | beam position 5 |
| t3 to t4 | \ | \ |

“\” in the table indicates that there is no corresponding information and a corresponding resource can be used without restrictions.

For example, when the time is t1 to t2 and the frequency band is a BW 1, the beam position resource is “\”, indicating that when the time is t1 to t2 and the frequency band is the BW 1, any available beam position may be used to send the noise signal. For example, a beam position to which the noise signal of the second communication device may be sent includes a beam position 2, a beam position 5, and a beam position 7. In this case, in Table 15B, when the time is t1 to t2 and the frequency band is the BW 1, a beam position available for sending the noise signal includes any one or more of the following: the beam position 2, the beam position 5, or the beam position 7. Other “\” represents a similar function, and details are not described herein again.

The coordination center determines, based on the received application information and with reference to the obtained idle resource of the another communication device, the resource used by the second communication device to transmit the noise signal.

In a possible implementation, the resource that the coordination center has obtained and that is available for the another communication device to transmit the noise signal is shown in Table 15. The second communication device sends, to the coordination center, the resource expected to be used for transmission of the noise signal. For example, the second communication device may be, for example, a second communication device, and the resource that is expected to be used for transmission of the noise signal and that is sent by the second communication device to the coordination center is shown in Table 13A. The resource that is transmitted by the coordination center to the second communication device and that is available for transmission of the noise signal is shown in Table 16.

TABLE 16
Resource available for the second communication
device to transmit the noise signal

| | Frequency | |
|---|---|---|
| Time | band | Beam position |
| t3 to t4 | BW 1 | Beam position 2 and |
| | | beam position 5 |
| t5 to t6 | BW 1 | Beam position 6 |
| t7 to t8 | BW 1 | Beam position 8 |

It can be learned from Table 16 that the resource in Table 16 includes a part in both Table 13A and Table 15A, for example: the time: t3 to t4, the frequency band: the BW 1, and the beam position: the beam position 5; and the time: t5 to t6, the frequency band: the BW 1, and the beam position: a beam position 6. The resource in Table 16 further includes a resource that is not in Table 13A, for example: the time: t7 to t8, the frequency band: the BW 1, and the beam position: the beam position 8. In a possible implementation, the resource that is sent by the coordination center to the second communication device and that is available for transmission of the noise signal may include some resources in Table 16, for example, include only the following: the time: t7 to t8, the frequency band: the BW 1, and the beam position: the beam position 8.

S1703: The second communication device determines the resource used for transmission of the noise signal.

In a possible implementation, the second communication device determines, based on the received resource that is sent by the coordination center and that is available for transmission of the noise signal, the resource used by the second communication device to transmit the noise signal. For example, the resource that is received by the second communication device and that is available for transmission of the noise signal is shown in Table 16, and the resource that is used by the second communication device to transmit the noise signal and that is determined by the second communication device based on Table 16 is shown in Table 17.

TABLE 17

| | Frequency | |
|---|---|---|
| Time | band | Beam position |
| t3 to t4 | BW 1 | Beam position 5 |
| t5 to t6 | BW 1 | Beam position 6 |
| t7 to t8 | BW 1 | Beam position 8 |

In a possible implementation, the resource used by the second communication device to transmit the noise signal may be some resources in Table 17. For example, the some resources include: the time: t5 to t6, the frequency band: BW 1, and the beam position: the beam position 6.

S1704: The second communication device sends, to the coordination center, the resource used for transmission of the noise signal.

In a possible implementation, the second communication device sends, to the coordination center, the resource that is determined in step S1703 and that is used for transmission of the noise signal. For example, the second communication device sends content shown in Table 17 to the coordination center.

In a possible implementation, the second communication device may send, to the coordination center via the Xn interface, the resource used for transmission of the noise signal.

S1705: The coordination center sends, to the second communication device, a resource used by an adjacent communication device to transmit a noise signal.

In a possible implementation, the coordination center sends, to the second communication device, the resource used by the adjacent communication device to transmit the noise signal. For example, the adjacent communication device may be, for example, a third communication device or a fourth communication device, and the resource used by the adjacent communication device to transmit the noise signal is shown in Table 18.

TABLE 18

| Communication | | Frequency | |
|---|---|---|---|
| device name | Time | band | Beam position |
| Third | t1 to t2 | BW 1 | Beam position 2 and |
| communication | | | beam position 3 |
| device | | | |
| Third | t1 to t2 | BW 2 | Beam position 1 and |
| communication | | | beam position 7 |
| device | | | |
| Third | t2 to t3 | BW 1 | Beam position 6 and |
| communication | | | beam position 9 |
| device | | | |
| Third | t3 to t4 | BW 1 | Beam position 3 and |
| communication | | | beam position 5 |
| device | | | |
| Fourth | t5 to t6 | BW 1 | Beam position 4 and |
| communication | | | beam position 6 |
| device | | | |
| Fourth | t5 to t6 | BW 2 | Beam position 9 |
| communication | | | |
| device | | | |
| Fourth | t7 to t8 | BW 1 | Beam position 8 and |
| communication | | | beam position 10 |
| device | | | |

The table includes resources used by the third communication device and the fourth communication device to transmit noise signals, where the part used by the second communication device to transmit the service signal is shown in Table 19.

TABLE 19

| Communication | | Frequency | |
|---|---|---|---|
| device name | Time | band | Beam position |
| Third | t1 to t2 | BW 1 | Beam position 2 and |
| communication | | | beam position 3 |
| device | | | |
| Third | t1 to t2 | BW 2 | Beam position 1 |
| communication | | | |
| device | | | |
| Third | t3 to t4 | BW 1 | Beam position 3 |
| communication | | | |
| device | | | |
| Fourth | t5 to t6 | BW 1 | Beam position 4 |
| communication | | | |
| device | | | |

In a possible implementation, the resource that is sent by the coordination center to the second communication device and that is used by the adjacent communication device to transmit the noise signal may be shown in Table 19.

In still another possible implementation, the resource that is sent by the coordination center to the second communication device and that is used by the adjacent communication device to transmit the noise signal may include some data in Table 19. For example, as shown in Table 20, the table does not include the label “communication device name”.

TABLE 20

| | Frequency | |
|---|---|---|
| Time | band | Beam position |
| t1 to t2 | BW 1 | Beam position 2 and |
| | | beam position 3 |
| t1 to t2 | BW 2 | Beam position 1 and |
| | | beam position 7 |
| t2 to t3 | BW 1 | Beam position 6 and |
| | | beam position 9 |
| t3 to t4 | BW 1 | Beam position 3 and |
| | | beam position 5 |
| t5 to t6 | BW 1 | Beam position 4 and |
| | | beam position 6 |
| t5 to t6 | BW 2 | Beam position 9 |
| t7 to t8 | BW 1 | Beam position 8 and |
| | | beam position 10 |

In still another possible implementation, in addition to including the labels in Table 20, a resource that is sent by the coordination center to the second communication device and that is used by an adjacent satellite to transmit a noise signal may further include a label such as a “resource level”, for example, as shown in Table 21.

TABLE 21

| Communication | | Frequency | | Resource |
|---|---|---|---|---|
| device name | Time | band | Beam position | level |
| Third | t1 to t2 | BW 1 | Beam position 2 and | A |
| communication | | | beam position 3 | |
| device | | | | |
| Third | t1 to t2 | BW 2 | Beam position 1 and | A |
| communication | | | beam position 7 | |
| device | | | | |
| Third | t2 to t3 | BW 1 | Beam position 6 and | B |
| communication | | | beam position 9 | |
| device | | | | |
| Third | t3 to t4 | BW 1 | Beam position 3 and | B |
| communication | | | beam position 5 | |
| device | | | | |
| Fourth | t5 to t6 | BW 1 | Beam position 4 and | B |
| communication | | | beam position 6 | |
| device | | | | |
| Fourth | t5 to t6 | BW 2 | Beam position 9 | A |
| communication | | | | |
| device | | | | |
| Fourth | t7 to t8 | BW 1 | Beam position 8 and | B |
| communication | | | beam position 10 | |
| device | | | | |

In the table, the resource used by the adjacent communication device to transmit the noise signal is classified into three levels: A, B, and C. The level A indicates a high level, and represents that the resource is definitely used for transmission of the noise signal. The level B indicates a low level, and represents that the resource is allowed to be changed after negotiation and determining. For example, the fourth communication device prepares to use a resource represented by the time: t5 to t6, the frequency band: the BW 1, the beam position: the beam position 4, and the resource level: B, to transmit a noise signal. Because the second communication device also prepares to use the resource to send the service signal, the second communication device may negotiate with the fourth communication device to determine how to allocate the resource. A manner in which the second communication device negotiates with the fourth communication device may be a form in which the second communication device and the fourth communication device send data to each other; or may be a form in which data is forwarded via the coordination center between the second communication device and the fourth communication device; or may be a form in which the second communication device sends a requirement for using the resource to the coordination center, so that the coordination center re-allocates the resource. A specific implementation form is not limited in this application.

The adjacent communication device may be a satellite adjacent to a coverage area of a service signal sent by the communication device, may be a communication device that interferes with the noise signal sent by the communication device, or may be a communication device whose actual distance with the communication device is less than a specific threshold. For example, two communication devices whose straight-line distance is less than 200 km are referred to as adjacent communication devices.

S1706: The second communication device determines, based on the sent resource used for transmission of the noise signal or the received resource used by the adjacent communication device to transmit the noise signal, a resource used for transmission of a service beam.

In a possible implementation, the resource that is received by the second communication device and that is used for transmission of the noise signal is a resource determined to be used by the adjacent communication device to transmit noise. In this case, the second communication device adjusts, based on the resource, the resource used by the second communication device to transmit the service signal, to avoid interference of the noise. Alternatively, the second communication device may adjust, based on the sent resource used for transmission of the noise signal, the resource used by the second communication device to transmit the service signal, to avoid interference of the noise. For a specific adjustment manner, refer to the foregoing corresponding content. Details are not described herein again.

S1707: The second communication device places, based on the resource determined to be used for transmission of the noise signal, the noise signal on a corresponding coverage area, time, and frequency band.

In a possible implementation, for a method for placing, by the second communication device, the noise signal on the corresponding coverage area, time, and frequency band based on the resource for the noise signal, refer to the foregoing corresponding content. Details are not described herein again.

According to the method shown in FIG. 17A, the coordination center obtains resources expected by a plurality of communication devices to be used for transmission of noise signals, obtains a resource of each of the plurality of communication devices that is available for another satellite to transmit a noise signal, integrates obtained information, and allocates, to each of the plurality of communication devices, a resource available for transmission of a noise signal. Further, each communication device determines a beam hopping pattern based on the resource available for transmission of the noise signal. In this manner, resources of the satellites can be better coordinated, and resources of the satellites that are available for transmission of service beams can be fully used, so that data transmission efficiency of the satellites is improved.

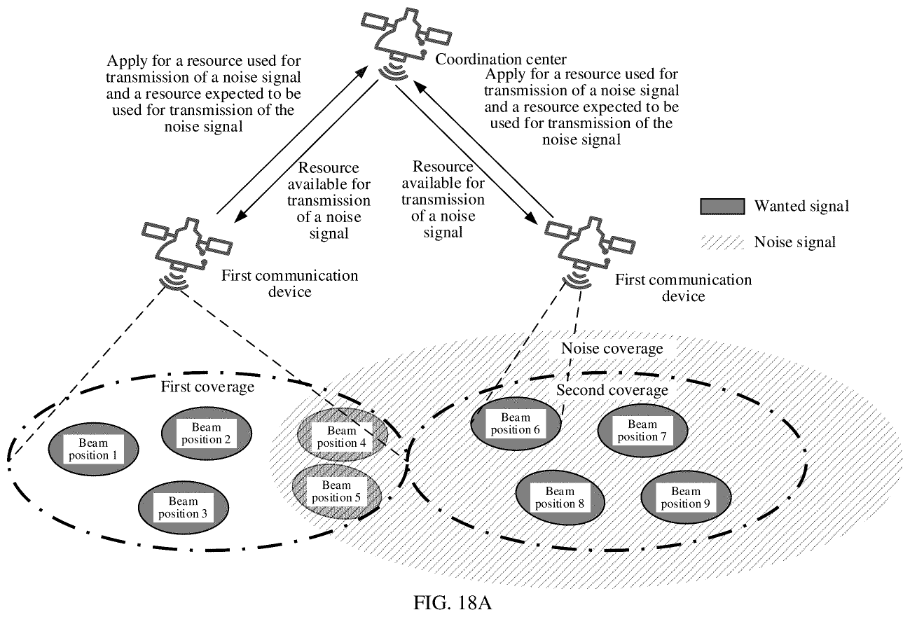

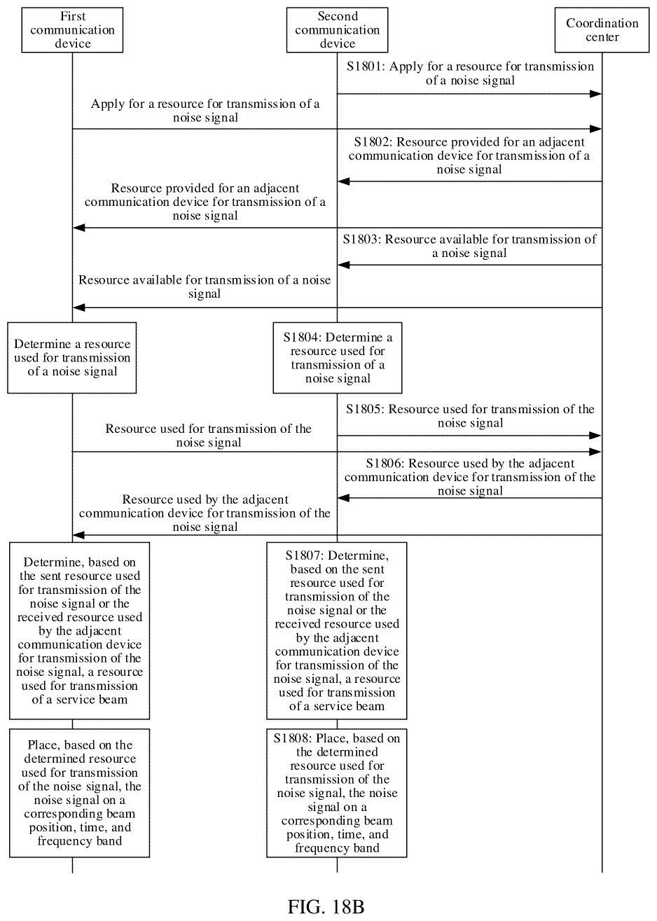

In still another possible implementation, for example, FIG. 18A is a diagram of an inter-communication device centralized application-negotiation solution provided. A difference between FIG. 18A and FIG. 17A lies in that information sent by a first communication device and a second communication device to a coordination center in FIG. 18A does not include a resource of the communication device that is used by another communication device to transmit a noise signal. For other descriptions in FIG. 18A, refer to the content in FIG. 17A. Details are not described herein again.

The coordination center obtains only resources expected by a plurality of communication devices to be used for transmission of noise signals. After integrating the resources expected by the plurality of communication devices to be used for transmission of the noise signals, the coordination center allocates, to each of the plurality of communication devices, a resource available for transmission of a noise signal and/or the resource used by the another communication device to transmit the noise signal. Further, each communication device determines a beam hopping pattern based on the resource available for transmission of the noise signal. According to the method, the coordination center can better allocate a resource available for each communication device to transmit a service beam, the resource available for each communication device to transmit the service beam is more fully used, and data transmission efficiency of the communication device is further improved.

FIG. 18B provides a beam processing method. In the method, content shown in FIG. 18A can be presented more clearly. The first communication device and the second communication device perform same steps. In this application, the second communication device in FIG. 18B is used as an example to describe a possible implementation of this embodiment. FIG. 18B shows interaction between the first communication device and the second communication device and the coordination center, mainly to show that the coordination center may be configured to coordinate a plurality of communication devices to send service signals and/or noise signals. The method includes but is not limited to the following steps.

S1801: The second communication device applies to the coordination center for a resource for transmission of a noise signal.

In a possible implementation, when the second communication device has a noise signal transmission requirement, the second communication device sends an application to the coordination center to apply for the resource for transmission of the noise signal, where the resource includes one or more of the following: time for transmission of the noise signal, a frequency band in which a beam carrying the noise signal is located, or a coverage area of the noise signal.

In a possible implementation, except a beam position for representing a coverage area of a service beam or noise, a longitude and a latitude, an administrative region, or the like may be used to represent the coverage area. For example, the coverage area is represented in a form of longitude and latitude, for example, from longitude 73°33′ east to longitude 73°58′ east, and from latitude 3°43′ north to latitude 4°21′ north. Alternatively, a named area may be used for representation. For example, an area in which a city is located is a beam position, or an area in which a village or town is located is a beam position. It may be understood that a size and a shape of a coverage area of a beam position may be adjusted based on a requirement. This is not limited in this embodiment of this application.

The time may be absolute time, for example, coordinated time or Greenwich mean time. The time may alternatively be relative time, for example, a frame number, a subframe number, a slot number, or a symbol sequence number. For example, the time may be (+0800) the 5th millisecond of 00:01 on Jan. 1, 2001 to (+0800) the 15th millisecond of 00:01 on Jan. 1, 2001.

A unit of the frequency band may be hertz (Hz) or kilohertz (kHz), or may be a frequency domain unit such as a resource block (RB), a resource element (RE), a resource block group (RBG), a resource element group (REG), or a channel control element (CCE).

The second communication device sends one piece of application information to the coordination center, to apply for one or more resources. In this application, a quantity of resources that can be applied for based on the one piece of application information is not limited.

In a possible implementation, an application sent by the first communication device to the coordination center includes a resource expected by the first communication device to be used for transmission of a noise signal, for example, as shown in Table 22.

TABLE 22

| | Frequency | |
|---|---|---|
| Time | band | Beam position |
| t1 to t2 | BW 1 | Beam position 1 |
| t3 to t4 | BW 1 | Beam position 2 |
| t5 to t6 | BW 1 | Beam position 3 |
| t7 to t8 | BW 1 | Beam position 4 |
| t9 to t10 | BW 1 | Beam position 2 and |
| | | beam position 3 |

In a possible implementation, an application sent by the second communication device to the coordination center includes a resource expected by the second communication device to be used for transmission of the noise signal. For example, the resource expected by the second communication device to be used for transmission of the noise signal is shown in Table 23.

TABLE 23

| | Frequency | |
|---|---|---|
| Time | band | Beam position |
| t3 to t4 | BW 1 | Beam position 5 |
| t5 to t6 | BW 1 | Beam position 6 |
| t7 to t8 | BW 1 | Beam position 7 |
| t9 to t10 | BW 1 | Beam position 5 and |
| | | beam position 6 |

In a possible implementation, an application sent by the second communication device to the coordination center may include all or some information in Table 23. The some information may include one or more of the following: time information, frequency band information, or beam position information. For example, the application sent by the second communication device to the coordination center includes: only the time: t3 to t4. For example, the application sent by the second communication device to the coordination center includes: the time: t5 to t6, and the frequency band: a BW 1. For example, the application sent by the second communication device to the coordination center includes: the time: t3 to t4, the frequency band: a BW 1, and the beam position: a beam position 5; the time: t5 to t6, the frequency band: the BW 1, and the beam position: a beam position 6; and the time: t7 to t8, the frequency band: the BW 1, and the beam position: a beam position 7.

In a possible implementation, the second communication device may send the application information to the coordination center via an Xn interface.

S1802: The coordination center sends, to the second communication device, a resource provided for a communication device adjacent to the second communication device to transmit a noise signal.

The communication device adjacent to the second communication device may be a communication device adjacent to a coverage area of a service beam sent by the second communication device, may be a communication device that interferes with the noise signal sent by the second communication device, or may be a communication device whose actual distance with the second communication device is less than a specific threshold. For example, two communication devices whose straight-line distance is less than 200 km are referred to as adjacent communication devices.

In a possible implementation, the coordination center obtains resources expected by a plurality of communication devices adjacent to the second communication device to be used for transmission of noise signals. For example, the communication device adjacent to the second communication device may be, for example, the first communication device or a third communication device. The resource expected by the second communication device to be used for transmission of the noise signal is shown in Table 23. A resource expected by the third communication device to be used for transmission of a noise signal is shown in Table 24.

TABLE 24

| | Frequency | |
|---|---|---|
| Time | band | Beam position |
| t1 to t2 | BW 1 | Beam position 2 |
| t5 to t6 | BW 1 | Beam position 4 |
| t9 to t10 | BW 1 | Beam position 1 and |
| | | beam position 4 |

The resources expected by the first communication device and the third communication device to be used for transmission of the noise signals may further include resources on adjacent communication devices of the first communication device and the third communication device. Table 22 and Table 24 show only resources expected by the first communication device and the third communication device to be used for transmission of the noise signals in the coverage area of the service beam of the second communication device.

For example, the coordination center obtains, based on Table 22 and Table 24, the resource expected by the communication device adjacent to the second communication device to be used for transmission of the noise signal, as shown in Table 25.

TABLE 25

| | Frequency | |
|---|---|---|
| Time | band | Beam position |
| t1 to t2 | BW 1 | Beam position 1 and |
| | | beam position 2 |
| t3 to t4 | BW 1 | Beam position 2 |
| t5 to t6 | BW 1 | Beam position 3 and |
| | | beam position 4 |
| t7 to t8 | BW 1 | Beam position 4 |
| t9 to t10 | BW 1 | Beam position 1, beam position 2, |
| | | beam position 3, and |
| | | beam position 4 |

The resource shown in Table 25 is a resource that the second communication device needs to reserve for the another communication device to transmit the noise signal.

In a possible implementation, the coordination center obtains, with reference to the resource (as shown in Table 25) expected by the communication device adjacent to the second communication device to be used for transmission of the noise signal and the resource (as shown in Table 23) expected by the second communication device to be used for transmission of the noise signal, a resource that the second communication device needs to reserve for the adjacent communication device to transmit the noise signal. For example, the second communication device has a resource expected to be used for transmission of the noise signal in time t9 to t10 and the frequency band BW 1. Therefore, if the second communication device needs to send a service signal in the time t0 to t10 and the frequency band BW 1, a time resource that needs to be occupied is ty to t10, a frequency band resource that needs to be occupied is the BW 1, and a beam position resource that needs to be occupied is one or more of the following: a beam position 1, a beam position 2, a beam position 3, or a beam position 4. However, in the time t9 to t10 and the frequency band BW 1, the beam position resource that may be used by the second communication device to send the service signal is completely consistent with the resource expected by the communication device adjacent to the second communication device to be used for transmission of the noise signal. When the second communication device sends a service beam in the time t9 to t10 and the frequency band BW 1, the service beam is definitely interfered by noise from an adjacent satellite. Therefore, the coordination center needs to perform coordination for the foregoing problem. The following provides descriptions in different cases.

In a first case, the coordination center may evenly allocate a conflicting resource to the second communication device and the communication device adjacent to the second communication device by using an even allocation principle. For example, a coordination result of the coordination center is: The coordination center sends, to the first communication device, that beam position resources available for transmission of the noise signal in the time t9 to t10 and the frequency band BW 1 are the beam position 1 and the beam position 4. In this case, in the time t9 to t10 and the frequency band BW 1, the beam position 2 and the beam position 3 may be reserved for transmission of the service signal of the second communication device.

In a second case, the coordination center may adjust, based on a priority allocation principle, that is, allocating a resource to the noise signal of the adjacent communication device first for use, a resource occupied by the service signal, to avoid the service signal from the noise signal. For example, the coordination center sends, to the second communication device, that beam position resources available for transmission of the noise signal in the time t9 to t10 and the frequency band BW 2 are a beam position 5 and a beam position 6. In this case, in the time t9 to t10, a frequency band resource available for the second communication device to transmit the service signal is a BW 2 (it is assumed that a satellite adjacent to the second communication device does not send a noise signal in the time t9 to t10 and the frequency band BW 2), so that interference from the noise signal of the adjacent communication device can be avoided.

In a third case, the coordination center may adjust resources used by the second communication device and the communication device adjacent to the second communication device to transmit the noise signals. An adjustment manner is similar to that in the foregoing embodiment, and details are not described herein again.

The foregoing content describes an operation mode of the coordination center from three aspects: adjusting the resource available for the noise signal of the second communication device, adjusting the resource available for the noise signal of the adjacent communication device of the second communication device, and adjusting the resources available for the noise signals of the second communication device and the adjacent communication device of the second communication device. In an actual system, there are a plurality of adjacent communication devices around each communication device, and a process in which the coordination center adjusts resources available for noise signals of the plurality of communication devices is more complex. An objective of the adjustment is to more fully use the resource available for each communication device and improve efficiency of the communication device. A specific adjustment process is not limited in this application.

In a possible implementation, after the coordination center sends, to the second communication device, the resource provided for the communication device adjacent to the second communication device to transmit the noise signal, the second communication device returns, to the coordination center, information for confirming reception.

S1803: The coordination center sends, to the second communication device, a resource available for transmission of the noise signal.

In a possible implementation, the coordination center determines, based on the resource (as shown in Table 23) that is sent by the second communication device and that is expected to be used for transmission of the noise signal and the resource (as shown in Table 25) expected by the communication device adjacent to the second communication device to be used for transmission of the noise signal, the resource available for the second communication device to transmit the noise signal.

For example, with reference to Table 23 and Table 25, it can be learned that when the time is t9 to t10 and the frequency band is the BW 1, the second communication device has a service signal sending requirement, but the beam position 1, the beam position 2, the beam position 3, and the beam position 4 are all used by the adjacent communication device to transmit the noise signal. Therefore, the time or the frequency band used by the second communication device to transmit the noise signal may be adjusted, so that the service signal transmitted by the second communication device avoids the noise signal transmitted by the adjacent communication device. Adjusting the time is used as an example. The time resource used for transmission of the noise signal of the second communication device is adjusted to t10 to t11. In this case, the resource that is sent by the coordination center to the second communication device and that is used for transmission of the noise signal may be adjusted based on Table 26.

TABLE 26

| | Frequency | |
|---|---|---|
| Time | band | Beam position |
| t3 to t4 | BW 1 | Beam position 5 and |
| | | beam position 6 |
| t5 to t6 | BW 1 | Beam position 6 |
| t7 to t8 | BW 1 | Beam position 7 and |
| | | beam position 8 |
| t10 to t11 | BW 1 | Beam position 5 and |
| | | beam position 6 |

The foregoing specific adjustment process is more complex, and an objective of the adjustment is to better use a satellite resource. A specific adjustment manner is not limited in this application.

S1804: The second communication device determines the resource used for transmission of the noise signal.

In a possible implementation, the second communication device determines, based on the resource that is sent by the coordination center and that is available for transmission of the noise signal, the resource used by the second communication device to transmit the noise signal. For example, the resource that is received by the second communication device and that is available for transmission of the noise signal is shown in Table 26, and the resource that is used by the second communication device to transmit the noise signal and that is determined by the second communication device based on Table 26 is shown in Table 27.

TABLE 27

| | Frequency | |
|---|---|---|
| Time | band | Beam position |
| t3 to t4 | BW 1 | Beam position 5 |
| t5 to t6 | BW 1 | Beam position 6 |
| t7 to t8 | BW 1 | Beam position 7 |
| t10 to t11 | BW 1 | Beam position 5 and |
| | | beam position 6 |

In a possible implementation, the resource used by the second communication device to transmit the noise signal may be some resources in Table 27. For example, the some resources include: the time: t5 to t6, the frequency band: BW 1, and the beam position: the beam position 6.

S1805: The second communication device sends, to the coordination center, the resource used by the second communication device to transmit the noise signal.

In a possible implementation, the second communication device sends, to the coordination center, the resource that is determined in step S1804 and that is used for transmission of the noise signal. For example, the second communication device sends content shown in Table 27 to the coordination center.

S1806: The coordination center sends, to the second communication device, a resource used by the adjacent communication device to transmit the noise signal.

In a possible implementation, the coordination center sends, to the second communication device, the resource used by the adjacent communication device to transmit the noise signal. For example, the resource used by the adjacent communication device to transmit the noise signal is shown in Table 28. The adjacent communication device may be the first communication device, the third communication device, or the like.

TABLE 28

| Communication | | Frequency | |
|---|---|---|---|
| device name | Time | band | Beam position |
| First | t1 to t2 | BW 1 | Beam position 2 and beam |
| communication | | | position 3 |
| device | | | |
| First | t1 to t2 | BW 2 | Beam position 1 and beam |
| communication | | | position 7 |
| device | | | |
| First | t2 to t3 | BW 1 | Beam position 6 and beam |
| communication | | | position 9 |
| device | | | |
| First | t3 to t4 | BW 1 | Beam position 3 and beam |
| communication | | | position 5 |
| device | | | |
| Third | t5 to t6 | BW 1 | Beam position 4 and beam |
| communication | | | position 6 |
| device | | | |
| Third | t5 to t6 | BW 2 | Beam position 9 |
| communication | | | |
| device | | | |
| Third | t7 to t8 | BW 1 | Beam position 8 and beam |
| communication | | | position 10 |
| device | | | |

The table includes resources used by the first communication device and the third communication device to transmit the noise signals. A resource that is in the resources and that is used by the second communication device to transmit the service beam is shown in Table 29.

TABLE 29

| Communication | | Frequency | |
|---|---|---|---|
| device name | Time | band | Beam position |
| First | t1 to t2 | BW 1 | Beam position 2 and |
| communication | | | beam position 3 |
| device | | | |
| First | t1 to t2 | BW 2 | Beam position 1 |
| communication | | | |
| device | | | |
| First | t3 to t4 | BW 1 | Beam position 3 |
| communication | | | |
| device | | | |
| Third | t5 to t6 | BW 1 | Beam position 4 |
| communication | | | |
| device | | | |

For example, the resource that is sent by the coordination center to the second communication device and that is used by the adjacent communication device to transmit the noise signal may be shown in Table 29.

For example, the resource that is sent by the coordination center to the second communication device and that is used by the adjacent communication device to transmit the noise signal may include some data in Table 29. For example, as shown in Table 30, the table does not include the label “communication device name”.

TABLE 30

| | Frequency | |
|---|---|---|
| Time | band | Beam position |
| t1 to t2 | BW 1 | Beam position 2 and |
| | | beam position 3 |
| t1 to t2 | BW 2 | Beam position 1 and |
| | | beam position 7 |
| t2 to t3 | BW 1 | Beam position 6 and |
| | | beam position 9 |
| t3 to t4 | BW 1 | Beam position 3 and |
| | | beam position 5 |
| t5 to t6 | BW 1 | Beam position 4 and |
| | | beam position 6 |
| t5 to t6 | BW 2 | Beam position 9 |
| t7 to t8 | BW 1 | Beam position 8 and |
| | | beam position 10 |

For example, in addition to including the labels in Table 30, the resource that is sent by the coordination center to the second communication device and that is used by the adjacent communication device to transmit the noise signal may further include a label such as a “resource level”, for example, as shown in Table 31.

TABLE 31

| Communication | | Frequency | | Resource |
|---|---|---|---|---|
| device name | Time | band | Beam position | level |
| First | t1 to t2 | BW 1 | Beam position 2 and | A |
| communication | | | beam position 3 | |
| device | | | | |
| First | t1 to t2 | BW 2 | Beam position 1 and | A |
| communication | | | beam position 7 | |
| device | | | | |
| First | t2 to t3 | BW 1 | Beam position 6 and | B |
| communication | | | beam position 9 | |
| device | | | | |
| First | t3 to t4 | BW 1 | Beam position 3 and | B |
| communication | | | beam position 5 | |
| device | | | | |
| Third | t5 to t6 | BW 1 | Beam position 4 and | B |
| communication | | | beam position 6 | |
| device | | | | |
| Third | t5 to t6 | BW 2 | Beam position 9 | A |
| communication | | | | |
| device | | | | |
| Third | t7 to t8 | BW 1 | Beam position 8 and | B |
| communication | | | beam position 10 | |
| device | | | | |

In the table, the resource used by the adjacent communication device to transmit the noise signal is classified into three levels: A, B, and C. The level A indicates a high level, and represents that the resource is definitely used for transmission of the noise signal. The level B indicates a low level, and represents that the resource is allowed to be changed after negotiation and determining. For example, when the third communication device prepares to use a resource represented by the time: t5 to t6, the frequency band: the BW 1, the beam position: the beam position 4, and the resource level: B, to transmit the noise signal, because the second communication device also prepares to use the resource to send the service signal, the second communication device may negotiate with the third communication device to determine how to allocate the resource. A manner in which the second communication device negotiates with the third communication device may be a form in which the second communication device and the third communication device send data to each other; or may be a form in which data is forwarded via the coordination center between the second communication device and the third communication device; or may be a form in which the second communication device sends a requirement for using the resource to the coordination center, so that the coordination center re-allocates the resource. A specific implementation form is not limited in this application.

The adjacent communication device may be a communication device adjacent to the coverage area of the service signal sent by the communication device, may be a communication device that interferes with the noise signal sent by the communication device, or may be a communication device whose actual distance with the communication device is less than the specific threshold. For example, two communication devices whose straight-line distance is less than 200 km are referred to as adjacent communication devices.

S1807: The second communication device determines, based on the sent resource used for transmission of the noise signal or the received resource used by the adjacent communication device to transmit the noise signal, a resource used for transmission of a service beam.

In a possible implementation, the resource that is received by the second communication device and that is used for transmission of the noise signal is a resource determined to be used by the adjacent communication device to transmit noise. In this case, the second communication device adjusts, based on the resource, the resource used by the second communication device to transmit the service signal, to avoid interference of the noise. Alternatively, the second communication device may adjust, based on the sent resource used for transmission of the noise signal, the resource used by the second communication device to transmit the service signal, to avoid interference of the noise. For a specific adjustment manner, refer to the foregoing corresponding content. Details are not described herein again.

S1808: The second communication device places, based on the resource determined to be used for transmission of the noise signal, the noise signal on a corresponding beam position, time, and frequency band.

In a possible implementation, for a method for placing, by the second communication device, the noise signal on the corresponding beam position, time, and frequency band based on the resource for the noise signal, refer to the foregoing corresponding content. Details are not described herein again.

According to the foregoing method, resources between adjacent communication devices can be better coordinated, resources of the communication devices are fully used, and efficiency of the communication devices is improved.

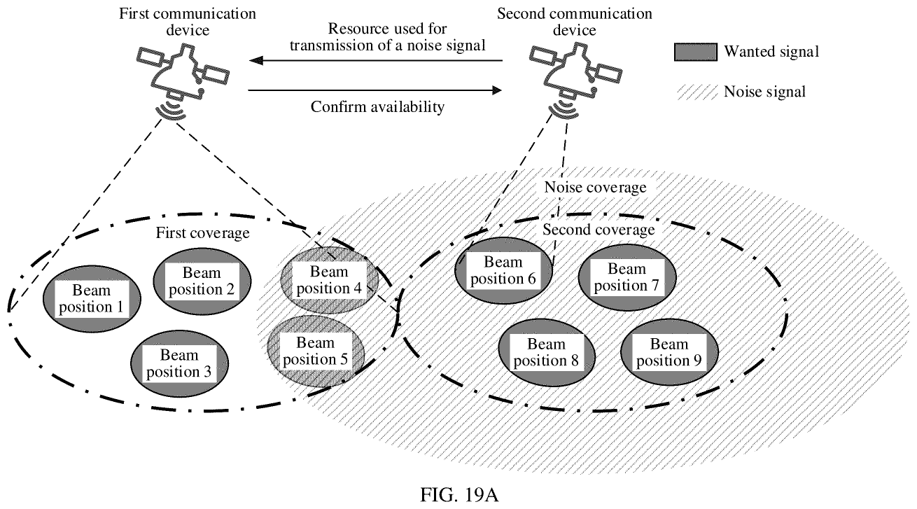

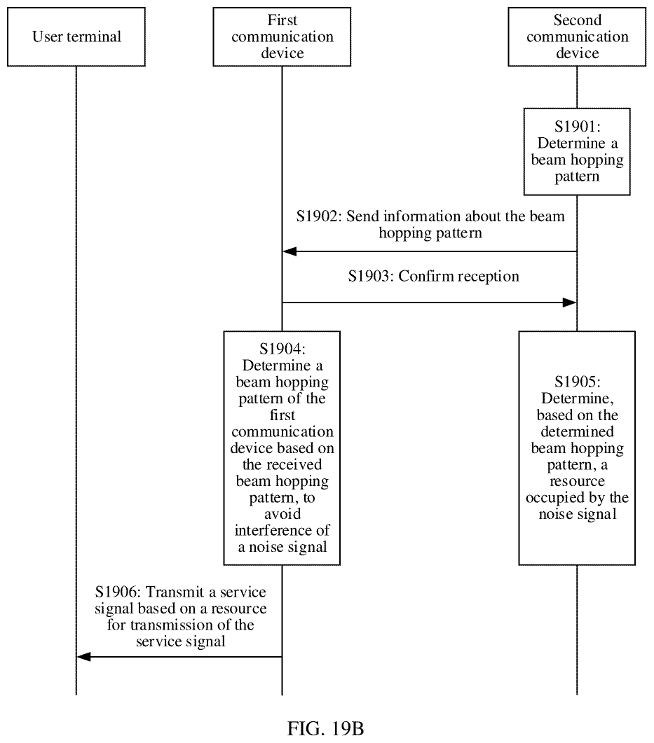

In still another possible implementation, for example, FIG. 19A is a diagram of an inter-communication device application-negotiation solution provided. A difference between FIG. 19A and FIG. 15 lies in that information sent by a first communication device to a second communication device in the figure is a beam hopping pattern of the first communication device. The beam hopping pattern is a set including a plurality of service signals. For other descriptions in FIG. 19A, refer to the content in FIG. 15. Details are not described herein again.

FIG. 19B provides a beam processing method. In the method, content shown in FIG. 19A can be presented more clearly. A communication device performs beam hopping pattern exchange with an adjacent communication device, and the communication device determines, based on a beam hopping pattern obtained through exchange, a beam hopping pattern of the communication device and a resource for a noise signal of the communication device. In this way, a service signal is avoided from interference of another noise signal, which can reduce an amount of interaction signaling and reduce signaling overheads. In this application, the method is described by using two communication devices as an example. A first communication device and a second communication device are two adjacent communication devices. For descriptions of the adjacent communication devices, refer to the foregoing corresponding content. Details are not described herein again. The method includes but is not limited to the following steps.

S1901: The second communication device determines a beam hopping pattern.

The beam hopping pattern includes different content. The following describes components of the beam hopping pattern by using an example.

In a possible implementation, the beam hopping pattern is a beam hopping pattern including a service signal with a high peak-to-average power ratio suppression requirement.

In a possible implementation, the beam hopping pattern includes a beam hopping pattern including a service signal with a high peak-to-average power ratio suppression requirement and a service signal with no high peak-to-average power ratio suppression requirement.

In a possible implementation, the beam hopping pattern is a set of to-be-sent service signals of the second communication device within a period of time. The period of time may be any one of the following: one minute, one hour, one day, and the like. A specific length of the period of time is not limited in this application.

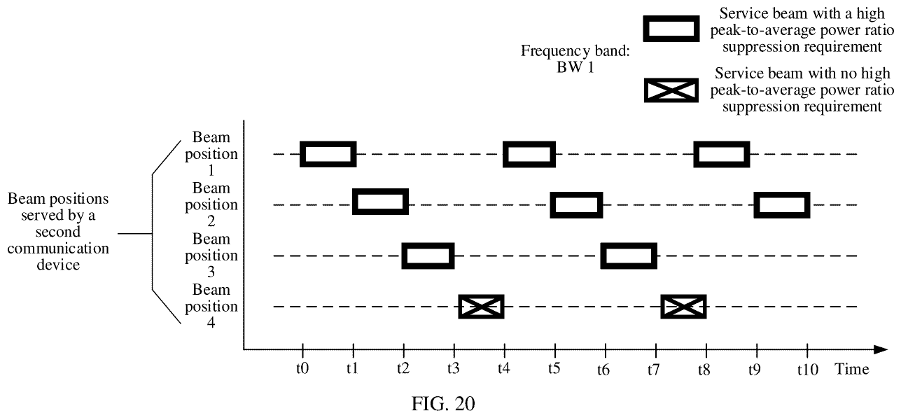

For example, the beam hopping pattern may be shown in FIG. 20. FIG. 20 includes a service signal with a high peak-to-average power ratio suppression requirement and a service signal with no high peak-to-average power ratio suppression requirement, and a frequency band is a BW 1 (for example, the frequency band BW 1 is 29.6 GHz to 29.7 GHZ).

S1902: The second communication device sends information about the beam hopping pattern to the first communication device.

In a possible implementation, the second communication device may send the determined beam hopping pattern to the first communication device via an Xn interface. For example, the beam hopping pattern of the second communication device may be shown in Table 32.

TABLE 32

| | Frequency | | PAPR suppression |
|---|---|---|---|
| Time | band | Beam position | requirement |
| to to t1, t4 to t5, | BW 1 | Beam position 1 | Yes |
| and t8 to t9 | | | |
| t1 to t2, t5 to t6, | BW 1 | Beam position 2 | Yes |
| and t9 to t10 | | | |
| t2 to t3, and t6 to t7 | BW 1 | Beam position 3 | Yes |
| t3 to t4, and t7 to t8 | BW 1 | Beam position 4 | None |

S1903: The first communication device sends, to the second communication device, information for confirming reception.

In a possible implementation, after receiving the beam hopping pattern of the second communication device, the first communication device sends the information to the second communication device, to confirm that the beam hopping pattern from the second communication device has been received.

S1904: The first communication device determines a beam hopping pattern of the first communication device based on the received beam hopping pattern, to avoid interference of a noise signal.

After determining the beam hopping pattern, the second communication device further needs to determine, based on the beam hopping pattern of the second communication device, a resource occupied by a noise signal of the second communication device.

In a possible implementation, the second communication device determines, based on the determined beam hopping pattern, the resource occupied by the noise signal. For example, a resource occupied by a service signal of the second communication device is: time: t0 to t1, a frequency band: a BW 1, and a beam position: a beam position 1. The noise signal accompanying the service signal may be sent to at least four of the following beam positions: the beam position 1, a beam position 2, a beam position 3, a beam position 4, a beam position 5, a beam position 6, a beam position 7, or a beam position 8. The noise signal may be sent to four beams farthest from the service signal based on a principle of a farthest distance. Therefore, the resource occupied by the noise signal may be selected as: the time: t0 to t1, the frequency band: the BW 1, and the beam position: the beam position 5, the beam position 6, the beam position 7, and the beam position 8 (it is assumed that the four beam positions are four beam positions farthest from the beam position 1). For example, there is also a principle of a shortest distance, and the noise signal is sent to several beam positions closest to the service signal. A specific rule based on which the resource occupied by the noise signal is determined is not limited in this application.

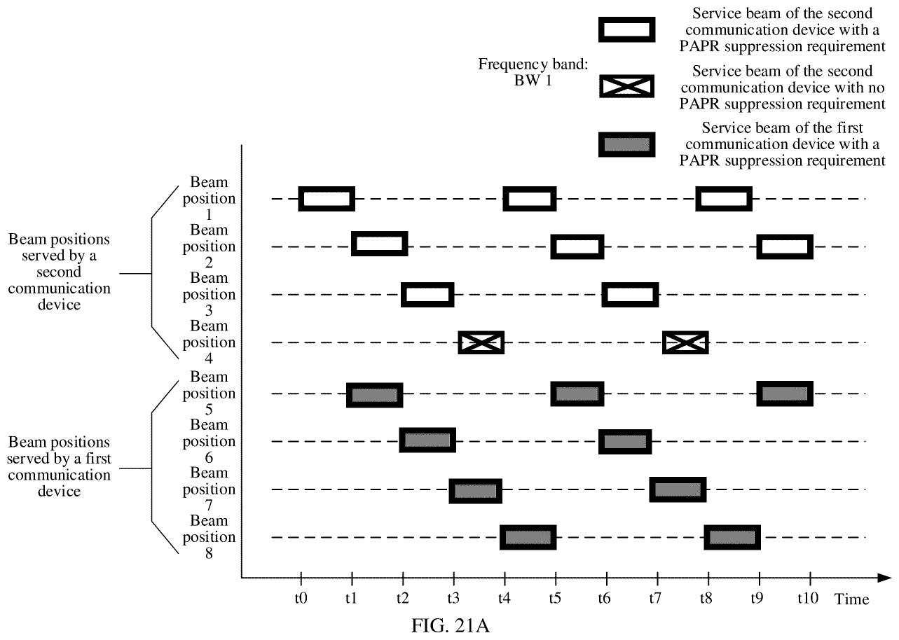

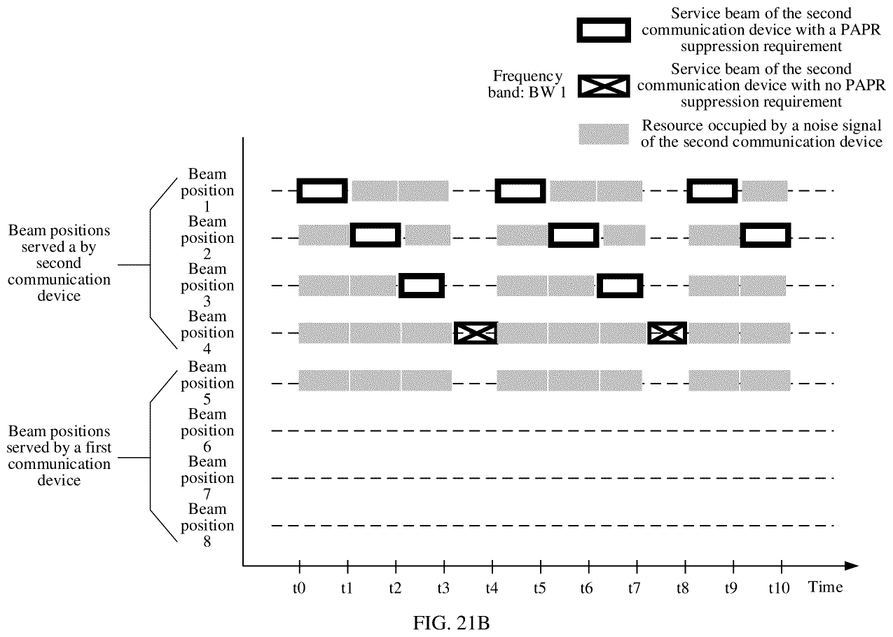

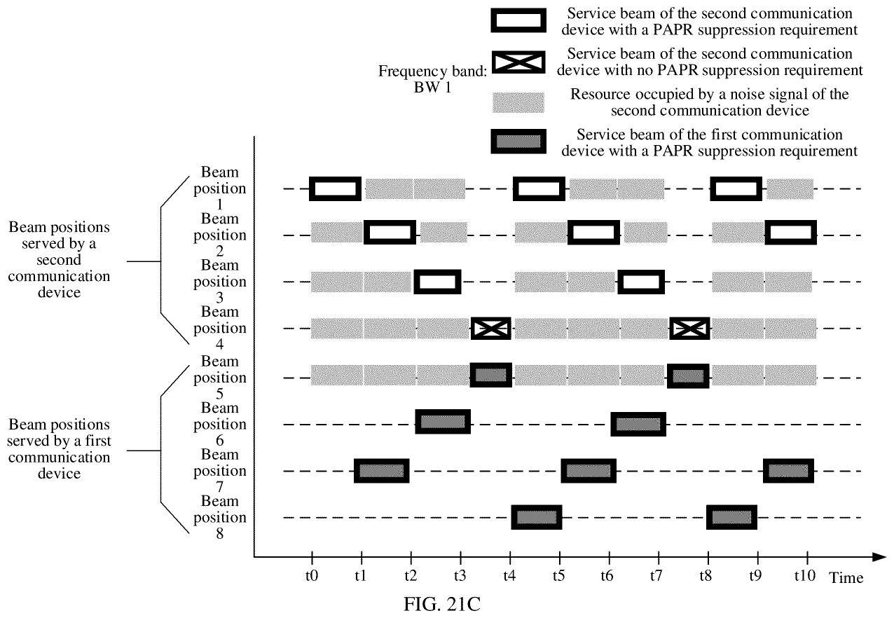

The first communication device adjusts the beam hopping pattern of the first communication device based on the resource that is determined by the second communication device and that is occupied by the noise signal. For example, the beam hopping patterns of the first communication device and the second communication device are shown in FIG. 21A. For example, the resource that is determined by the first communication device and the second communication device based on the beam hopping pattern of the second communication device and that is occupied by the noise signal is shown in FIG. 21B. Both the first communication device and the second communication device transmit noise signals by using the resource. For example, an adjusted beam hopping pattern of the first communication device is shown in FIG. 21C. The beam hopping pattern of the first communication device may be represented by using a table, as shown in Table 33.

TABLE 33

| | Frequency | |
|---|---|---|
| Time | band | Beam position |
| t1 to t2, t5 to t6, | BW 1 | Beam position 5 |
| and t9 to t10 | | |
| t2 to t3, and t6 to t7 | BW 1 | Beam position 6 |
| t3 to t4, and t7 to t8 | BW 1 | Beam position 7 |
| t4 to t5, and t8 to t9 | BW 1 | Beam position 8 |

With reference to Table 33 and FIG. 21B, it can be learned that the resource is: the time: t1 to t2, the frequency band: the BW 1, and the beam position: the beam position 5, and is covered by the noise signal generated by the first communication device. The noise signal causes interference to a service signal of the first communication device in Table 33. Therefore, the beam hopping pattern of the first communication device needs to be adjusted. Similarly, in time t5 to t6, the frequency band BW 1, and the beam position 5, the noise signal generated by the second communication device causes interference to the service signal of the first communication device in Table 33. An adjusted beam hopping pattern of the first communication device may be represented by using a table, as shown in Table 34.

TABLE 34

| | Frequency | |
|---|---|---|
| Time | band | Beam position |
| t3 to t4, and t7 to t8 | BW 1 | Beam position 5 |
| t2 to t3, and t6 to t7 | BW 1 | Beam position 6 |
| t1 to t2, t5 to t6, | BW 1 | Beam position 7 |
| and t9 to t10 | | |
| t4 to t5, and t8 to t9 | BW 1 | Beam position 8 |

As shown in FIG. 21C, the adjusted beam hopping pattern of the first communication device may avoid interference from the noise signal of the second communication device.

S1905: The second communication device determines, based on the determined beam hopping pattern, the resource occupied by the noise signal.

In a possible implementation, the second communication device determines, based on the determined beam hopping pattern, the resource occupied by the noise signal accompanying the beam hopping pattern of the second communication device. For a specific implementation, refer to the foregoing corresponding content. Details are not described herein again.

S1906: The first communication device transmits the service signal to a terminal device based on the resource for transmission of the service signal.

For example, the first communication device sends the service signal to the terminal device based on the resource for transmission of the service signal and with reference to the method shown in FIG. 9. The service signal is less interfered by the noise signal of the second communication device.

It should be noted that the beam processing method shown in FIG. 19B is not limited to the foregoing steps, and may be a combination of the foregoing steps in a specific implementation process.

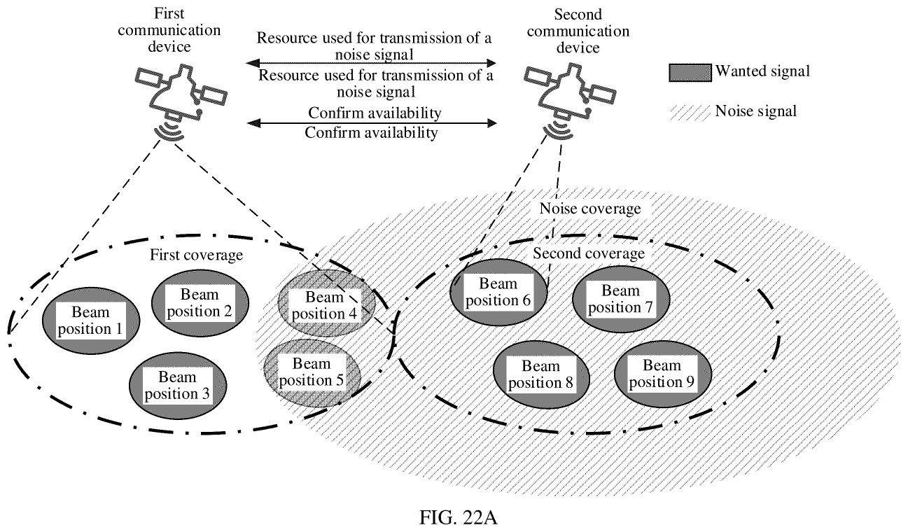

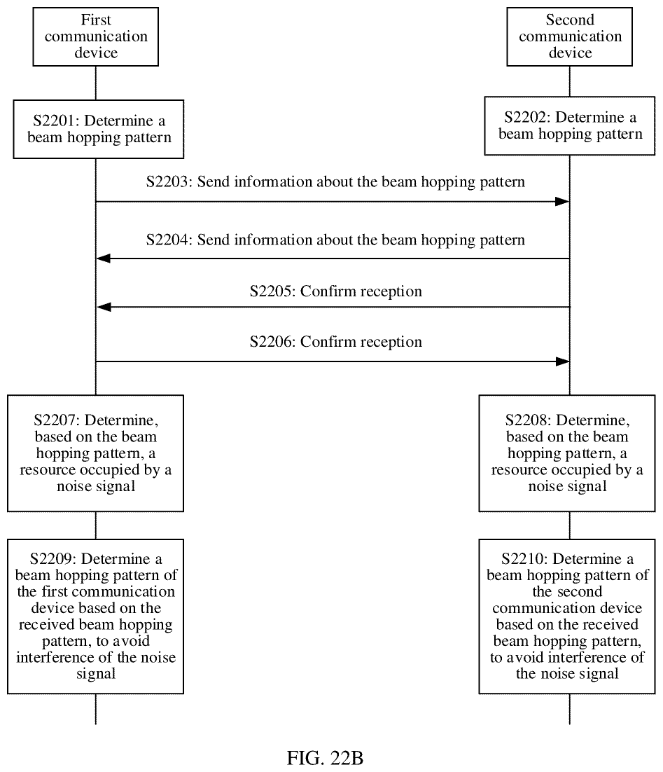

In still another possible implementation, for example, FIG. 22A is a diagram of an inter-communication device application-negotiation solution provided. A difference between FIG. 22A and FIG. 19A lies in that in FIG. 22A, a second communication device sends a beam hopping pattern of the second communication device to a first communication device, and after receiving the beam hopping pattern sent by the second communication device, the first communication device returns confirmation information to the second communication device. The beam hopping pattern is a set including a plurality of service signals. For other descriptions in FIG. 22A, refer to the content in FIG. 19A. Details are not described herein again.

FIG. 22B provides a beam processing method. In the method, content shown in FIG. 22A can be presented more clearly. As shown in FIG. 22B, two beam hopping patterns for communication are adjusted, so that satellite resources can be used to a maximum extent. The method includes but is not limited to the following steps.

S2201: A first communication device determines a beam hopping pattern. For a specific implementation, refer to the foregoing corresponding content. Details are not described herein again.

S2202: A second communication device determines a beam hopping pattern. For a specific implementation, refer to the foregoing corresponding content. Details are not described herein again.

S2203: The first communication device sends information about the beam hopping pattern to the second communication device. For a specific implementation, refer to the foregoing corresponding content. Details are not described herein again.

S2204: The second communication device sends information about the beam hopping pattern to the first communication device. For a specific implementation, refer to the foregoing corresponding content. Details are not described herein again.

S2205: The second communication device sends, to the first communication device, information for confirming reception. For a specific implementation, refer to the foregoing corresponding content. Details are not described herein again.

S2206: The first communication device sends, to the second communication device, information for confirming reception. For a specific implementation, refer to the foregoing corresponding content. Details are not described herein again.

S2207: The first communication device determines, based on the beam hopping pattern, a resource occupied by a noise signal.

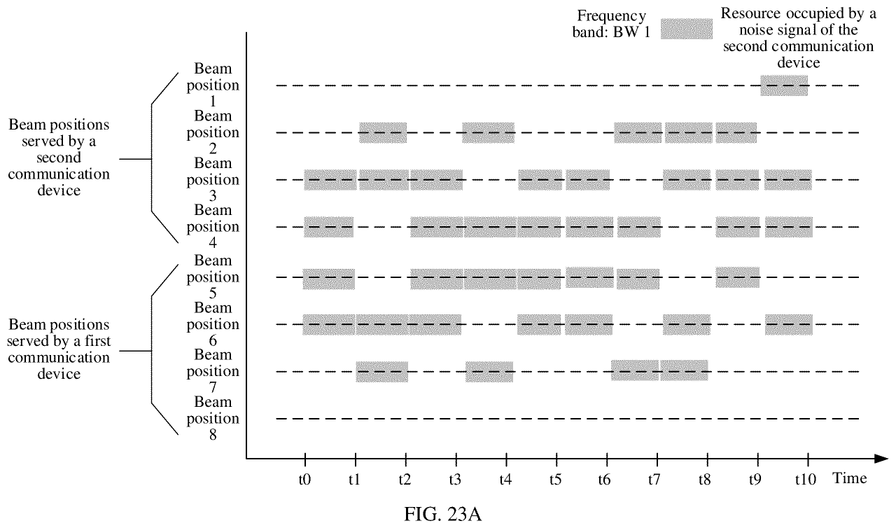

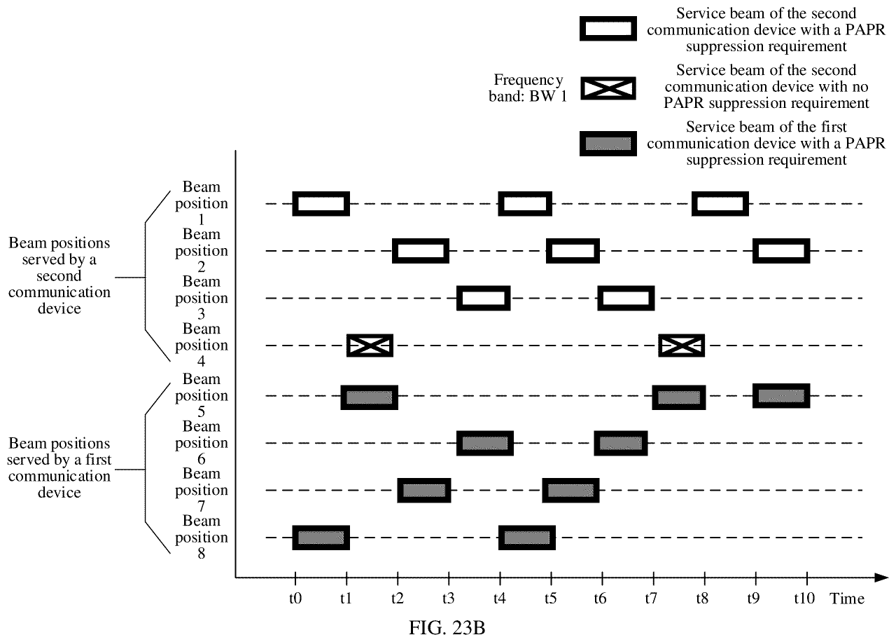

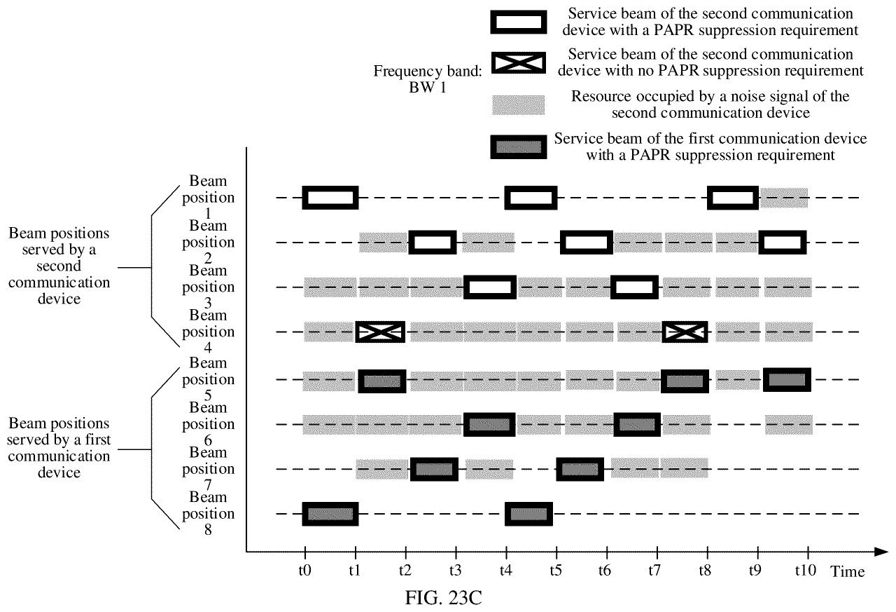

In a possible implementation, the beam hopping pattern of the second communication device and the beam hopping pattern of the first communication device are, for example, shown in FIG. 21A. The first communication device determines, based on the beam hopping pattern of the second communication device and the beam hopping pattern of the first communication device, the resource occupied by the noise signal, for example, as shown in FIG. 23A.

In a possible implementation, the resource occupied by the noise signal shown in FIG. 23A is a resource for the noise signals generated by the second communication device and the first communication device. In this manner, an impact range of noise can be reduced as much as possible, and resources available for the communication device can be saved.

S2208: The second communication device determines, based on the beam hopping pattern, a resource occupied by a noise signal.

In a possible implementation, the beam hopping pattern of the second communication device and the beam hopping pattern of the first communication device are, for example, shown in FIG. 21A. The second communication device determines, based on the beam hopping pattern of the second communication device and the beam hopping pattern of the second communication device, the resource occupied by the noise signal, for example, as shown in FIG. 23A.

In a possible implementation, the resource occupied by the noise signal shown in FIG. 23A is a resource used by the noise signals generated by the first communication device and the second communication device. In this manner, an impact range of noise can be reduced as much as possible, and resources available for the communication device can be saved.

S2209: The first communication device determines a beam hopping pattern of the first communication device based on the received beam hopping pattern, to avoid interference of the noise signal.

In a possible implementation, the first communication device adjusts the beam hopping pattern of the first communication device based on the received beam hopping pattern and the resource occupied by the noise signal, to avoid the interference of the noise signal. For example, an adjusted beam hopping pattern of the first communication device is shown in FIG. 23B. For a specific adjustment manner, refer to the foregoing corresponding content. Details are not described herein again.

S2210: The second communication device determines a beam hopping pattern of the second communication device based on the received beam hopping pattern, to avoid interference of the noise signal.

In a possible implementation, the second communication device adjusts the beam hopping pattern of the second communication device based on the received beam hopping pattern and the resource occupied by the noise signal, to avoid the interference of the noise signal. For example, an adjusted beam hopping pattern of the first communication device is shown in FIG. 23B. For a specific adjustment manner, refer to the foregoing corresponding content. Details are not described herein again.

The beam hopping pattern of the first communication device, the beam hopping pattern of the second communication device, and the resource occupied by the noise signal are shown in FIG. 23C. In the figure, the resource occupied by the noise signal is shared by the first communication device and the second communication device. In this solution, resources available for the first communication device and the second communication device to send service beams can be saved, and resources of the first communication device and the second communication device can be better used.

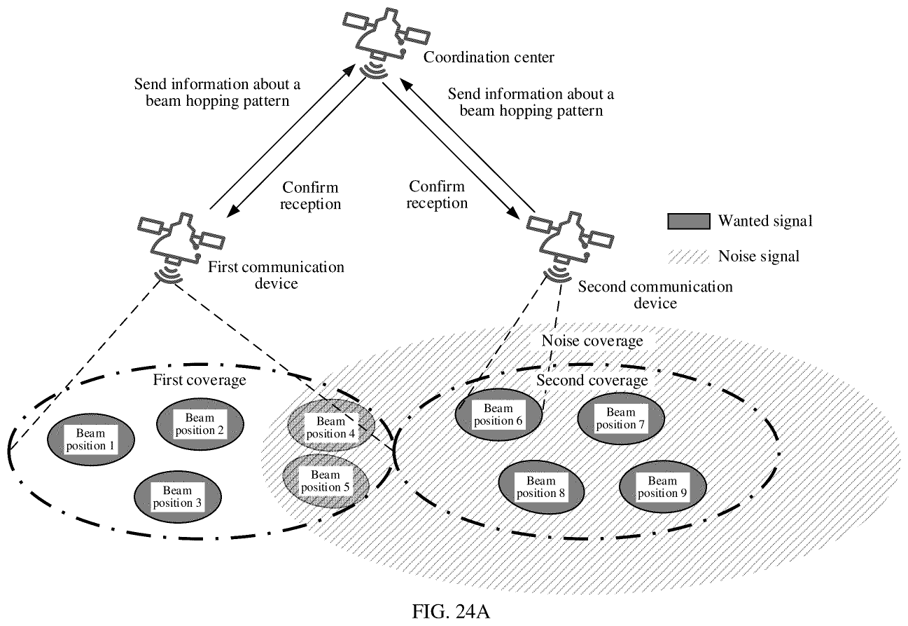

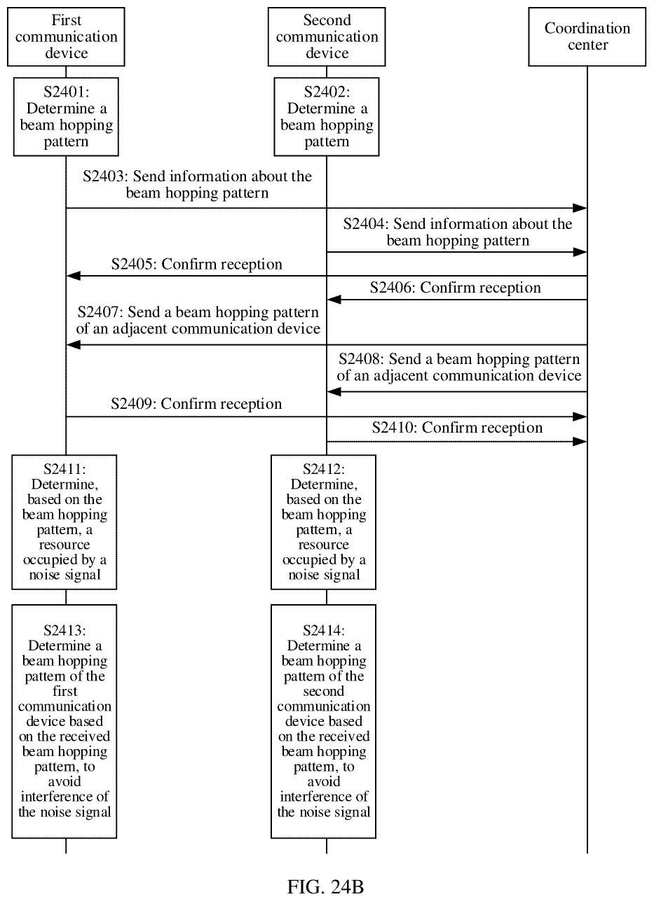

In still another possible implementation, for example, FIG. 24A is a diagram of an inter-communication device centralized application-negotiation solution provided. A difference between FIG. 24A and FIG. 18A lies in that information sent by a communication device to a coordination center in FIG. 24A is a beam hopping pattern of the communication device. The beam hopping pattern is a set including a plurality of service signals. For other descriptions in FIG. 22A, refer to the content in FIG. 18A. Details are not described herein again.

In the methods shown in FIG. 19A and FIG. 22A, the communication device needs to interact with each adjacent satellite to exchange data. A quantity of interactions of each communication device depends on a quantity of adjacent communication devices. In a possible implementation, as shown in FIG. 24A, one coordination center obtains beam hopping patterns of a plurality of communication devices, so that the communication device can obtain beam hopping patterns of a plurality of adjacent satellites of the communication device through only one interaction. The method includes but is not limited to the following steps.

S2401: A first communication device determines a beam hopping pattern. For a specific implementation, refer to the foregoing corresponding content. Details are not described herein again.

S2402: A second communication device determines a beam hopping pattern. For a specific implementation, refer to the foregoing corresponding content. Details are not described herein again.

S2403: The first communication device sends information about the beam hopping pattern to the coordination center. For a specific implementation, refer to the foregoing corresponding content. Details are not described herein again.

S2404: The second communication device sends information about the beam hopping pattern to the coordination center. For a specific implementation, refer to the foregoing corresponding content. Details are not described herein again.

S2405: The coordination center sends received confirmation information to the first communication device. For a specific implementation, refer to the foregoing corresponding content. Details are not described herein again.

S2406: The coordination center sends received confirmation information to the second communication device. For a specific implementation, refer to the foregoing corresponding content. Details are not described herein again.

S2407: The coordination center sends a beam hopping pattern of an adjacent communication device to the first communication device.

In a possible implementation, the coordination center selects, from obtained data, the beam hopping pattern of the communication device adjacent to the first communication device, and sends the information to the first communication device. For the beam hopping pattern, refer to the foregoing corresponding content. Details are not described herein again. For communication between the coordination center and the first communication device, refer to the foregoing corresponding content. Details are not described herein again.

S2408: The coordination center sends a beam hopping pattern of an adjacent communication device to the second communication device.

In a possible implementation, the coordination center selects, from obtained data, the beam hopping pattern of the communication device adjacent to the second communication device, and sends the information to the second communication device. For the beam hopping pattern, refer to the foregoing corresponding content. Details are not described herein again. For communication between the coordination center and the second communication device, refer to the foregoing corresponding content. Details are not described herein again.

S2409: The first communication device sends, to the coordination center, information confirming reception. For a specific implementation, refer to the foregoing corresponding content. Details are not described herein again.

S2410: The first communication device sends, to the coordination center, information confirming reception. For a specific implementation, refer to the foregoing corresponding content. Details are not described herein again.

S2411: The first communication device determines, based on the beam hopping pattern, a resource occupied by a noise signal.

In a possible implementation, the beam hopping pattern includes the beam hopping pattern of the first communication device and the beam hopping pattern of the communication device adjacent to the first communication device. For determining, based on the beam hopping pattern, the resource occupied by the noise signal, refer to the foregoing corresponding content. Details are not described herein again.

S2412: The second communication device determines, based on the beam hopping pattern, a resource occupied by a noise signal.

In a possible implementation, the beam hopping pattern includes the beam hopping pattern of the second communication device and the beam hopping pattern of the communication device adjacent to the second communication device. For determining, based on the beam hopping pattern, the resource occupied by the noise signal, refer to the foregoing corresponding content. Details are not described herein again.

S2413: The first communication device determines a beam hopping pattern of the first communication device based on the received beam hopping pattern, to avoid interference of the noise signal.

In a possible implementation, the first communication device adjusts the beam hopping pattern of the first communication device based on the received beam hopping pattern and the resource occupied by the noise signal, to avoid the interference of the noise signal. For a specific adjustment manner, refer to the foregoing corresponding content. Details are not described herein again.

S2414: The second communication device determines a beam hopping pattern of the second communication device based on the received beam hopping pattern, to avoid interference of the noise signal.

In a possible implementation, the second communication device adjusts the beam hopping pattern of the second communication device based on the received beam hopping pattern and the resource occupied by the noise signal, to avoid the interference of the noise signal. For a specific adjustment manner, refer to the foregoing corresponding content. Details are not described herein again.

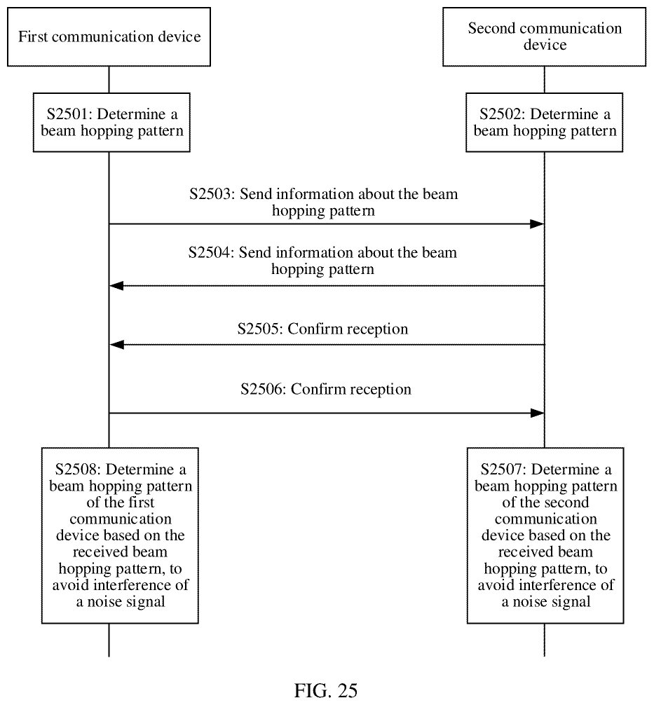

In still another possible implementation, a priority may be set for a service signal based on an emergency degree of a task and a service type, and a resource occupied by the service signal is preferentially selected for a service signal with a high priority, so that the service signal better avoids interference from a noise signal. In this way, resources of a communication device are better used, and quality of service of the communication device is improved. For example, as shown in FIG. 25, the method includes but is not limited to the following steps.

S2501: A first communication device determines a beam hopping pattern.

Each group of resources in the beam hopping pattern has a priority. The following discusses the beam hopping pattern in different cases based on content of the beam hopping pattern.

In a first case, how to set the priority in the beam hopping pattern. For example, a priority of each service signal is determined by obtaining a service of each service signal, and an emergency degree of the service, or an importance degree of the service. A higher priority indicates a higher importance degree of information transmitted or a task executed by the service signal. For example, the priority of the service signal is classified into three levels: A, B, and C, where A is the highest level, and C is the lowest level. A specific representation manner of the priority is not limited in this application.

In a second case, the beam hopping pattern is a beam hopping pattern including a service signal with a PAPR suppression requirement.

In the second case, the beam hopping pattern includes a beam hopping pattern including a service signal with a PAPR suppression requirement and a service signal with no PAPR suppression requirement.

For example, the beam hopping pattern determined by the first communication device is shown in Table 35.

TABLE 35

| | | | PAPR | |
|---|---|---|---|---|
| | Frequency | | suppression | |
| Time | band | Beam position | requirement | Priority |
| to to t1, | BW 1 | Beam position 1 | Yes | C |
| t4 to t5, | | | | |
| and t8 to t9 | | | | |
| t1 to t2, | BW 1 | Beam position 2 | Yes | B |
| t5 to t6, | | | | |
| and t9 to t10 | | | | |
| t2 to t3, | BW 1 | Beam position 3 | Yes | B |
| and t6 to t7 | | | | |
| t3 to t4, | BW 1 | Beam position 4 | None | C |
| and t7 to t8 | | | | |

S2502: A second communication device determines a beam hopping pattern.

Each group of resources in the beam hopping pattern has a priority. The following discusses the beam hopping pattern in different cases based on content of the beam hopping pattern.

In a first case, how to set the priority in the beam hopping pattern. For example, a priority of each service signal is determined by obtaining a service of each service signal, and an emergency degree of the service, or an importance degree of the service. A higher priority indicates a higher importance degree of information transmitted or a task executed by the service signal. For example, the priority of the service signal is classified into three levels: A, B, and C, where A is the highest level, and C is the lowest level. A specific representation manner of the priority is not limited in this application.

In a second case, the beam hopping pattern is a beam hopping pattern including a service signal with a PAPR suppression requirement.

In the second case, the beam hopping pattern includes a beam hopping pattern including a service signal with a PAPR suppression requirement and a service signal with no PAPR suppression requirement.

For example, the beam hopping pattern determined by the second communication device is shown in Table 36.

TABLE 36

| | | | PAPR | |
|---|---|---|---|---|
| | Frequency | | suppression | |
| Time | band | Beam position | requirement | Priority |
| t1 to t2, | BW 1 | Beam position 5 | Yes | A |
| t5 to t6, | | | | |
| and t9 to t10 | | | | |
| t2 to t3, | BW 1 | Beam position 6 | Yes | A |
| and t6 to t7 | | | | |
| t3 to t4, | BW 1 | Beam position 7 | Yes | A |
| and t7 to t8 | | | | |
| t4 to t5, | BW 1 | Beam position 8 | Yes | A |
| and t8 to t9 | | | | |

S2503: The first communication device sends information about the beam hopping pattern to the second communication device. For a specific implementation, refer to the foregoing corresponding content. Details are not described herein again.

S2504: The second communication device sends information about the beam hopping pattern to the first communication device. For a specific implementation, refer to the foregoing corresponding content. Details are not described herein again.

S2505: The second communication device sends, to the first communication device, information for confirming reception. For a specific implementation, refer to the foregoing corresponding content. Details are not described herein again.

S2506: The first communication device sends, to the second communication device, information for confirming reception. For a specific implementation, refer to the foregoing corresponding content. Details are not described herein again.

S2507: The second communication device determines a beam hopping pattern of the second communication device based on the received beam hopping pattern, to avoid interference of a noise signal.

It can be learned from Table 36 that priorities in the beam hopping pattern of the second communication device are the level A, indicating that the beam hopping pattern is important and cannot be randomly changed.

In a possible implementation, a resource occupied by a service signal with a lower priority is adjusted as much as possible. For example, if a noise signal generated from a first service signal whose level is C affects a second service signal whose level is A or B, a resource occupied by the first service signal needs to be adjusted, so that the noise signal generated by the first service signal avoids a resource occupied by the second service signal.

In another possible implementation, when noise signals generated from two service signals of a same level cause interference to another service signal, an adjustment manner is consistent with the foregoing corresponding content. Details are not described herein again.

As shown in Table 36, priorities of service signals in the beam hopping pattern of the second communication device are all A, and priorities of service signals of a satellite adjacent to the second communication device are all lower than A. Therefore, the beam hopping pattern of the second communication device does not need to be adjusted. The beam hopping pattern of the first communication device needs to be adjusted, to reduce interference of the noise signal generated by the first communication device to the service signal of the second communication device. For example, an adjusted beam hopping pattern of the first communication device is shown in Table 37.

TABLE 37

| | | | PAPR | |
|---|---|---|---|---|
| | Frequency | | suppression | |
| Time | band | Beam position | requirement | Priority |
| t3 to t4, | BW 1 | Beam position 1 | Yes | C |
| t7 to t8, | | | | |
| and t8 to t9 | | | | |
| t1 to t2, | BW 1 | Beam position 2 | Yes | B |
| t5 to t6, | | | | |
| and t9 to t10 | | | | |
| t2 to t3, | BW 1 | Beam position 3 | Yes | B |
| and t6 to t7 | | | | |
| to to t1, | BW 1 | Beam position 4 | None | C |
| and t4 to t5 | | | | |

S2508: The first communication device determines a beam hopping pattern of the first communication device based on the received beam hopping pattern, to avoid interference of the noise signal.

For a method for determining the beam hopping pattern of the first communication device, refer to the corresponding content in step S2507. Details are not described herein again.

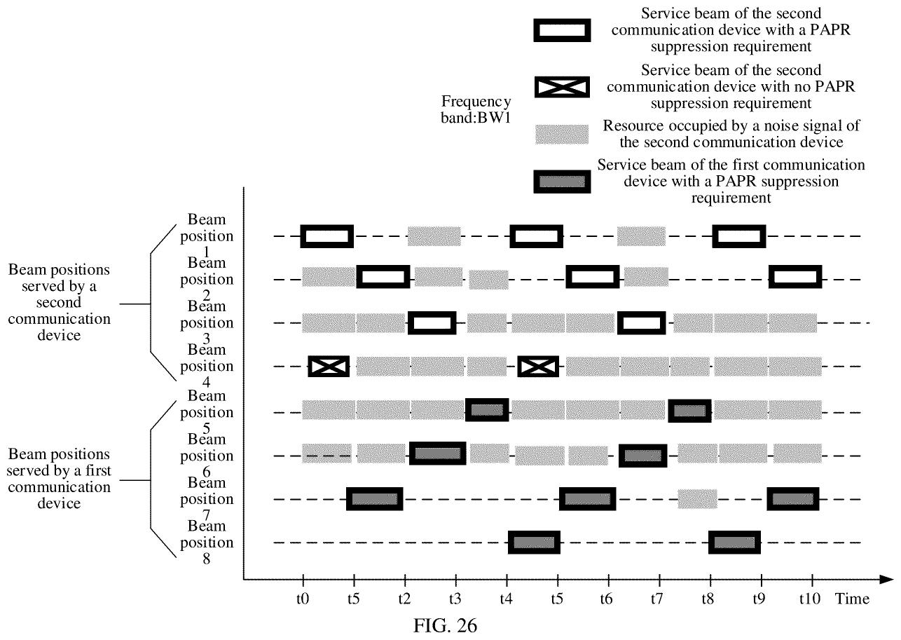

A determined service signal of the first communication device, a determined service signal of the second communication device, and a determined service signal of the noise signal are shown in FIG. 26.

The foregoing method for setting the priority for the service signal may also be applied to the methods described in FIG. 19B, FIG. 22B, and FIG. 24B.

In a possible implementation, a priority is set for a service signal, and a noise signal accompanying the service signal does not have a priority. When noise accompanying the first service signal causes interference to the second service signal, a beam position resource occupied by the noise is first adjusted. When the noise signal still causes interference to the second service signal after the adjustment, priorities of the first service signal and the second service signal are determined, and a resource occupied by a service signal with a lower priority is adjusted.

In another possible implementation, a priority is set for a service signal, and a noise signal accompanying the service signal has a priority. When noise accompanying the first service signal causes interference to the second service signal, priorities of the noise and the second service signal are determined, and a party with a lower priority is adjusted. When the priority of the noise signal is low, and the noise signal still causes interference to the second service signal after the adjustment, a resource occupied by the first service signal needs to be adjusted.

In still another possible implementation, a priority is set for a noise signal, so that a service signal corresponding to the noise signal has a same priority. In a specific implementation process, for adjustment of a resource occupied by the service signal or the noise signal, refer to the foregoing corresponding content. Details are not described herein again.

The foregoing method for setting the priority for the noise signal may be applied to the methods shown in FIG. 5, FIG. 11B, FIG. 16, FIG. 17B, FIG. 18B, FIG. 19B, FIG. 22B, and FIG. 24B.

A priority is set for a resource used for transmission of a noise signal and/or a resource used for transmission of a service signal, so that a resource of a communication apparatus can be more effectively used, quality of service of the communication apparatus is improved, and interference of the noise signal to a service signal corresponding to an urgent task or an important task is reduced.

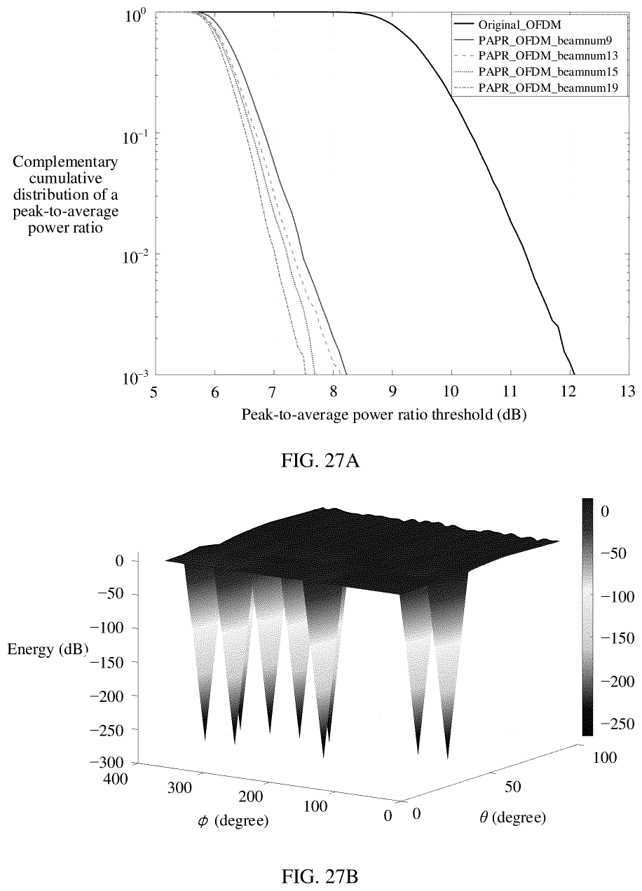

Next, for example, FIG. 27A is a diagram of simulation of PAPR suppression effects on an OFDM signal in the method according to this application. A simulation result shows that this solution can effectively suppress a high peak-to-average power ratio of the OFDM signal.

For example, FIG. 27B is a diagram of a result of filtering PAPR suppression noise according to this application. It can be learned from FIG. 27B that in a coverage area of a beam signal, power of a noise signal is effectively suppressed compared with that in FIG. 3D.

FIG. 27A and FIG. 27B are merely examples of effects that can be achieved in this application, and do not constitute a limitation on this application.

In a possible implementation, in the foregoing embodiments and the possible embodiments thereof, signaling may be exchanged between the first communication device and the second communication device, between the first communication device (or the second communication device) and a coordination center, and between the first communication device (or the second communication device) and the terminal device. For example, the exchanged signaling may include, for example, the resource for which the second communication device applies to the first communication device and that is available for transmission of the noise signal in FIG. 11B, the resource that is sent by the second communication device to the coordination center and that is used for transmission of the noise signal in FIG. 17B, or the information about the beam hopping pattern that is sent by the second communication device to the first communication device and the beam hopping pattern or an updated beam hopping pattern that is sent by the first communication device (or the second communication device) to the terminal device in FIG. 19B. This is not limited in embodiments of this application.

The foregoing exchanged signaling may alternatively be sent by the communication device or the coordination center to the terminal device in a broadcast or multicast manner, for example, may be sent to the terminal device by using at least one of a system information block (SIB), other system information (OSI), a master system information block (MIB), or other broadcast information. Sending the foregoing information to the terminal device in the broadcast or multicast manner can avoid scheduling different resources for different terminal devices to send the foregoing signaling, reduce signaling overheads for resource scheduling, and reduce system scheduling complexity.

In addition, if the exchanged signaling is sent in a radio resource control (RRC) connection establishment phase and a subsequent communication process, the communication device or the coordination center may carry the foregoing signaling by using at least one of RRC signaling (for example, an RRC setup (RRCsetup) message, RRC reconfiguration signaling (RRCReconfiguration), or RRC resume signaling (RRCResume)), downlink control information (DCI), group DCI, and a media access control (MAC) control element (CE). In addition, an instruction may be further sent to the terminal device by using any one or more of the following: for example, indicating the foregoing signaling/parameter value to the terminal device in a table manner, transmitting along with data, or sending to the terminal device in a unicast or multicast mode on a separately allocated physical downlink shared channel (PDSCH) bearer. An advantage of sending the foregoing signaling to the terminal device separately or in a group is that a parameter value of each terminal device/each group of terminal devices can be flexibly controlled, and different beam hopping patterns are configured for the terminal device based on different link budget requirements of a location, an area, or the like of the terminal device, to optimize system transmit power efficiency and optimize communication performance of the terminal device/system communication performance. For example, different PAPR suppression and different beam hopping patterns may be configured and used based on a geographical location of the terminal device, a throughput requirement, a required link budget, and a signal transmit power requirement, to optimize PAPR suppression and communication performance of each terminal device/each group of terminal devices, avoid a waste of spectrum resources and transmit efficiency, and improve overall communication performance of the terminal device and the system.

All the foregoing embodiments are described by using a satellite as a main body. In addition to being applied to a satellite, the foregoing method may also be applied to a communication device with a signal receiving and sending capability, such as a terrestrial base station or an air base station. A specific communication device to which the method is applied is not limited in this application.

The foregoing mainly describes the signal transmission method provided in embodiments of this application. It may be understood that, to implement the foregoing corresponding functions, each control unit or device includes a corresponding hardware structure and/or a corresponding software module for performing each function. In combination with example units and steps described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the device may be divided into functional modules based on the foregoing method examples. For example, each functional module corresponding to each function may be obtained through division, or two or more functions may be integrated into one processing module. The integrated module may be implemented in a form of hardware, or may be implemented in a form of a software functional module. It should be noted that in embodiments of this application, division into the modules is an example and is merely logical function division, and may be other division during actual implementation.

When each functional module is obtained through division based on each corresponding function, an embodiment of this application further provides an apparatus configured to implement any one of the foregoing methods. For example, an apparatus is provided, including a unit (or means) configured to implement each step in any one of the foregoing methods.

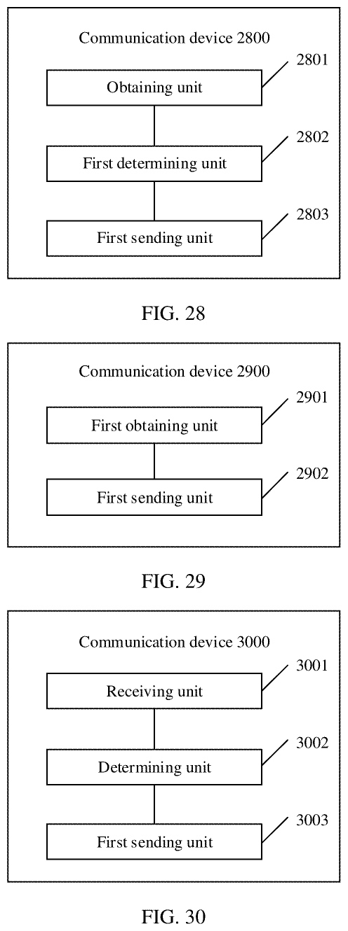

For example, FIG. 28 is a diagram of a structure of a communication device 2800 according to an embodiment of this application. The communication device 2800 shown in FIG. 28 may be the first communication device in any embodiment of the foregoing signal transmission method, or may be a module (for example, a chip) in the first communication device, or may be a logic module or software that can implement all or some functions of the first communication device. The communication device 2800 is configured to implement an operation implemented by the first communication device in any embodiment of the foregoing signal transmission method. The communication device 2800 may include an obtaining unit 2801, a first determining unit 2802, and a first sending unit 2803. Specifically,
the obtaining unit 2801 is configured to obtain a first resource used for transmission of a noise signal, where the first resource includes one or more of the following: first time for transmission of the noise signal, a first coverage area of the noise signal, or a first frequency band of a beam that carries the noise signal.

The first determining unit 2802 is configured to determine, based on the first resource, a second resource used for transmission of a service signal, where the second resource includes one or more of the following: second time for transmission of the service signal, a second coverage area of the service signal, or a second frequency band of a beam that carries the service signal, and the first resource is different from the second resource.

The first sending unit 2803 is configured to send a first service signal based on the second resource.

In a possible implementation, the first resource includes the first coverage area of the noise signal. The second resource includes the second coverage area of the service signal. The first coverage area overlaps the second coverage area. That the first resource is different from the second resource includes: The first time is different from the second time, or the first frequency band is different from the second frequency band.

In a possible implementation, the obtaining unit includes:
a first receiving unit, configured to receive first information, where the first information is used to request to obtain a resource available for transmission of the noise signal; and
a second determining unit, configured to determine the first resource based on the first information.

In a possible implementation, the first information includes one or more resources available for transmission of the noise signal, and the one or more resources available for transmission of the noise signal include the first resource.

In a possible implementation, the communication device further includes a second sending unit, configured to send second information to a second communication device, where the second information indicates the first resource.

In a possible implementation, the second resource includes the second time. The first sending unit 2803 is specifically configured to send the first service signal at the second time.

In a possible implementation, the second resource includes the second frequency band, and a frequency band of the beam that carries the first service signal is the second frequency band.

In a possible implementation, the second resource includes the second coverage area, and a coverage area of the first service signal is the second coverage area.

In a possible implementation, the communication device further includes: a second receiving unit, configured to receive a beam hopping pattern from one or more communication devices.

The obtaining unit further includes a third determining unit, configured to determine the first resource based on the beam hopping pattern.

In a possible implementation, the third determining unit is specifically configured to determine, based on the beam hopping pattern, a plurality of resources used for transmission of the noise signal, where the plurality of resources used for transmission of the noise signal include the first resource.

The first determining unit 2802 is specifically configured to adjust, based on the plurality of resources used for transmission of the noise signal, a beam hopping pattern corresponding to the first communication device, where an adjusted beam hopping pattern includes the second resource.

For specific operations and beneficial effects of the units in the communication device 2800 in FIG. 28, refer to the descriptions corresponding to the first communication device in any one signal transmission method in FIG. 5, FIG. 11B, or FIG. 16 and possible embodiments of the signal transmission method. Details are not described herein again.

For example, FIG. 29 is a diagram of a structure of a communication device 2900 according to an embodiment of this application. The communication device 2900 shown in FIG. 29 may be the second communication device in any embodiment of the foregoing signal transmission method, or may be a module (for example, a chip) in the second communication device, or may be a logic module or software that can implement all or some functions of the second communication device. The communication device 2900 is configured to implement an operation implemented by the second communication device in any embodiment of the signal transmission method. The communication device 2900 includes a first obtaining unit 2901 and a first sending unit 2902, where
the first obtaining unit 2901 is configured to obtain a first resource used for transmission of a noise signal, where the first resource includes one or more of the following: first time for transmission of the noise signal, a first coverage area of the noise signal, or a first frequency band of a beam that carries the noise signal.

The first sending unit 2902 is configured to send a first noise signal based on the first resource.

In a possible implementation, the first noise signal is carried in a first beam. The first beam further carries a first service signal. The first service signal is transmitted based on a second resource. A second coverage area indicated by the second resource does not overlap the first coverage area.

In a possible implementation, the communication device further includes:
a second sending unit, configured to send first information, where the first information is used to request to obtain a resource available for transmission of the noise signal.

In a possible implementation, the first information includes one or more resources available for transmission of the noise signal, and the one or more resources available for transmission of the noise signal include the first resource.

In a possible implementation, the communication device further includes: a third sending unit, configured to send second information, where the second information indicates that the first resource is used for transmission of the noise signal.

In a possible implementation, the first resource includes the first time. The first sending unit 2902 is specifically configured to send the first noise signal at the first time.

In a possible implementation, the first resource includes the first frequency band, and a frequency band of the beam that carries the first noise signal is the first frequency band.

In a possible implementation, the communication device further includes:
a second obtaining unit, configured to obtain a first signal;
a peak clipping and filtering unit, configured to perform peak clipping and filtering on the first signal to obtain a second signal;
a third obtaining unit, configured to obtain a peak clipping and filtering noise signal based on the first signal and the second signal; and
a beamforming unit, configured to perform beamforming on the peak clipping and filtering noise signal based on the first coverage area, to obtain the first noise signal.

For specific operations and beneficial effects of the units in the communication device 2900 in FIG. 29, refer to the descriptions corresponding to the second communication device in any one signal transmission method in FIG. 5, FIG. 11B, or FIG. 16 and possible embodiments of the signal transmission method. Details are not described herein again.

For example, FIG. 30 is a diagram of a structure of a communication device 3000 according to an embodiment of this application. The communication device 3000 shown in FIG. 30 may be the coordination center in the signal transmission method, or may be a module (for example, a chip) in the coordination center, or may be a logic module or software that can implement all or some functions of the coordination center. The communication device 3000 is configured to implement an operation implemented by the coordination center in the signal transmission method. The communication device 3000 includes a receiving unit 3001, a determining unit 3002, and a first sending unit 3003, where
the receiving unit 3001 is configured to receive first information from a first communication device, where the first information is used to request to obtain a resource available for transmission of a noise signal.

The determining unit 3002 is configured to determine a first target resource from a candidate resource based on the first information, where the first target resource includes one or more resources available for transmission of the noise signal, and the candidate resource is a plurality of resources that are from one or more communication devices and that are available for transmission of the noise signal.

The first sending unit 3003 is configured to send the first target resource to the first communication device.

In a possible implementation, the first information includes one or more resources expected by the first communication device to be used for transmission of the noise signal.

In a possible implementation, the communication device further includes: a second sending unit, configured to send a second target resource to a second communication device, where the second target resource includes one or more resources that are determined from the candidate resource and that are available for transmission of the noise signal.

In a possible implementation, the communication device further includes:
a third sending unit, configured to send second information, where the second information indicates that the first target resource is used for transmission of the noise signal.

For specific operations and beneficial effects of the units in the communication device 3000 in FIG. 30, refer to the corresponding descriptions in FIG. 17B and FIG. 18B and possible embodiments thereof. Details are not described herein again.

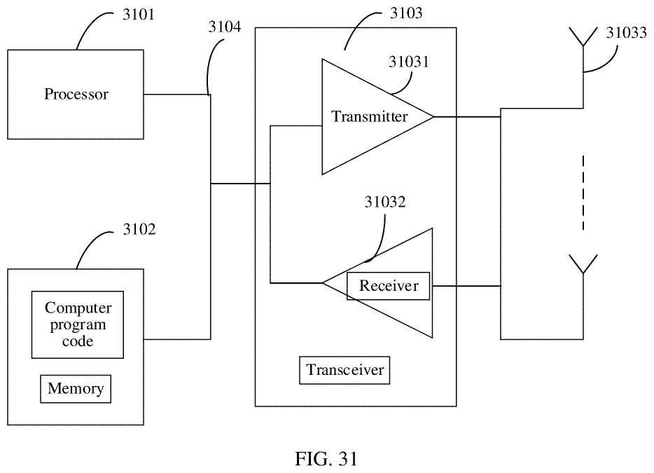

An embodiment of this application further provides an example of a diagram of a structure of another communication device. Refer to FIG. 31. As shown in FIG. 31, the communication device 3100 may include a processor 3101, a memory 3102, a transceiver 3103, and a bus 3104. The memory 3102 may exist independently, and may be connected to the processor 3101 through the bus 3104. The memory 3102 may alternatively be integrated with the processor 3101. The bus 3104 is configured to implement connections between these components. In a case, as shown in FIG. 31, the transceiver 3103 may include a transmitter 31031, a receiver 31032, and an antenna 31033. In another case, the transceiver 3103 may include a transmitter (that is, an output interface) and a receiver (that is, an input interface). The transmitter may include a transmitter machine and an antenna, and the receiver may include a receiver machine and an antenna.

When computer program instructions stored in the memory 3102 are executed by the processor 3101, the operations performed by the first communication device in the foregoing embodiment may be implemented. The transceiver 3103 is configured to cooperate with the processor 3101 to implement receiving and sending operations of the first communication device in the foregoing embodiment.

Alternatively, when computer program instructions stored in the memory 3102 are executed by the processor 3101, the operations performed by the second communication device in the foregoing embodiment may be implemented. The transceiver 3103 is configured to cooperate with the processor 3101 to implement receiving and sending operations of the second communication device in the foregoing embodiment.

Alternatively, when computer program instructions stored in the memory 3102 are executed by the processor 3101, the operations performed by the coordination center in the foregoing embodiment may be implemented. The transceiver 3103 is configured to cooperate with the processor 3101 to implement receiving and sending operations of the coordination center in the foregoing embodiment.

For specific operations and beneficial effects implemented by the units in the communication device 3100, refer to the corresponding descriptions in the possible implementations of the signal transmission method. Details are not described herein again.

An embodiment of this application further provides a computer-readable storage medium. The computer-readable storage medium stores a computer program. The computer program is executed by a processor to implement an operation performed by a communication device in any one of embodiments and possible embodiments of embodiments.

An embodiment of this application further provides a computer program product. When the computer program product is read and executed by a computer, an operation performed by a communication device in any one of embodiments and possible embodiments of embodiments is performed.

The terms such as “first” and “second” in this application are used to distinguish between same or similar items with basically same roles and functions. It should be understood that there is no logical or timing dependency between “first”, “second”, and “n^{th}”, and neither a quantity nor an execution sequence is limited. It should be further understood that although the terms such as “first” and “second” are used in the following descriptions to describe various elements, these elements should not be limited by the terms. These terms are simply used to distinguish one element from another.

It should be further understood that sequence numbers of processes do not mean execution sequences in embodiments of this application. The execution sequences of the processes should be determined based on functions and internal logic of the processes, and should not be construed as any limitation on the implementation processes of embodiments of this application.

It should be further understood that the term “include” (also referred to as “includes”, “including”, “includes”, “comprises” and/or “comprising”) used in this specification specifies presence of the stated features, integers, steps, operations, elements, and/or components, with presence or addition of one or more other features, integers, steps, operations, elements, components, and/or their components not excluded.

It should be further understood that “an embodiment”, “an embodiment”, and “a possible implementation” mentioned throughout the specification mean that a specific feature, structure, or characteristic related to the embodiment or an implementation is included in at least one embodiment of this application. Therefore, “in one embodiment” or “in an embodiment” or “a possible implementation” appearing throughout the specification may not necessarily refer to a same embodiment. In addition, these particular features, structures, or characteristics may be combined in one or more embodiments by using any appropriate manner.

Finally, it should be noted that the foregoing embodiments are merely intended for describing the technical solutions of this application other than limiting this application. Although this application is described in detail with reference to the foregoing embodiments, a person of ordinary skill in the art should understand that they may still make modifications to the technical solutions described in the foregoing embodiments or make equivalent replacements to some or all technical features thereof, without departing from the scope of the technical solutions of embodiments of this application.

What is claimed is:

1. A method, wherein the method comprises:
obtaining, by a first communication device, a first resource used for transmission of a noise signal, wherein the first resource comprises one or more of: first time for the transmission of the noise signal, a first coverage area of the noise signal, or a first frequency band of a first beam that carries the noise signal;
determining, by the first communication device based on the first resource, a second resource used for transmission of a service signal, wherein the second resource comprises one or more of: second time for the transmission of the service signal, a second coverage area of the service signal, or a second frequency band of a second beam that carries the service signal, and the first resource is different from the second resource; and
sending, by the first communication device, a first service signal based on the second resource.

2. The method according to claim 1, wherein the first resource comprises the first coverage area of the noise signal, the second resource comprises the second coverage area of the service signal, and the first coverage area overlaps the second coverage area; and
wherein the first resource being different from the second resource comprises at least one of: the first time being different from the second time or the first frequency band being different from the second frequency band.

3. The method according to claim 1, wherein the obtaining, by the first communication device, the first resource comprises:
receiving, by the first communication device, first information from a second communication device, wherein the first information is used to request to obtain a resource available for the transmission of the noise signal; and
determining, by the first communication device, the first resource based on the first information.

4. The method according to claim 3, wherein the first information comprises one or more resources available for the transmission of the noise signal, and the one or more resources comprise the first resource.

5. The method according to claim 1, wherein after the obtaining, by the first communication device, the first resource, the method further comprises:
sending, by the first communication device, second information to a second communication device, wherein the second information indicates the first resource.

6. The method according to claim 1, wherein the second resource comprises the second time, and the sending, by the first communication device, the first service signal comprises:
sending, by the first communication device, the first service signal at the second time.

7. The method according to claim 1, wherein the second resource comprises the second frequency band, and a frequency band of a beam that carries the first service signal is the second frequency band.

8. The method according to claim 1, wherein the second resource comprises the second coverage area, and a coverage area of the first service signal is the second coverage area.

9. The method according to claim 1, wherein before the obtaining, by the first communication device, the first resource, the method further comprises:
receiving, by the first communication device, a beam hopping pattern from one or more communication devices; and
the obtaining, by the first communication device, the first resource comprises:
determining, by the first communication device, the first resource based on the beam hopping pattern.

10. The method according to claim 9, wherein the determining, by the first communication device, the first resource based on the beam hopping pattern comprises:
determining, by the first communication device based on the beam hopping pattern, a plurality of resources used for the transmission of the noise signal, wherein the plurality of resources comprises the first resource; and
the determining, by the first communication device based on the first resource, the second resource comprises:
adjusting, by the first communication device based on the plurality of resources, a first beam hopping pattern corresponding to the first communication device, wherein the adjusted first beam hopping pattern comprises the second resource.

11. A first communication device, comprising:
a processor, and a memory, wherein the processor invokes a computer program stored in the memory to cause the first communication device to perform operations including:
obtaining a first resource used for transmission of a noise signal, wherein the first resource comprises one or more of: first time for transmission of the noise signal, a first coverage area of the noise signal, or a first frequency band of a first beam that carries the noise signal;
determining, based on the first resource, a second resource used for transmission of a service signal, wherein the second resource comprises one or more of: second time for the transmission of the service signal, a second coverage area of the service signal, or a second frequency band of a second beam that carries the service signal, and the first resource is different from the second resource; and
sending a first service signal based on the second resource.

12. The first communication device according to claim 11, wherein the first resource comprises the first coverage area of the noise signal, the second resource comprises the second coverage area of the service signal, and the first coverage area overlaps the second coverage area; and
wherein the first resource being different from the second resource comprises at least one of: the first time being different from the second time or the first frequency band is different from the second frequency band.

13. The first communication device according to claim 11, wherein the obtaining the first resource comprises:
receiving first information from a second communication device, wherein the first information is used to request to obtain a resource available for the transmission of the noise signal; and
determining the first resource based on the first information.

14. The first communication device according to claim 13, wherein the first information comprises one or more resources available for the transmission of the noise signal, and the one or more resources comprise the first resource.

15. The first communication device according to claim 11, wherein after the obtaining the first resource used for transmission of the noise signal, the operations further comprise:
sending second information to a second communication device, wherein the second information indicates the first resource.

16. The first communication device according to claim 11, wherein the second resource comprises the second time, and the sending the first service signal comprises:
sending the first service signal at the second time.

17. The first communication device according to claim 11, wherein the second resource comprises the second frequency band, and a frequency band of a beam that carries the first service signal is the second frequency band.

18. The first communication device according to claim 11, wherein the second resource comprises the second coverage area, and a coverage area of the first service signal is the second coverage area.

19. The first communication device according to claim 11, wherein before the obtaining the first resource, the operations further comprise:
receiving a beam hopping pattern from one or more communication devices; and
the obtaining the first resource comprises:
determining the first resource based on the beam hopping pattern.

20. The first communication device according to claim 19, wherein the determining the first resource based on the beam hopping pattern comprises:
determining, by the first communication device based on the beam hopping pattern, a plurality of resources used for the transmission of the noise signal, wherein the plurality of resources comprises the first resource; and
the determining the second resource comprises:
adjusting, by the first communication device based on the plurality of resources, a first beam hopping pattern corresponding to the first communication device, wherein the adjusted first beam hopping pattern comprises the second resource.
